(19) United States
(12) Patent Application Publication
(10) Pub. No.: US 2016/0247082 A1
(43) Pub. Date: Aug. 25, 2016

(54) Crop Model and Prediction Analytics System

(71) Applicant: FARMERS BUSINESS NETWORK, LLC, St. Louis, MO (US)

(72) Inventors: Sammy J. Stehling, Monmouth, IL (US); Christopher G. Fasano, Monmouth, IL (US)

(73) Assignee: Farmers Business Network, LLC, St. Louis, MO (US)

(21) Appl. No.: 15/027,135

(22) PCT Filed: Oct. 3, 2014
(86) PCT No.: PCT/US2014/059195

§ 371 Date: Apr. 4, 2016

Related U.S. Application Data
(60) Provisional application No. 61/886,500, filed on Oct. 3, 2013.

(51) Int. Cl. G06N 7/00; A01G 1/00

(52) U.S. Cl. CPC G06N 7/005; A01G 1/001

(57) ABSTRACT

Various agronomic technologies are described, including a computer-implemented method for forecasting crop yield and an agronomic web portal including determining an expected yield at a first time, determining a growth function representing how the expected crop yield changes over time and based at least in part on an intrinsic yield function and the growth function, determining an expected yield at a second time, wherein the second time is later than the first time.

### CROSS REFERENCE TO RELATED APPLICATIONS

Applicants request entry into the National Phase in the United States by and through this application which is based on PCT Patent Application, serial number PCT/US2014/059195, filed on Oct. 3, 2014, which claims the benefit of U.S. Provisional Application No. 61/886,500, filed Oct. 3, 2013, both of which are incorporated herein by reference in their entirety.

### BACKGROUND

Conventional agricultural data collection and analysis techniques lack validation for data collected on the farm. There remains room for improvement.

### SUMMARY

The Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

An embodiment can be a method for forecasting crop yield, the method comprising: determining an expected yield at a first time; determining a growth function representing how the expected crop yield changes over time; and based at least in part on an intrinsic yield function and the growth function, determining an expected yield at a second time, wherein the second time is later than the first time.

An embodiment can be one or more computer-readable storage media storing computer-executable instructions that, when executed, perform a method for forecasting crop yield, the method comprising: receiving at least one of environmental data or cultural farming practice data for one or more fields growing a crop of a crop type; and constructing a location-specific growth function that estimates a change in an expected crop yield over time for the one or more fields growing the crop of the crop type, the growth function based on the at least one of environmental data or cultural farming practice data.

An embodiment can be one or more computer-readable storage media storing computer-executable instructions that, when executed, perform a method for forecasting crop yield, the method comprising: generating a yield trajectory for each of a plurality of locations in a field or group of fields, the respective yield trajectories representing an expected yield as a function of time for a set of environmental factors and cultural farming practices, the respective yield trajectories generated by: determining an intrinsic yield function for the location, the intrinsic yield function representing a yield determined from a set of empirical observations; determining a growth function having values for the location at each of a plurality of time steps, the growth function based at least in part on a plurality of parameters reflecting at least some of the environmental factors and cultural farming practices; and for each of the plurality of time steps after an initial time step, calculating an expected yield based at least in part on an expected yield of the previous time step, the intrinsic yield function, and the growth function; and combining the yield trajectories for the plurality of locations in the field or group of field to determine an expected yield for a growing season.

As described herein, a variety of other features and advantages can be incorporated into the technologies as desired.

### BRIEF DESCRIPTION OF THE DRAWINGS

FIG. 1 is a flowchart of an example method for analyzing farming data.

FIG. 2 is a flowchart of an example method of forecasting crop yield.

FIG. 3 is a flowchart of another example method of forecasting crop yield.

FIG. 4 is a flowchart of another example method of forecasting crop yield.

FIG. 5 shows a graph of an example set of generated yield trajectories.

FIG. 6 shows a graph of an example in which a growth function is built using data.

FIG. 7 shows a graph illustrating yield by soil type for two different hybrids.

FIGS. 8 and 9 illustrate an example in which a drought event is modeled.

FIG. 10 is an example system in which the technologies can be implemented.

FIG. 11 is a graphical user interface presenting an example member sign in box.

FIG. 12 is a graphical user interface presenting an example member sign up box.

FIG. 13 is a graphical user interface presenting an example home page with a top bar and a bottom bar.

FIG. 14 is a graphical user interface presenting an example user home page.

FIG. 15 is a graphical user interface presenting an example user home page presenting various options.

FIG. 16 is a graphical user interface presenting an example “Create Farm” form.

FIG. 17 is a graphical user interface presenting example options for fields of a farm.

FIG. 18 is a graphical user interface presenting example options for creating a field boundary.

FIG. 19 is a graphical user interface presenting an example field adding form.

FIG. 20 is a graphical user interface presenting an example yield map.

FIG. 21 is a graphical user interface presenting an example mapping view.

FIG. 22 is a graphical user interface presenting an example field view.

FIG. 23 is a graphical user interface presenting another example field view.

FIG. 24 is a graphical user interface presenting an example list of field events.

FIG. 25 is a graphical user interface presenting an example user seed short list.

FIG. 26 is a graphical user interface presenting an example form to add a new seed type.

FIG. 27 is a graphical user interface presenting an example user fertilizer short list.

FIG. 28 is a graphical user interface presenting an example form to add a new fertilizer type.

FIG. 29 is a graphical user interface presenting an example user chemical short list.

FIG. 30 is a graphical user interface presenting an example form to add a new chemical type.

FIG. 31 is a graphical user interface presenting an example user tank mix short list.

FIG. 32 is a graphical user interface presenting an example form to add a new tank mix type.

FIG. 33 is a graphical user interface presenting an example form to add a new tank mix type showing an additional chemical in the tank mix.

FIG. 34 is a graphical user interface presenting an example user equipment short list.

FIG. 35 is a graphical user interface presenting an example detailed view of a selected piece of equipment.

FIG. 36 is a graphical user interface presenting an example form to add a new piece of equipment.

FIG. 37 is a graphical user interface presenting an example summary list of user equipment.

FIG. 38 is a graphical user interface presenting an example user equipment combination short list.

FIG. 39 is a graphical user interface presenting an example detailed view of a selected equipment combination.

FIG. 40 is a graphical user interface presenting an example form to add a new equipment combination.

FIG. 41 is a graphical user interface presenting an example summary list of plant events.

FIG. 42 is a graphical user interface presenting an example detailed view of a selected plant event.

FIG. 43 is a graphical user interface presenting an example plant event adding form.

FIG. 44 is a graphical user interface presenting an example form pane to select a seed used in a plant event.

FIG. 45 is a graphical user interface presenting example form panes to enter data for a plant event.

FIG. 46 is a graphical user interface presenting an example field list for selection and association with a plant event.

FIG. 47 is a graphical user interface presenting an example summary list of fertilizer events.

FIG. 48 is a graphical user interface presenting an example fertilizer event creation form.

FIG. 49 is a graphical user interface presenting an example summary list of chemical events.

FIG. 50 is a graphical user interface presenting an example chemical event creation form.

FIG. 51 is a graphical user interface presenting an example tank mix used form pane and an example timing used form pane for chemical event creation.

FIG. 52 is a graphical user interface presenting an example spray details form pane and an example equipment used form pane for a chemical event.

FIG. 53 is a graphical user interface presenting an example harvest event creation form.

FIG. 54 is a graphical user interface presenting an example crop data pane and a monitor data pane for harvest event creation.

FIG. 55 is a graphical user interface presenting an example equipment used pane for harvest event creation.

FIG. 56 is a graphical user interface presenting an example summary list of tillage events.

FIG. 57 is a graphical user interface presenting an example tillage event creation form.

FIG. 58 is a graphical user interface presenting an example summary list of weather events.

FIG. 59 is a graphical user interface presenting an example weather event creation form.

FIG. 60 is a graphical user interface presenting an example map screen.

FIG. 61 is a diagram of an example computing system in which some described embodiments can be implemented.

FIG. 62 is an example mobile device that can be used for the technologies described herein.

FIG. 63 is an example cloud-support environment that can be used in conjunction with the technologies described herein.

### DETAILED DESCRIPTION

### Example 1

### Example Overview

The technologies described herein can be used for a variety of agronomic information scenarios, and adoption of the technologies can provide improved techniques for analyzing and collecting such information, ultimately resulting in greater productivity (e.g., increased yield).

Various other features can be implemented and combined as described herein.

### Example 2

### Examples of Forecasting Crop Yield

Conventional agricultural data collection and analysis techniques lack validation for data collected on the farm. Such data can therefore contain so many errors that the data is not useful or relevant. Similarly, even when farmers have computerized monitoring equipment, they are often not able to accurately complete or even remember to accurately complete data entries as to what seed or chemical is being applied in a field. For example, a farmer might enter in his planter monitor a particular corn hybrid as the one being planted in a field, yet some seeds of a different hybrid might remain in the seed supply bin of the planter as planting begins. As another example, once partially through planting the field, a supply bin might run out, and a farmer may add yet another hybrid to finish on some of the planter rows. In the same manner, a farmer might load a sprayer with a particular chemical but enters in his records that he used a different formulation that he assumes to be the same. Thus, in conventional systems, the actual occurrences in the field may not be properly captured and cannot be used to ensure valid data.

Conventional harvest results also suffer from lack of validity or consistency because of, for example, poorly calibrated or un-calibrated equipment (e.g. harvest monitors). For example, flow sensors on a grain combine should be frequently calibrated and compared to an actual weight to ensure accuracy. Failure to monitor and adjust flow sensors frequently enough limits the accuracy of collected data.

Although simplified attempts have been made to determine the implications of seed selection, use of specific products, or use of specific practices on crop productivity, predicting productivity through modeling has been extremely difficult. Field crop growth is dynamic and complex in the natural environment. No two growth conditions are exactly similar or completely understood and thus this chaos that is witnessed is conventionally accepted as much too complex for a model to account for. If a practice or product produces an average response in a cropping system that is economically positive, it is typically accepted that this is the best one can expect. Thus the recommendation to apply the practice over relatively similar systems is conventionally considered reasonable, even though it may fail to produce a positive response half of the time.

Examples of novel crop yield forecasting are described herein. The examples reliably provide useful guidance to farmers (or anyone managing a biological system, referred to as farmer) to make effective choices in genetics and cultural practices that greatly benefit their enterprise by predicting the response of a crop or other biological system. The examples can identify and classify components that impact the specific productivity of a field, group of fields, or portions of a field. The described examples also create a continuum of response with respect to variables such as seed, fertility, pesticide application, or other environmental factors or cultural farming practices to optimize productivity and profitability. (As used herein, optimization refers to improvement and does not necessarily require a “best” result.) The described examples allow farmers to use their own data to connect to this continuum of response. This allows individual farm data to be kept completely confidential, providing farmers the incentive to participate in the practice so they can seek their own best choice.

The described examples provide time- and location-specific (e.g. field-specific) solutions rather than relying on aggregation of data that is then used to generate response curves directing the user to the best average outcome. The described examples provide predictions from post-processed data that is intuitive and determined by time and specific conditions. The described examples can record planting and cultural farming practices accurately, record harvest data accurately, and mathematically model yield to allow a farmer to make better choices about planting and practice.

In some examples, valid data collection can be improved through use of a marker (also referred to as a tracking substance or a tag). The marker can be unique to different chemicals or seeds and can be used in conjunction with a device to identify this marker. Markers can, for example, include specific combinations of one or more rare earth elements that are not usually found in nature in various concentrations. A device to identify the marker can be installed on planter units, sprayers or applicator devices to monitor which seeds or chemicals are being applied. The link of such a device to a monitor recording the movement of the equipment in the field closes the data validation loop. The material used as a marker can be but is not limited to inert materials that through their detection would indicate a planting rate or chemical rate being applied. Such a system also insures accurate governmental compliance records. Human interaction, the primary source of data error, is minimized by limiting the interaction of humans with the data collection process. Such a system can be linked to the farmer entries of plans to apply to a field to highlight errors, they can also be linked to a failsafe system of software to ensure chemicals or seed are not applied off label or in a way that could cause damage to the crop. An example marker is a fluorescent dye with a unique spectral signature that can be used to identify the material easily, quickly, and safely.

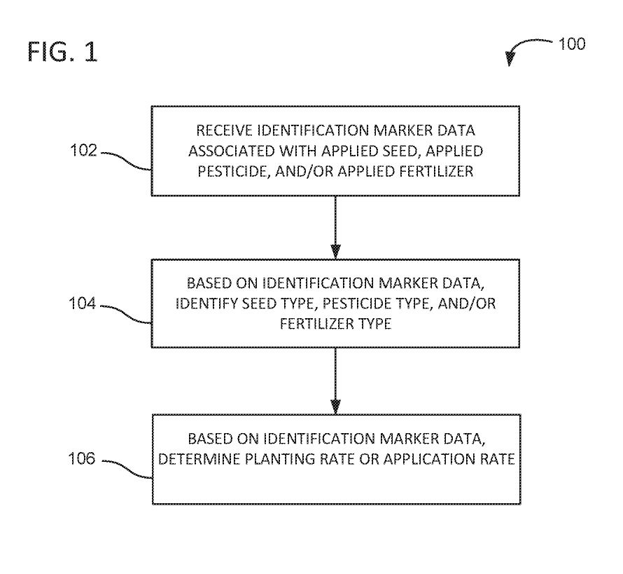

FIG. 1 illustrates a method 100 for analyzing farming data. In process block 102, identification marker data is received. The identification marker data is associated with at least one of applied seed, applied pesticide, or applied fertilizer. The identification marker data can, for example, indicate a detection of a tracking substance. The tracking substance can be a substance that is present in seeds, pesticide, fertilizer, or other applied material in a concentration or a combination not naturally found in an area where the tracking substance is detected. The tracking substance can be or include, for example, an inert substance such as a fluorescent dye or a rare earth element. The identification marker data can be, for example, detected by sensors on farm equipment and stored or wirelessly transmitted to a computer system for analysis. In process block 104, based at least in part on the identification marker data, at least one of a seed type of the applied seed, a pesticide type of the applied pesticide, or a fertilizer type of the applied fertilizer is identified. In process block 106, based at least in part on the identification marker data, at least one of a planting rate of the applied seed, an application rate of the applied pesticide, or an application rate of the applied fertilizer is determined. In some examples, method 100 can further comprise determining an expected yield based at least in part on at least one of the seed type, the planting rate, the pesticide type, the application rate of the applied pesticide, the fertilizer type, or the application rate of the applied fertilizer determined in process block 106.

In some examples, combines and harvesters are fitted with load cells to calibrate flow sensors continually as changes occur. Examples of such sensors include a sensor that uses alpha particle blockage to measure mass flow rate and laser (or light) identification detection and ranging (LIDAR) sensors. Software can link this on the go correction to ensure accurate data is collected and stored.

Examples described herein provide for the ability to more precisely determine the yield outcome for any specific crop system given a specific set of conditions. This enables predictions that are extremely effective in determining efficient courses of action with respect to farming choices and allows determination with more certainty of the conditions for a specific seed selection, product, cultural farming practice, etc. that increase (or provide an “optimized”) yield. The described examples are thus an effective tool in determining where and how something works in crop production. The described examples also allow crop productivity (e.g. yield) to be projected during the season, which allows for prediction of commodity prices at future times. The described examples can provide increasingly accurate results as more and more specific data is provided for modeling.

The described examples can: classify specific impacts of genetic response by field environment (soils, water drainage, etc.); classify specific impacts of genetic response using different pesticides by field environment; classify specific impacts of genetic response using different pesticides by tillage method by field environment; classify specific impacts of genetic response using different pesticides by tillage method by other cultural farming practice by field environment; create a growing continuum of knowledge that can be shared with other farmers to produce a more powerful guidance system for enterprise changes; utilize the outcomes of model simulations allowing for the choices a farmer might make; classify a farm field response and identify the components that most affect crop yield under the conditions observed for that specific field; define the impact that inputs have on the response, thus fitting known examples; explain what is typically seen as “chaos” when conventional linear methods are used; identify unique response characteristics of a farm field (or non-unique field-specific response characteristics); project outcomes to manage specific fields effectively; use only one farmer's data or all farms data in useful data set; predict the value and outcome of farm decisions; relate to a variety of specific fields or future environments and environmental conditions; use the data collected on one farm or a number of farms; and project end-of-season outcome to project crop size and a corresponding market value.

The described examples set forth a framework that allows processing and building a large number of models to more precisely determine the yield outcome for any specific biological system (e.g. a field or group of fields growing a crop) given a specific set of conditions. Agricultural systems can be thought of as deterministic machines that process energy into sugar and other plant biomass. Using this approach, models and processes can be constructed based on the framework.

Motivated by energy flow, equation(s) can be written that grow a biological system in a time-dependent way. Equations and models can include the effects of additional inputs and can allow energy that flows into the system to be used by other parts of the system that do not directly lead to yield. The equation(s) can be calibrated—there are constants that govern the energy flow and development of the system. To provide an accurate and precise response, these constants can be fixed by empirical data. Many of these constants can also be fixed by genetics and other fundamental principles.

The following is an example process for determining constants to calibrate the model. In the example, farmers record planting data that can include location, time, hybrid, seed treatment, and other conditions that occur at planting. By knowing the accurate location of the planting, soil type, slope, elevation, etc. can be used to build extremely sophisticated algorithms. Farmers record events as they occur in time. These events include (but are not limited to) weather (e.g. rainfall and drought) and occurrence of pest and other outbreaks. Farmers record cultural farming practices (e.g. tillage, rotation, application of pesticides, herbicides, etc.) in time as appropriate. Farmers record yield as a function of geospatial location and time. Yield can be fit with a distribution function to find the average and full-width half maximum (FWHM) as a function of “cutting the data” by practice, hybrid, soil etc. to determine the yield and FWHM for many specific practices. The average and FWHM from the yield distribution function can be used to determine the calibration constants that produce an accurate representation of the yield.

Using a discrete set of parameters for a range of inputs, a smooth hypersurface can be constructed that defines the calibration constants. The axes of this hypersurface can be, for example, a corn productivity index that characterizes the soil type, nitrogen, rainfall, slope or many other things. Using the hypersurface, an algorithm can be applied for different circumstances or situations, which allows modeling cases for which there is no data. With more data available, the hypersurface can be refined to add to its complexity and provide a more powerful model.

The described examples allow farmers to farm their field “virtually” by letting them select practice as well as hybrid. This is done with a “backend” that implements an algorithm and a “front-end” that allows a farmer to make selections. This interaction can take many forms, but can include some of the following features. Farmers can run models before the season begins to make seed and practice selection by projecting yield and other outcomes computationally. Farmers can choose an “optimize button” that will optimize yield, optimize profit, minimize risk, or other choices. During the season, farmers can run a model daily, weekly, etc., that updates with events as they have happened to allow accurate predictions for the end of the season outcome. It can also allow farmers to make changes to their operation as they are recording events in time during the season.

A detailed example algorithm that implements the framework described herein is presented below. In this example, the expected yield (e.g., at the end of the season) is a product of each moment throughout the growing season and a function of the expected yield at the previous moment based on a host of conditions that are present during that time interval. In addition to the moment-to-moment dependence, there are some properties that set the large-scale behavior for the season. Both the moment-to-moment change and the large-scale behavior of the expected yield are built into the algorithm and are parameterized in a general and flexible way to allow the algorithm to be applied to a variety of crops, production processes, cultural farming practices, and environmental conditions.

For a set of fields for a single crop:

yₖ₊₁(i,j)=yₖ(i,j)+gₖ*(i,j)(y*(i,j)−yₖ(i,j))h (1)

where
yₖ₊₁(i, j): expected yield at time k+1 at location (i, j)
yₖ(i, j): expectedyield at time k at location (i, j)
(i, j): field coordinates
k: time
gₖ(i, j): growth function at (i, j) at time k
y*(i, j): intrinsic yield for the crop considered at field coordinate (i, j)
h: time interval between moments
   In equation 1, yₖ₊₁(i, j) is the expected yield at location (i, j) at time k+1 during the season. An expected yield can be calculated for each field location and time step for the entire season. The expected yield at location (i, j) at time k during the season is yₖ(i, j). An expected yield can be calculated for each field location and time step for the entire season. The intrinsic yield, which can be fit from yield data, is y*(i, j). The intrinsic yield is a statistical function that represents the maximum “theoretical yield” for the crop/hybrid under consideration. The theoretical yield is an example of a large-scale property. The intrinsic yield is the best (or nearly best) yield that could be achieved by a particular crop/hybrid under the theoretically optimal conditions for growth (ideal soil, ideal moisture, ideal practices, etc.). Since it is a statistical function, the standard deviation associated with this theoretical maximum can be built directly into the algorithm.

The growth function gₖ(i, j) is a statistical function that controls how the expected yield grows over the time interval h. The growth function takes the difference between the intrinsic yield and the current expected yield and grows the yield by some amount over the time interval. This statistical function contains the parameters for the growth that occurs over the time interval between time k and k+1. The growth function parameterizes environmental conditions and cultural farming practices as a function of time k. The operation of the growth function can be thought of as “propagating” the yield forward, so the growth function can be thought of as similar to a “propagator” in physics parlance.

An example of the growth function is a statistical function with a few parameters that is generated for each time step k. However, the growth function is very flexible and very powerful. Since it is k dependent, the growth function can be built to contain correlations (auto-correlations) with previous time steps (i.e. the growth function at the kth step could depend on the growth function at the (k-n)th step.) Further, the growth function allows for dependence and communication between fields and crops. It can do this by constructing functions so that gₖ(i, j) depends on other field locations (e.g. gₖ(i, j) depends on locations (i+1, j), (i−1, j) (i, j+1), and (i, j−1)).

The growth function can be, for example, a Gaussian distribution function with a mean and standard deviation. When gₖ(i, j) is positive, the yield grows and the expected yield at the k+1 step is larger than the expected yield at the k step. As gₖ(i, j) gets larger while positive, the expected yield grows more rapidly. When gₖ(i, j) is negative, the expected yield at the k+1 step is smaller than the yield at the k step.

Many of the dynamics of an agricultural system can be built into the growth function. For example, behavior by soil type, rainfall, growing practice, environment etc. can be built into gₖ(i, j). Because of this, the behavior of the system can be captured, and universal behaviors can be identified. Universal behaviors that exist across genetics, soil types or practices, can be represented in the form and parameters that go into the growth function. Universality is a novel and powerful tool that allows the algorithm to be predictive. An identified universal behavior can be used across genetics, environmental factors, and cultural farming practices in a new and powerful, quantitative, and predictive way.

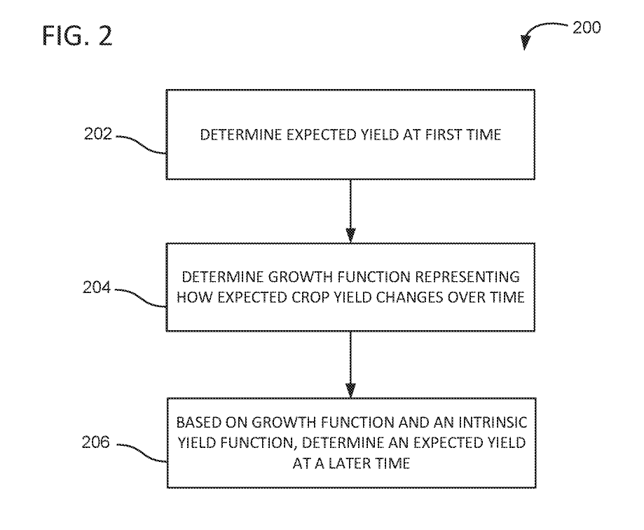

FIG. 2 illustrates a method 200 of forecasting crop yield. In process block 202, an expected yield at a first time is determined. In process block 204, a growth function representing how the expected crop yield changes over time is determined. The growth function can be a probability distribution function. In some examples, determining the growth function comprises performing a simulation to generate a value for each of a plurality of field locations at each of a plurality of times. The simulation can be, for example, a Monte Carlo simulation or other simulation tools including Euler, Runge-Kutta, Predictor-Corrector, Finite Element, or Finite Difference. In some examples, the value of the growth function at a particular field location and time is correlated to the value of the growth function at another field location or time.

The growth function can be determined based on a plurality of parameters, the respective parameters each representing one or more environmental factors or one or more cultural farming practices. The one or more environmental factors can comprise at least one of weather conditions (including rainfall, temperature, and humidity), soil conditions, or terrain. The one or more cultural farming practices are actions taken with respect to a field growing a crop for which the expected yield at the second time is determined. The cultural farming practices comprising at least one of soil disturbance, soil amendment, fertilizer application, fertilizer characteristics, pesticide application, pesticide characteristics, crop rotation, planting depth, planting density of a the crop, planting density of an alternate crop rotated with the crop, crop characteristics, crop residue management, weed management, tillage, canopy management, protective seed treatment, seed characteristics, characteristics of equipment used to manage the first crop, and a path or a speed of equipment traveling over the field growing the crop.

The intrinsic yield function corresponds to a crop yield under assumed conditions. The intrinsic yield function can be, for example, a probability distribution function. In some examples, the intrinsic yield function represents a maximum yield determined at least in part from data reflecting a variety of environmental factors and cultural farming practices for a crop variety for which the expected yield at the second time is determined. In process block 206, based at least in part on an intrinsic yield function and the growth function, an expected yield at a second time is determined. The second time is later than the first time.

In some examples, method 200 further comprises receiving identification marker data. The identification marker data can be associated with at least one of applied seed, applied pesticide, or applied fertilizer. The growth function can be based at least in part on the received identification marker data. In some examples, the identification marker data indicates a detection of a tracking substance. The tracking substance can be a substance that is present in seeds, pesticide, fertilizer, or other applied material in a concentration or a combination not naturally found in an area where the tracking substance is detected. In some examples, the tracking substance is an inert substance. The parameters embedded in the growth function can be described by a hypersurface.

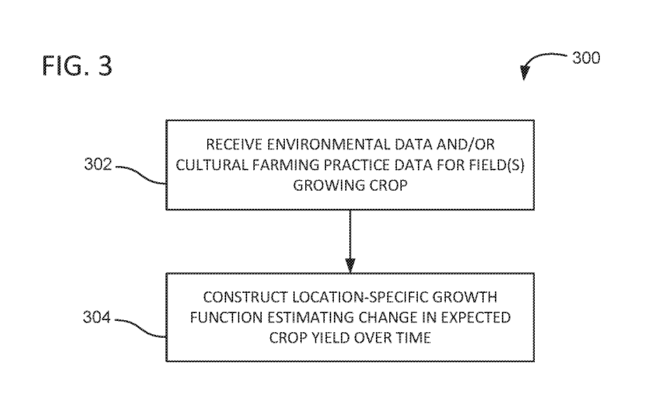

FIG. 3 illustrates a method 300 for forecasting crop yield. In process block 302, at least one of environmental data or cultural farming practice data for one or more fields growing a crop of a crop type is received. In process block 304, a location-specific growth function is constructed that estimates a change in an expected crop yield over time for the one or more fields growing the crop of the crop type. The growth function is based on the at least one of environmental data or cultural farming practice data. In some examples, constructing the location-specific growth function comprises: fitting yield data to a yield distribution function, wherein the yield data is a function of time and geospatial location and represents empirical data for the one or more fields growing the crop of the crop type; based at least in part on the yield distribution function, calculating an average yield and a full-width half maximum (FWHM) of the yield distribution function with respect to each of a plurality of environmental factors or cultural farming practices corresponding to the environmental data or cultural farming practices data; and determining a plurality of calibration constants for the yield distribution function based at least in part on the calculating.

Constructing the location-specific growth function can further comprise based at least in part on the plurality of calibration constants, constructing a hypersurface. Embedded in the growth function are a number of parameters. These parameters get fixed by data for yield as a function of a variety of factors such as soil productivity, elevation, weather, sunlight, maximum theoretical yield, etc. The hypersurface allows these points to be connected together in a smooth way. Using the hypersurface, the parameters to use for any combination of inputs can be determined—even inputs for which there is no data. The hypersurface represents the parameters for many possible scenarios smoothly connected and causal in nature. They form the basis for a theoretical model that then can be used generally. The more data, the better the hypersurface is defined and the better the resulting predictions.

Method 300 can further comprise determining an expected yield at a time later than a current time based at least in part on an intrinsic yield function representing crop yield for the crop type and the location-specific growth function. Method 300 can also comprise analyzing, for the crop type, crop yield data for a plurality of fields, and, based at least in part on the analyzing, determining the statistical intrinsic yield function.

In an example yield model algorithm implementation, an intrinsic yield y*(i, j) with a standard deviation is determined, and a growth function gₖ(i, j) is constructed with parameters that are fixed using data.

The intrinsic yield is the maximum yield for a particular hybrid under ideal conditions. The intrinsic yield can be determined by finding the maximum yield seen in the data collected over as many environmental and cultural conditions as are available. There can be some statistical uncertainty in this value because of the uncertainty associated with collecting these data, and the distribution of yields observed can be used to estimate this uncertainty. A sample size (number of measurements) is used to estimate an uncertainty.

The growth function serves to propagate and grow the yield from the kth time to the k+1 time. The size is a function of the time interval. It can be written many ways, for example as a Gaussian with a mean and standard deviation. Example growth functions can exhibit the following behavior:
If gₖ(i, j) is fixed to be a constant, the final expected yield shows only the variation of the intrinsic yield.
gₖ(i, j) controls the rate at which the expected yield rises in time. By manipulating this function, events can be modeled in time (drought, wet weather, temperature, spraying, and pests).
Autocorrelations observed in nature can be built into gₖ(i, j) so that they affect the yield.
Growth functions can be built from the aggregated data and then used generally.
A variety of hybrids for a variety of crops can be used with the growth function. This is a general framework for modeling.

After picking a form for gₖ(i, j), a set of yield trajectories (discussed in more detail below) can be constructed, and real data from harvests, environmental conditions, soil type, cultural practices, etc., can be used to fix the free parameters in gₖ(i, j).

To make a prediction of the expected yield, a large number of yield trajectories can be built and averaged over. A yield trajectory is the expected yield yₖ (i, j) as a function of time (k) for a particular season, crop and conditions. Trajectories can be built by:
Setting the initial (k=0) yield to 0.
Generating the intrinsic yield y*(i, j) for the trajectory for each (i, j) location using a distribution such as a Gaussian distribution. The intrinsic yield is fixed for each trajectory.
For each time step, generating a growth function gₖ (i, j) for each (i, j) location and time interval from k to k+1. This function is used to model cultural farming practices and environmental factors, and it can be a complicated multi-parameter function. Some models use a simple Gaussian distribution with a fixed mean and distribution function throughout the trajectory. Modeling more complex systems can be accomplished through additional complexity in the growth function.
Calculate the k+1 expected yield using the algorithm.
Repeat for the entire growing season to arrive at a final yield at the end of the season.

Since this model is statistical in nature, a large number of yield trajectories are generated, and the yield trajectories can be averaged to obtain a prediction of the expected yield.

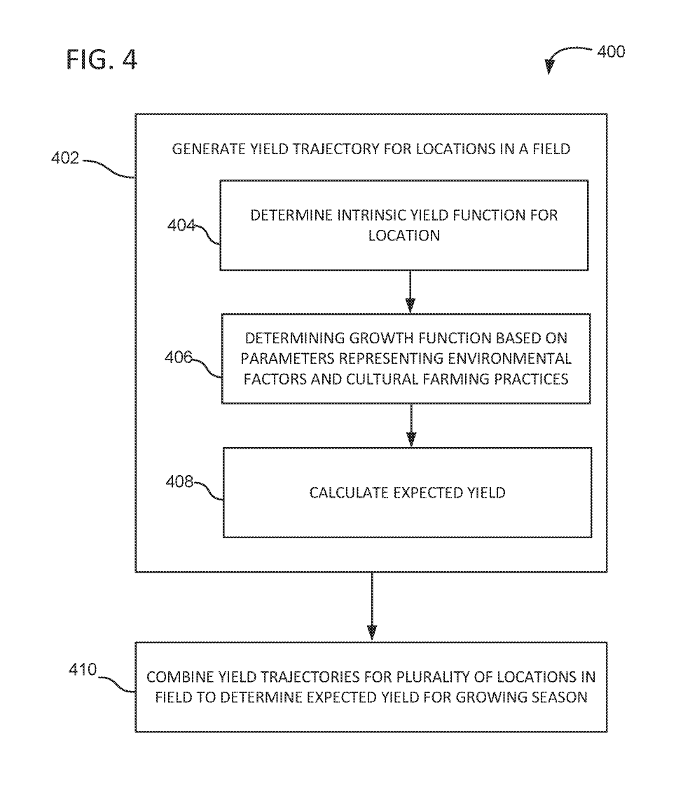

FIG. 4 illustrates a method 400 of forecasting crop yield. In process block 402, a yield trajectory is generated for each of a plurality of locations in a field or group of fields, the respective yield trajectories representing an expected yield as a function of time for a set of environmental factors and cultural farming practices. The respective yield trajectories are generated through process blocks 404, 406, and 408. In process block 404, an intrinsic yield function for the location is determined, the intrinsic yield function representing a yield determined from a set of empirical observations. In process block 406, a growth function having values for the location at each of a plurality of time steps is determined. The growth function is based at least in part on a plurality of parameters reflecting at least some of the environmental factors and cultural farming practices. In process block 408, for each of the plurality of time steps after an initial time step, an expected yield is calculated based at least in part on an expected yield of the previous time step, the intrinsic yield function, and the growth function. In process block 410, the yield trajectories for the plurality of locations in the field or group of fields are combined to determine an expected yield for a growing season. In some examples, the respective yield trajectories are determined by performing a simulation.

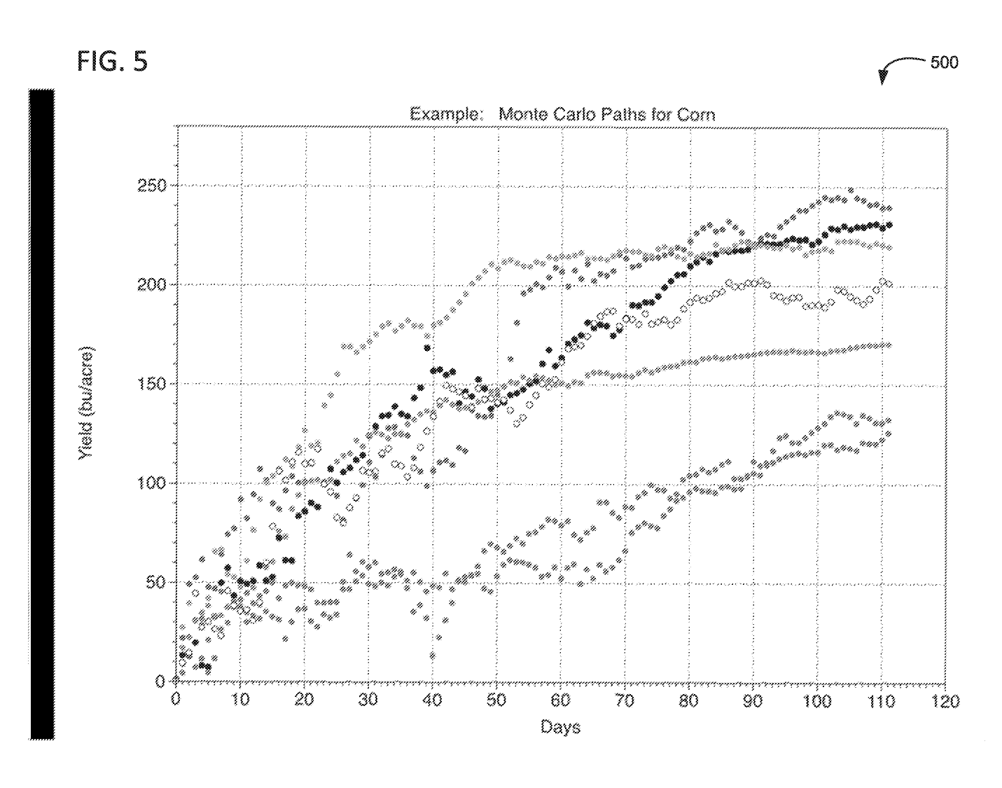

FIG. 5 shows a graph 500 of an example set of generated yield trajectories. For each trajectory, the maximum yield y*(i, j) is generated using a Monte Carlo simulation, although other simulations can also be used. The y*(i, j) when aggregated for all the trajectories, form a Gaussian distribution about a mean value with a standard deviation. The mean value and standard deviation of this distribution are determined by surveying the maximum conditions. In this example, the growth function gₖ(i, j) is also a unitless statistical function that is generated for each time interval in each trajectory. Like the maximum yield, the growth functions, when aggregated over many time intervals, form a Gaussian distribution about a mean value with a standard deviation. However, unlike the maximum yield, the mean and standard deviation may be changed as a function of time (k) to reflect different environmental and cultural farming practices. In this first example, however, the mean and standard deviation for the gₖ(i, j) are fixed as constant and the mean value is positive.

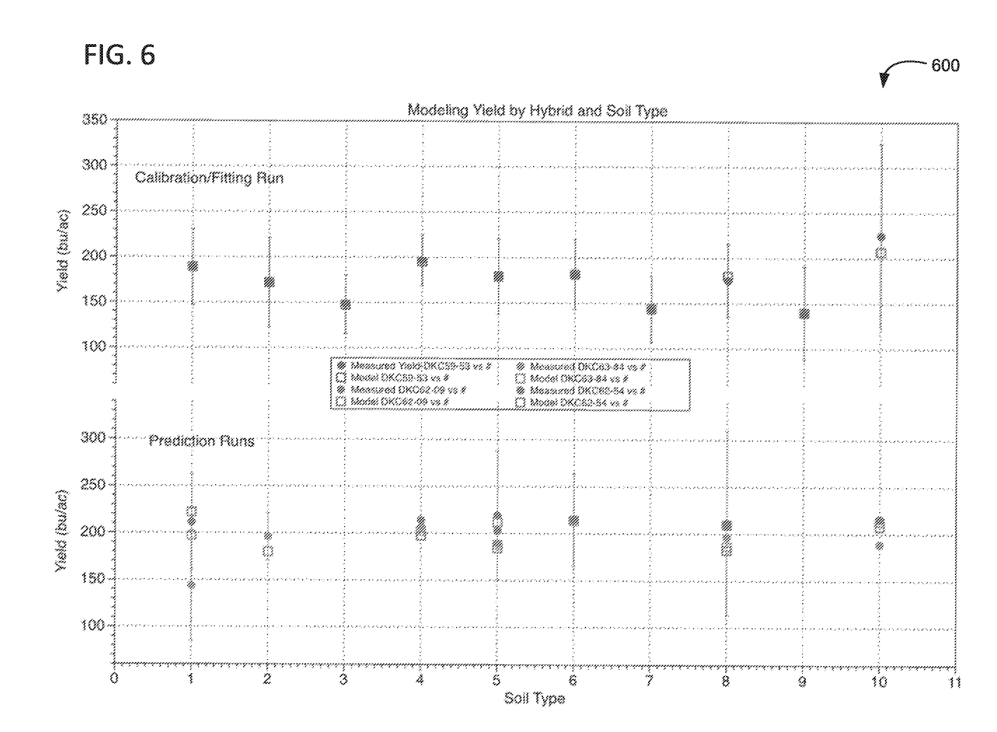

FIG. 6 shows a graph 600 of an example in which a growth function is built using data. In this example, it can be seen how different hybrids respond to a set of soil types. A particular hybrid is used to calibrate and fix the response due to the soil. Once the growth function is fixed by soil type, the model's predictive power can be tested when other hybrids are considered. In this example, the procedure is as follows:
Choose a hybrid.
Fit yields by soil type (this is a statistical process, so a mean for the distribution function and a standard deviation are selected).
Select a new hybrid and use the maximum yield seen as y*(i, j).
Use the determined fitting constants for each soil type to predict yields.

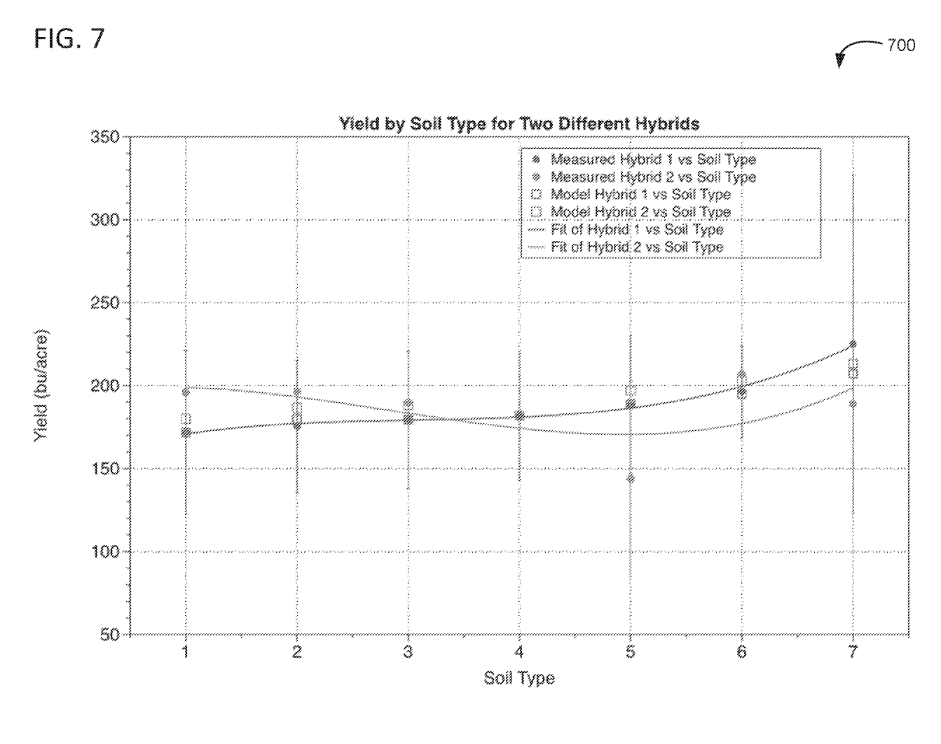

FIG. 7 shows a graph 700 illustrating yield by soil type for two different hybrids. If every hybrid responded the same way to the soil type, yield would be predicted as shown by the squares, based on the intrinsic yield for each hybrid. Graph 700 indicates that some hybrids outperform others for the same soil conditions. This model, when integrated into a system of hybrids and cultural farming practices, can be used to improve the yield performance of a farm.

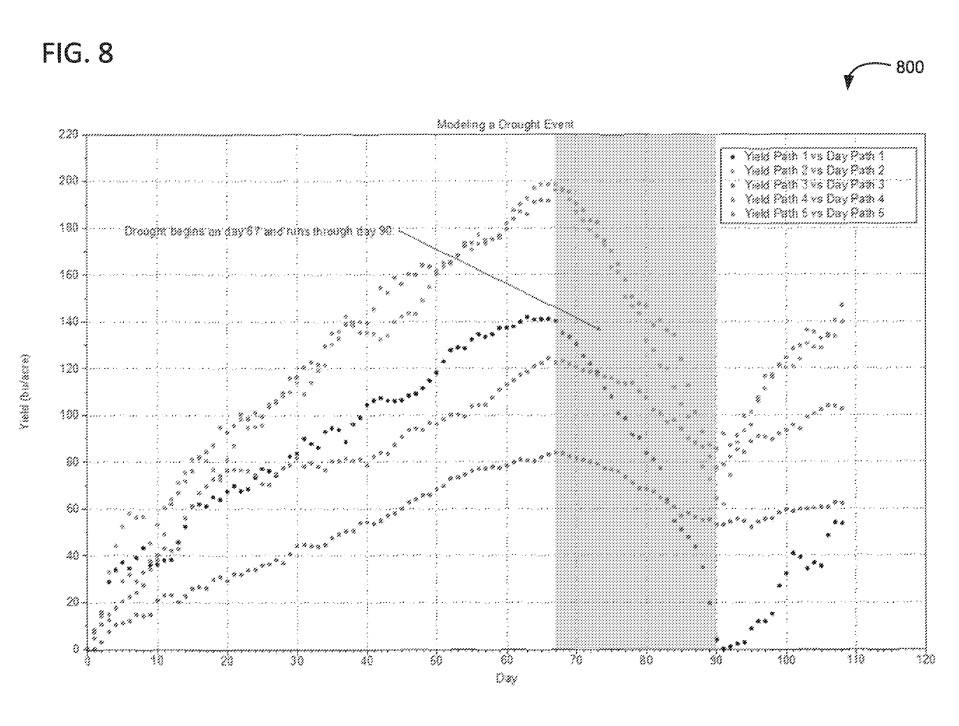

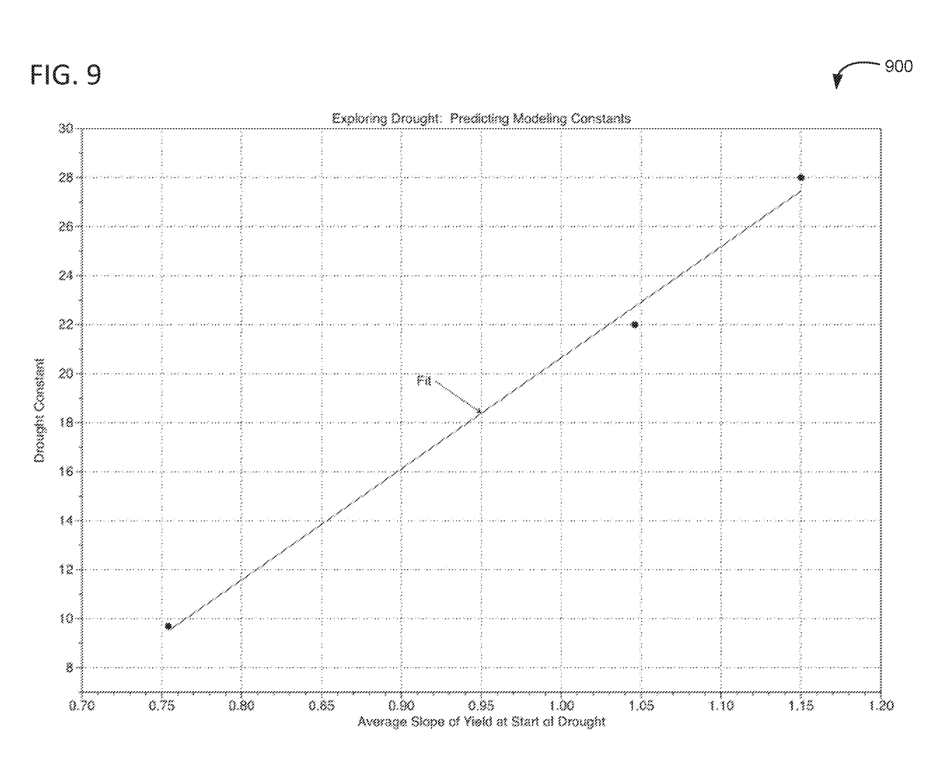

FIGS. 8 and 9 illustrate an example in which a drought event is modeled. Drought can dramatically suppress yield. In this example, the performance of a single hybrid in two locations is used to identify a relationship that allows prediction of performance by finding a relationship between. In this example, existing parameters were used for non-drought areas as a starting point. The growth function was modified so that it causes yield to drop during the drought. Constants for the modified growth function were selected by soil type, and a pattern was searched for in the new constants. FIG. 8 shows graph 800 illustrating yield as a function of time. This example demonstrates how additional complexity can be built into the modeling process. In this case, the Growth Function is altered by examining the slope of the yield at the onset of the drought as shown in graph 900 of FIG. 9. This allows construction of a growth function that has parameters that are conditioned by the drought.

In considering inputs, the importance of a particular input to the analysis can be considered. Another way of thinking of this is to ask how much of the yield prediction comes from characterizing a particular input. For example, in a particular situation, the most significant variable could be soil type. In such cases, it is useful to investigate as many yields on as many soil types as possible. Spending lots of time on other inputs before understanding this input may not be an efficient use of effort.

Importance can be measured by calculating the percent difference between the yield y and a defined standard of the 5-year average yield y_{avg} (taken to be 155 bu/ac) for corn.

$$I = \frac{y - {y}_{avg}}{{y}_{avg}} \qquad ( 2 )$$

Parameters that lead to values of I that are not 0 are increasingly important as I becomes larger. Positive values of I mean that the parameter(s) make the yield rise above the average, while negative values of I mean that the parameters make the yield fall below the average.

Another consideration is sensitivity. That is, how sensitive is the yield to small changes in a particular input? This is a closely related concern to importance, but not quite the same thing. It's possible that the yield prediction depends on a sensitive way on planting rate. If this were to be true, a relatively large change in yield for small changes in planting rate would be observed. Sensitivity can be measured by taking the percent difference for each practice or input yᵢₚ when compared to the yield averaged over all of those practices y_{avgp}.

$$S = \vert \frac{{y}_{ip} - {y}_{avgp}}{{y}_{avgp}} \vert \qquad ( 3 )$$

Importance and sensitivity allow investigations of dependence to be structured accordingly.
High importance, high sensitivity—The yield is very dependent on this input AND the parameters need to be determined precisely because the yield varies dramatically when those inputs are changed only slightly.
High importance, low sensitivity—The yield is very dependent on this input, but the yield is relatively insensitive to small changes in parameters, so parameters do not need to be determined very precisely.
Low importance, high sensitivity—The yield is sensitive to small changes in an input, but since that input controls little of the overall yield, it is of lower interest.
Low importance, low sensitivity—The yield is insensitive to changes in an input and that input controls little of the yield, so it is of lowest interest.

As more and more data are accumulated, more and more effective Growth Functions will be able to be constructed. Identification of the sensitivity of the growth function to various inputs is helpful. This can be accomplished through a “sensitivity analysis.” In this analysis, both the Importance I and Sensitivity S are computed as described above. An outline of the procedure is:
Construct a Growth function (identify parameters) for a particular dataset. For example, construct the growth function that describes the yield for a particular planting rate.
Repeat the construction of the Growth Function with different planting rates, identifying parameters required.
Compute the values of Importance I and Sensitivity S.

For inputs that show high importance or high sensitivity, the model can be improved by improving the growth function. A fit (linear or nonlinear) can be constructed between changes in the underlying variable (in this case the planting rate) and the output yield. With improved growth functions, better yield predictions are possible. As the quantity of data increases, the quality of the growth functions will increase.

The described examples set forth a new way to make predictions about crop yields using a new framework. This framework is reflects that the yield at the end of a season depends on a variety of parameters that can be used to “build up the yield” via the transformative notion that the yield at any given instant depends on the yield at the previous instant and a growth function that propagates the yield forward. The growth function contains the dynamics and provides the flexibility needed to incorporate a wide variety of practices and conditions for any crop. Building the growth function is based on accurate planting and harvest data, as well as accurate data to characterize conditions and practice. The accuracy of the input data is addressed by advancing the idea that every type of seed (hybrid) and input chemical be tagged with a marker (like a fluorescent dye) such that a planter or sprayer can be altered to quickly and accurately measure every seed as it is planted. Using accurate data on planting and practice, when combined with harvest data taken with a well calibrated harvester, growth functions can be built and used with the framework to allow farmers to make better decisions about their operations and allowing them to optimize in any way that they see fit.

### Example 3

### Example Systems Implementing the Technologies

The systems described herein can be implemented in conjunction with any of the hardware components described herein, such as the computing systems or mobile devices described below (e.g., comprising one or more processors, memory, and the like). In any of the examples herein, the inputs, outputs, models, databases, and applications can be stored in one or more computer-readable storage media or computer-readable storage devices. The technologies described herein can be generic to the specifics of operating systems or hardware and can be applied in any variety of environments to take advantage of the described features.

### Example 4

### Example Method Implementing the Technologies

The methods described herein can be performed by computer-executable instructions (e.g., causing a computing system to perform the method) stored in one or more computer-readable media (e.g., storage or other tangible media) or stored in one or more computer-readable storage devices.

### Example 5

### Example Implementation

The systems and methods herein can collect data related to crop production and harvest for use in creating a predictive analytics system useful in collecting crop production data including input amounts and types, soil types, soil terrains, weather conditions and crop yields. This data may be processed to generate a base profile for crop prediction model allowing key variable substitution (seed genetics and/or nitrogen input) for prediction of yields and estimation of the impact of the variables substituted under certain conditions, i.e. by varying weather conditions including, for example, moisture, days of sunlight and daily average temperature.

### Example 6

### Example Implementation

The web portal described herein is an exemplary embodiment of how a website that allows user access, data input and manipulation can work for data collection and input into a prediction model, such as those described herein.

The examples of forecasting crop yield described exemplary embodiments of how an evaluator/predictor model can work based on data collection and user input via the data collection systems and user interfaces described herein.

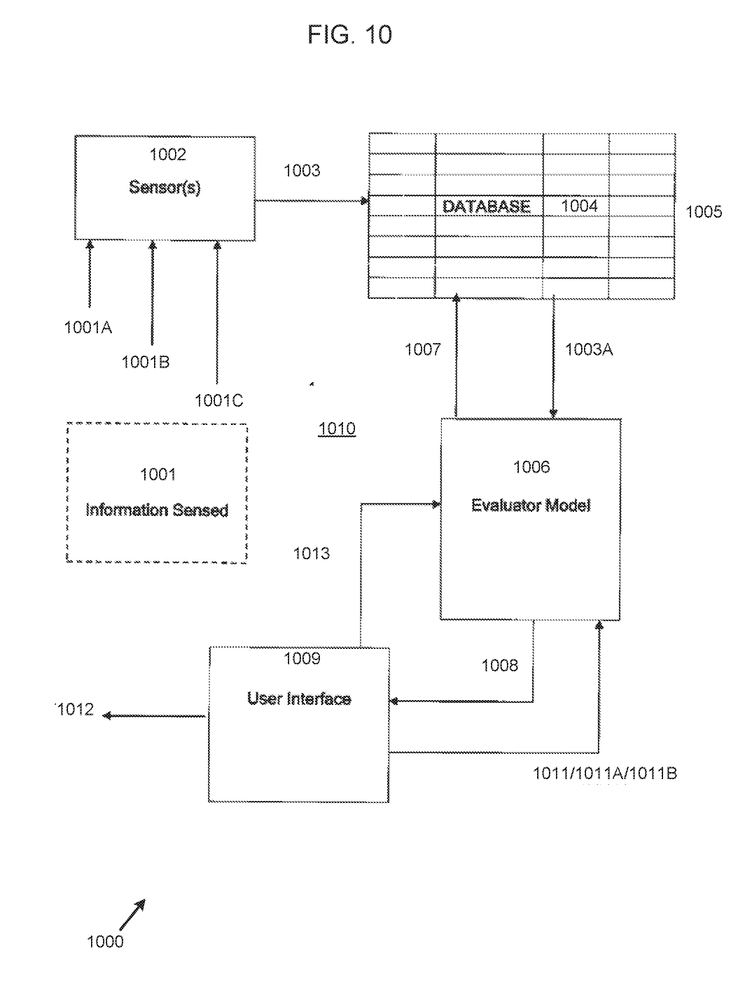

FIG. 10 is an example system in which any of the technologies described herein can be implemented.

### EXAMPLE LISTING OF ELEMENTS

| Element Description | Element Number |
|---|---|
| Information (sensed) | 1001 |
| Sensor(s) | 1002 |
| Data | 1003 |
| Database | 1004 |
| Server | 1005 |
| Evaluator/Predictor Program | 1006 |
| Calculated Results | 1007 |
| Transmitted Report | 1008 |
| User Interface | 1009 |
| Crop Model and Prediction Analytics | 1010 |
| System | |
| User Input | 1011 |
| Hypothetical information | 1011a |
| Assessment | 1012 |
| Selected crop | 1013 |

An example crop model and prediction analytics system for predicting crop yields is disclosed and includes sensing information 1001 that affects the yields of a particular crop 1013, which may be selected by a user via interface 1009. FIG. 10 provides an exemplary illustration of how one embodiment of the present disclosure may be enabled. A sensor(s) 1002 or a sensor system 1002a then converts the sensed information that affects the yields of a particular crop 1013 to data 1003. This data 1003 can be collected and arranged in a database 1004 and can reside on a computer or specialized, dedicated server 1005 (not shown).

An evaluator/predictor model 1006 can also reside on server 1005 or may reside on a second server 1005a or combination of a network of dedicated servers. The evaluator/predictor model 1006 processes the input data 1003a of the particular crop 1013, makes calculations and produces calculated results 1007 which may then be used in an iterative process for additional calculations useful in predicting the future performance of the particular crop 1013 based on the evaluation of the converted data 1003, based on the information sensed 1001.

The information sensed 1001 (collectively, individually 1001a, 1001b, 1001c, etc.) can include any one or more of the following, or as found in any of the examples herein as useful in evaluating/predicting the yields of a particular crop, as follows: Geographical information, GPS coordinates, crop type, seed type, seed population planted, date of planting, seed genetics, weather conditions, soil conditions, soil terrain, soil fertility, selection of equipment used for soil preparation, selection of equipment used for planting, selection of equipment used for harvesting, date of harvesting, type of fertilizer used, amount of fertilizer used, date of application of fertilizer, method of application of fertilizer, weather conditions prior to planting, weather conditions during planting, weather conditions during growing, weather conditions during harvest, weather conditions during fallow periods, weather history, or combinations thereof.

Further, as disclosed herein, although not shown, the information sensed 1001 for input into the crop model and prediction analytics system 1010 may also be provided by and include any information received from a sensor connectable to a machine useful in delivering seed or soil amendments to soil, conditioning soil, or harvesting particular crop. For example, and without limitation, a user may connect or upload data 1003 and equipment characteristics 1011a from a crop planter directly into the system disclosed herein via user input 1011.

The data 1003 can be transferred to a server 1005 wherein the evaluator/predictor program 1006 resides for prediction calculations. The evaluator/predictor program 1006 can incorporate any of the modeling or prediction technologies describe herein. The evaluator/predictor program 1006 produces a prediction of a crop's yield which is transmittable to the user, over a network or by any other means or media which is readable and useful to the user.

In the embodiment disclosed in FIG. 10, the evaluator/predictor program 1006 produces a transmittable report 1008 containing an assessment 1012 of a crop's yields and a prediction of a crop's yields based on a user's input 1011 and the initial prediction to provide an assessment of the impact the user's input has upon the predicted crop yields.

The information which may be selected an input by the user, may be similar to the information sensed, but is not exclusive to include, geographical information, GPS coordinates, crop type, seed type, seed population planted, date of planting, seed genetics, weather conditions, soil conditions, soil terrain, soil fertility, selection of equipment used for soil preparation, selection of equipment used for planting, selection of equipment used for harvesting, date of harvesting, type of fertilizer used, amount of fertilizer used, date of application of fertilizer, method of application of fertilizer, weather conditions prior to planting, weather conditions during planting, weather conditions during growing, weather conditions during harvest, weather conditions during fallow periods, weather history, or combinations thereof.

The user's input 1011 may include other information that is not sensible (e.g., is not collected by a sensor), hypothetical information 1011b, which may include without limitation: hypothetical equipment characteristics, hypothetical seed genetics, hypothetical application rates of fertilizers, hypothetical weather conditions, hypothetical moisture rates, hypothetical input costs, and hypothetical output values (prices) related to a particular crop or crops which may be produced.

### Example 7

### Example Implementation

A crop model and prediction analytics system that can collect relevant crop input and information useful in monitoring and predicting a crop yield upon is disclosed. The crop model and prediction analytics system can be useful in predicting crop yields and allows a user to input hypothetical information to produce predictions useful in selecting a particular combination of land, inputs and output yields and values.

### Example 8

### Example Agronomic Web Portal

Although data used to implement the technologies can be collected in a variety of ways, the following describes example web portal features by which agronomic data can be collected. Such a portal can aggregate agronomic data collected into an integrated agronomic database from which models can be built and predictions can be made.

Successful crop production is increasingly dependent upon the need for detailed, timely, accurate, and useful information. The described technologies can meet that need by collecting and integrating these “mountains” of disparate, incompatible data from grower participants in the network and converting those data into valuable information, insights, and knowledge farmers can use to improve their management decisions. The technologies can do all this while fully protecting the privacy and security of each individual farmer's data. This process can compress years of production experience into each growing season so farmers don't have to rely exclusively on their own individual experience. The technologies can help complete the transformation of farming into an information intensive business.

Functional features for a version of a website are described herein. The website can make it easy for farmers to enter data and view information about their operation. The website can be so intuitive that anyone using it does not have to pause and think about how to use any of its features.

In an example feature, a User selected and opened a particular Farm, and then selected a specific Field to add an Event. When done adding the event and closing dialogue boxes, the User can still be viewing the same Farm/Field List view the User used when the User selected and “opened’ a particular Field. However, as stated above, if the User wants to close the dialogue boxes and return to the User's main Home Page, the User can click the Home button at top left of the bar on top of screen to close dialogue boxes and return home. As appropriate, the User can be asked if the User wishes to close a dialogue box without submitting and data or changes.

When a User opens any Farm, the browser can zoom to an extent that includes any Fields that have been created for that Farm.

Users can be prevented from modifying Master Lists for Equipment, Seed, and the like. They can add a product they use, but can be prevented from adding to the Master List, which administrative personnel will review to determine whether or not to add to Master Lists. User(s) will still be able to see/use the item they added on their personalized “short lists”. A mechanism can be implemented for making administrative personnel aware of any nonstandard item Users have added to their “short lists,” but was not added from a Master List.

Navigation within functionality for Assets like Seed, Chemicals, Equipment, etc. can be made as similar as possible so as not to confuse Users. They need not be identical with regard to navigation, but can be made as similar as possible.

Users can be led through the functionality in a step-by-step basis using any of a variety of user interface features such as wizards, forms, tool tips, and the like.

### Example 9

### Example Web Portal: Sign in

Sign In (Existing Account):

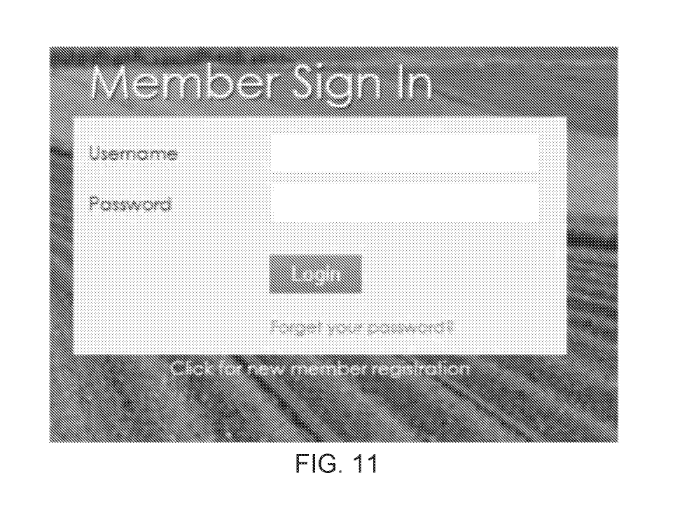

When an existing Member (or other Authorized User) signs in, the User clicks the Sign In button, and the pop-up box shown on FIG. 11 can appear:

A User can enter the User's Username and Password to enter the site. The user can use a cursor and click Login to Login or simply press the Enter key on the computer and get the same result. In both cases, the Member/User Home Page can then open.

If the User wishes to close the sign-in box shown in FIG. 11, the User can click Home at the lower left of the screen or to simply press the escape key on their computer to close the Login box. The Home link option can still remain an option for the User to close this box.

### Example 10

### Example Web Portal: Create New Account

Create New Account:

If the User does not yet have an Account with the administrator of the system, the following processes can be followed:

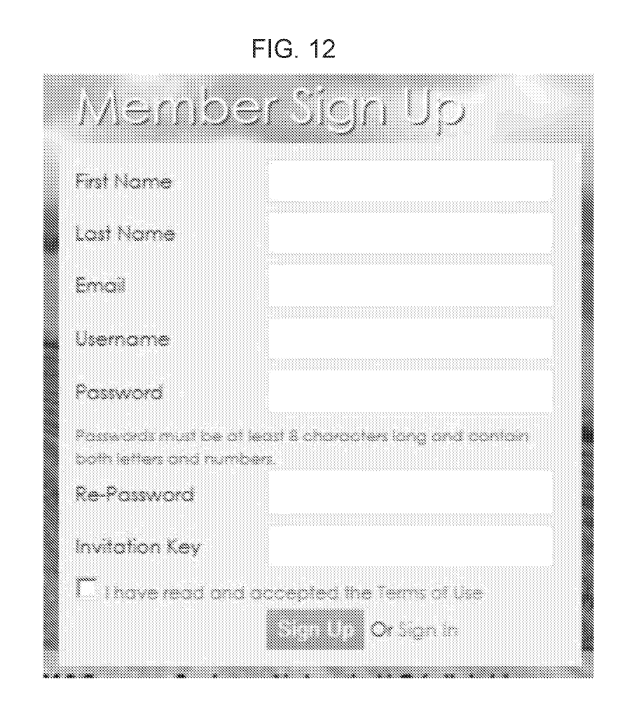

The first step in signing up is creating an Account for the Primary User: Currently, when one clicks ‘Sign Up’ on a Public Site Home Page, a new dialogue box opens (See FIG. 12) requesting info from the new User. The person setting up the new Account can already have received an Invitation Key from the administrator to be able to proceed. If the person trying to sign up does not yet have an Invitation Key and realizes one can't sign up without one, the User can close the dialogue box. The User can press escape, click on a close box (not shown), click on a Home icon or the like. Background colors can be slightly darker so data Input boxes are easier to see.

The title of the box can be “Account Sign Up.”

The User Name and Password entered here can be used to gain Account access for Primary Account User.

The email address can be entered twice to verify accuracy.

The following can be added to FIG. 12:

Enterprise/Business Name: For example, the legal name that the Primary User operates the User's Farm(s) under. Enterprise can be the total Farming operations associated with an Account.

Mailing Address (Data Input)

Physical Address (Data Input)

City, State, Zip code, Email Address, Cell Phone Number, Home Phone number, Business Phone number

At the bottom of the Sign Up page, a CAPTCHA can be presented for Users signing on for the first time.

Invitation Key: On the log-in/sign-up page it can be explained that when the User completes the information above, the administrator will email the User an Invitation Key that can be used to log into the User's personal Account for the first time.

The first time a User clicks Submit on the Sign Up dialogue box (or after signing in the first time using the Invitation Key), the Terms and Conditions document can appear with an ACCEPT and DECLINE button, and the User then accepts the Terms and Conditions before getting User site access. Once accepted, the User will go to the User's personal home page where the User can begin using the Services.

If the User declines the terms and conditions, the browser can return to public Home Page.

### Example 11

### Example Web Portal: User Home Page

User Account Home Page—Top Bar Menu

Once the initial Account setup has been completed (User has accepted Terms and Conditions and the User Home Page has opened) the User's Home page can say “Welcome <Primary/Secondary Account Users Name>”. For example, small type can be used at the upper part of the home page (e.g., in a top bar, in upper right hand corner, or the like). This can also happen each time a User accesses their Home Page.

The Home page displays the Farms and Fields of the User as background on the User's home page, to the extent that any Farm(s)/Field(s) that have been created are still visible. If the Enterprise (total Farming operations for the Account) is too large to accommodate, the browser can show a view that includes as many Farm(s)/Field(s) as possible as visible with the Account's physical address at center of screen.

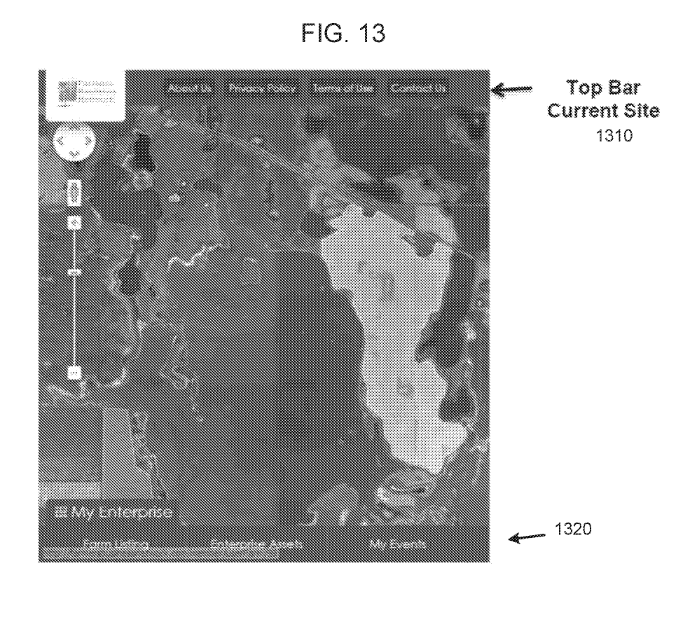

FIG. 13 shows an example top bar 1310 that can also list the following:

Home: Clicking Home can close any open dialogue boxes and return the browser to User's default home page view. With regard to open dialogue boxes, the User is asked if the User wants to close without submitting which has a Yes/No answer. If the User responds with a Yes, the dialogue boxes will simply close, and the browser returns to the Home page.

Account Profile: This can contain current profile information for the Primary User. A button can be included on that information dialogue box to add Secondary User(s) as explained below.

When clicked, ACCOUNT PROFILE can open to view/edit/add/delete the data and information that was created for the Primary User or Secondary User(s) when their Account access was set up and, of course, reflect any subsequent changes made by User(s). Secondary users can also be accommodated.

The following data can be entered for the Primary User during the Account setup process. For example, a Primary User can the person responsible for the overall Account management and also manages access for any Secondary Users that are created for the Primary User's Account. The Primary User may be the owner/operator, or a person to whom the owner/operator delegates the responsibility for Primary Account Management and Maintenance.

Primary User Name: (Data Input—Pre-populated: Input here only if different than name inputted on sign up page dialogue box (See FIG. 12) If the information is the same as that for the information entered in Account setup, it need not be entered a second time. This Account setup data can pre-populate these data Input boxes and can be edited to change if desired. It can default to the sign-up name entered into the dialogue box used when the Account was created or change the name if different name is desired.

Enterprise/Business Name: This can be the legal name that the Primary User operates his Farm(s) under. Enterprise means the total Farming operations associated with an Account.

Mailing Address (Data Input), Physical Address (Data Input), City, State, Zip code

Email Address: (Data Input) Can be input when different than the Email address Inputted on the sign up page dialogue box. (See FIG. 12) If different than the email address Inputted on sign up page, it can be enabled to edit to change the Primary User email address. It can default to the sign-up email address entered into the dialogue box used when Account was created or change if different email address is desired.

Cell Phone Number, Home Phone number, Business Phone number:

A User can also be able to change their User Name and/or Password here.

The other selections from top bar 1310 in FIG. 13 can include the following:

Terms of Use: Click to view the Terms & Conditions of Use Agreement.

Privacy Policy: Click to view the data and information Privacy Policies of the administrator.

About Us: About the administrator.

The Primary User Account information is now complete so the User can begin setting up their Farm(s) and Fields. Once the Farm(s) and Field(s) have been created, the User can create customized short lists for Seed, Chemicals, Fertilizer, and Equipment. These short lists, can make it much quicker and easier for the User to record Events (Events can be Field tasks, weather events, etc.).

### Example 12

### Example Web Portal: User Account Home Page—Bottom Bar Menu Selections

The existing menu selection can be placed in a bottom bar 1320 of the User Home Page of FIG. 13.

The menu selection list can include the following menu options (e.g., horizontally):

My Enterprise can be removed.

Farms & Fields: When clicked, Farms & Fields can pop up to view existing Farm(s) or to Add a Farm.

Inputs: Click to view pop-up menu with Seeds, Fertilizer, Lime, & Chemicals

Equipment, Events, Data Upload, Mapping, Reports

Other arrangements are possible (e.g., put menu options on a sidebar on left or right of screen).

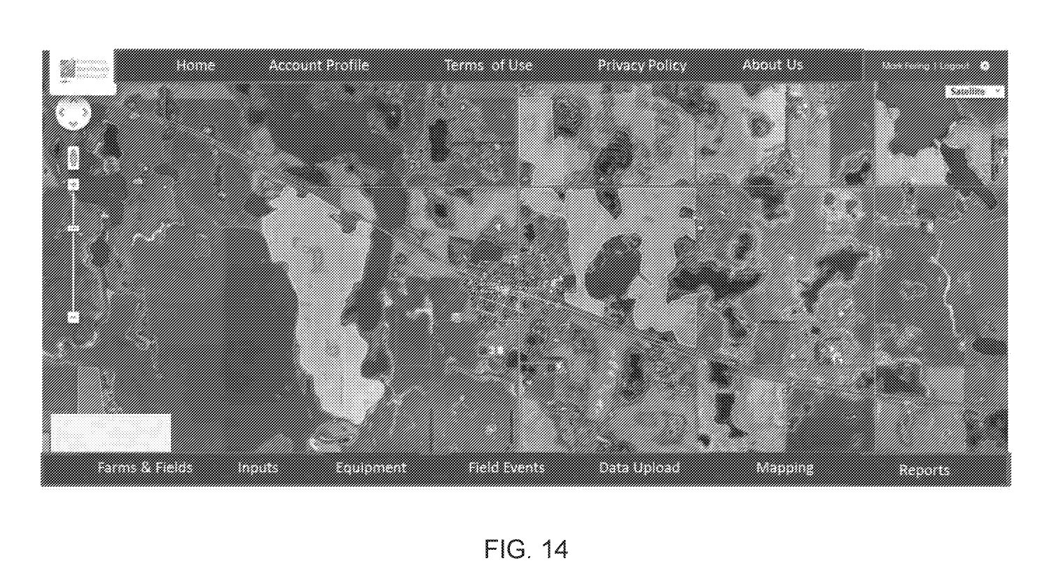

An example alternative implementation of the User home page is shown in FIG. 14.

### Example 13

### Example Web Portal: Secondary User Accounts

Setting Up Secondary User Accounts:

(Can be done at any time after the User creates the Primary Account. Secondary Users can have their own logon name and password and then be able to select any Enterprise for which they have authorization(s) to view, edit, or delete per permissions for all the Primary Accounts for which they have been granted access privileges.)

Secondary User(s): First Name

Secondary User(s): Last Name

Mailing Address

Physical Address, City, State, Zip Code, Email, Phone number

The above can be Data Inputs.

Secondary User Permissions:

A Primary User can create as many Secondary User Accounts as desired. A Secondary User, in some cases, may be granted access privileges by multiple and different Primary Account Users (Example: For a crop consultant working with multiple Enterprise/Farm operations.)

Primary Users can grant to Secondary Users permission to access their entire Account, selected Farm(s), etc. and to have full User control or selectively granted permissions. An example list of options that a Primary User can use to grant access/use permissions of Primary User's Account to a Secondary User follows:

| Full Use/Control | Limited Use |
|---|---|
| Enterprise | Selected Farms |
| Total Farms & | Selected Events |
| Fields | |
| All Assets | Selected Assets |

* Permissions for Selected Farms, Events, and/or Assets can be limited to Full Control, View Only, Edit, Add, or Delete.

Secondary Users can be prevented from granting access permissions to any other User.

### Administrator Accounts

Administrator customer support personnel will need access to User Accounts so that they can help Users with any questions and problems they may have. An Administrator Account can be implemented like a Secondary Account that has full privileges for all system Accounts.

Administrative personnel (whether employees or contracted workers) can be screened carefully and be required to sign a very strict Confidentiality and Non-Disclosure Agreement to help safeguard the privacy and confidentiality of Users' individual data and information. Administrator Accounts can be given only to personnel that need such access privileges to help Users resolve issues.

Primary Users need not give the Administrative personnel permissions to access the data and information in their Account. Administrative Accounts can have access to total User Accounts. This is because it is desirable to have Administrator Accounts of this nature in order to resolve customer issues as promptly as possible.

### Example 14

### Example Web Portal: Farms & Fields

Add New Farm(s):

The next step for new Users is to set up their Farm(s). How this is done can vary from one Account to the next simply because the business structure of Farm operations can vary considerably. Regardless of the User's business structure, the described technologies can enable Users to set up the Account in the way the User views the User's operation. Some Accounts will have many Farm(s) operated under the umbrella name shown in the primary Account Profile, while others may operate under only one Farm name.

In either case, to create a Farm(s) for the first time, the User clicks <Farms & Fields> on the lower left part of the User's Home Page. A pop up will appear with any existing Farm(s) shown as well as a link to <Add New Farm>.

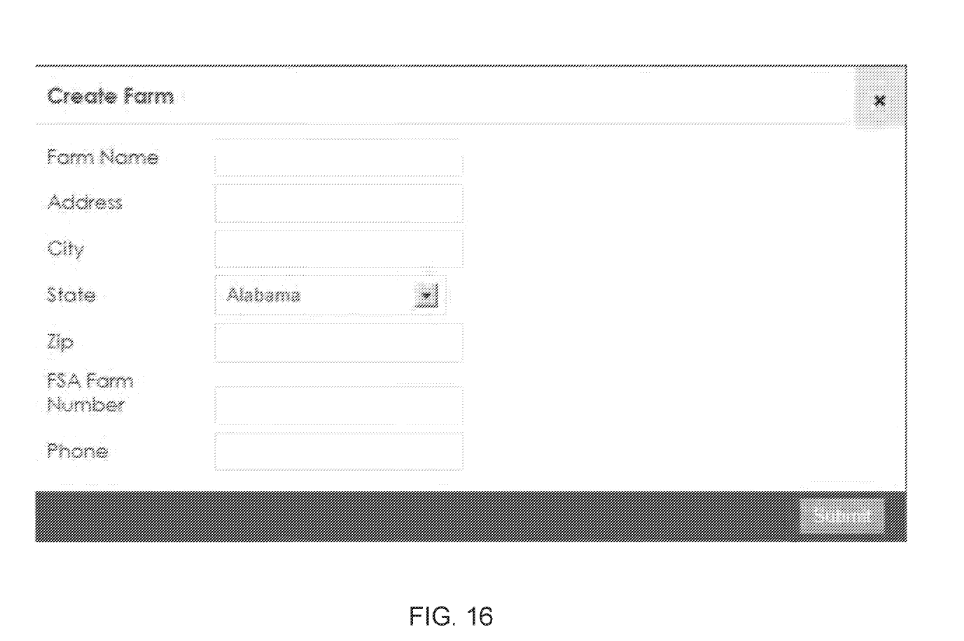

When <Add New Farm> is clicked a user interface such as that shown in FIG. 16 can appear:

### User Enters:

Farm name (Data Input), Address (Data Input), City (data Input) County, State (dropdown), Zip (dataInput), FSA Farm Number (Optional) (data Input), Phone Number (Data Input)

The user can activate “submit” to enter revised data for the Farm into system or Click X in upper right of box to close without submitting. If the User clicks the X to close, a dialogue box can pop open and asks “Are you sure you want to quit without saving/submitting? User selects Yes or No. If User selects No, the browser continues to show the dialogue box. If User clicks Yes, browser returns to User Home Page.

This information requires Data Input entry into Data Entry Boxes shown, except that County and State can be selected from a pull down menu list. The dialogue box can be narrower and/or adjustable.

A User Account can create as many individual Farms as needed. Individual Field(s) can be subsequently be assigned to the specific Farm(s) the User has created. Any individual Farm can include as many associated individual Field(s) as needed to accurately represent the Primary User's Farming operations.

Once the User has set up the User's Farms, the User can click on the Farms & Fields tab which can be on the lower left part of the User's Home page to access any particular Farm desired.

View, Edit, Delete Farms that have been Created:

The user can click Farms & Fields to display list of Farms (assumes User has already created/set up at least one Farm) as a pop up list.

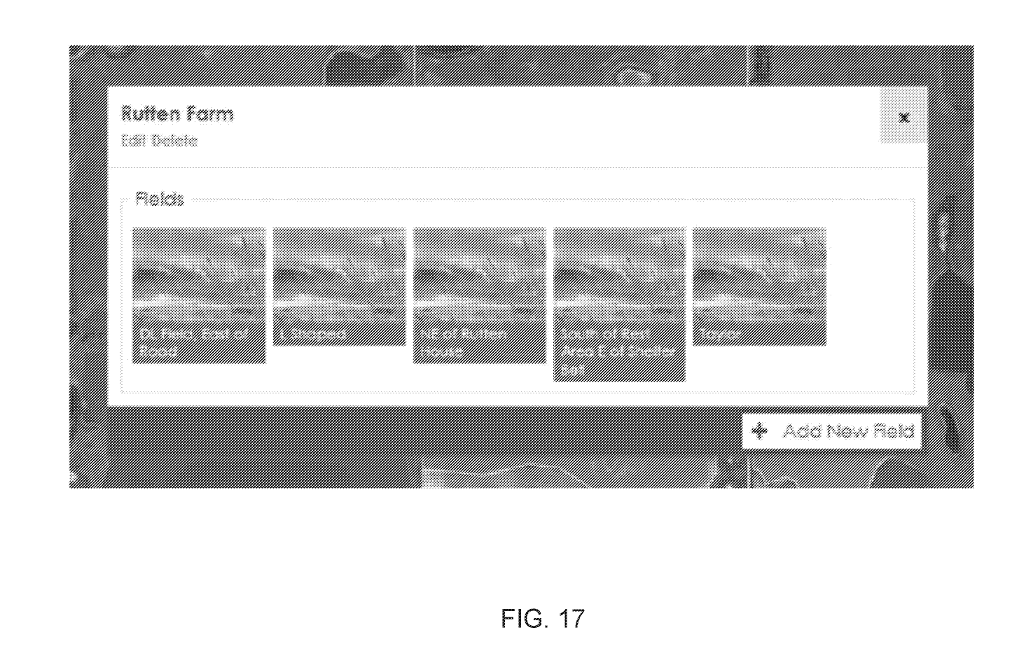

Select a Farm—Select by clicking on name of an individual Farm. This can open the dialogue box shown in FIG. 17 to View, Edit or Delete the Farm or to navigate to Field information/data. For example, in FIG. 17, the interface can include View, Edit, Delete directly below the Farm name (e.g., in blue letters as shown or otherwise).

If there are any existing Fields for the Farm Selected, the browser can zoom to an extent that includes the Field boundaries for the Fields that have been created for that particular Farm. (e.g., Assuming boundaries have been created. Otherwise the browser can move the map so that it is centered/hovers over the Farm address.)

If a Farm is Viewed/Edited/Deleted, the information box, as shown in FIG. 16 (e.g., or a revised version thereof) opens, Changes can be made and submitted by activating “Submit.” If the User decides to not make the changes or has made mistake of some type, the box can remain open until the User activates “close” on the dialogue box or activates a close box, upon which the browser reverts to view shown in FIG. 17. Close confirmation can be provided. Instead of “submit,” other phrasing such as “save” can be used in any of the examples herein.

Double clicking within or otherwise activating an existing Field boundary can give the same result as clicking on a Field name in dialogue the box of FIG. 17.

If a Farm is deleted, the browser can go to User's Home Page. The User can activate the close box (X) to close dialogue box without saving changes. The interface can ask a Y/N question (e.g., “Close without saving changes?”) The Farm can be deleted only for the production year in which it was deleted. Any historical data from previous years for a deleted Farm can remain in the database.

After a Farm dialogue box has been Edit(ed) and Submit(ted), the browser can return the dialogue box with the Field listing for the Farm in question. The page can return to page showing total Fields for that particular Farm. It need not return to the user homepage.

Alternatively, the user interface can create a Dialogue Box that opens when User selects Farms & Fields. The dialogue box can list about 10 Farms and if the User has loaded more, the User can click a control button that says “MORE” that takes User to a new dialogue box listing the rest of the Farms. There can be as many dialogue boxes as necessary to list the total Farms. User clicks control button that says “BACK” to return to previous box or clicks the X in upper right corner of any of these dialogue boxes to close out and return to User's Home Page. Changing the Farms Listing from a pop up of individual Farms to a dialogue box may be desired because the current pop-up may not have enough room to list enough Farms loaded in some Accounts.

### Adding New Fields

There can be three different ways a User can add Field(s) to specific Farm(s) and create Field boundaries for respective Field(s). Users can develop a preference for which method they prefer because a couple of the Methods are perceived easier than the other one.

### Method 1: Creating Field(s)—Manually Draw Boundaries

Using Method 1, the process for adding a new Field to a Farm is as follows. From the dialogue box for any particular Farm (example is Rutten Farm, FIG. 17):

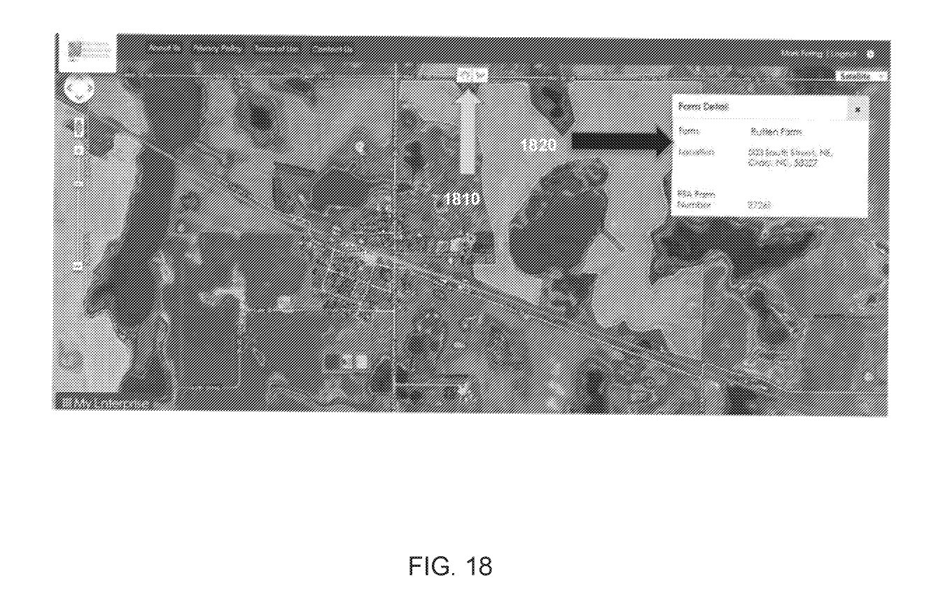

Click: Add New Field (In box on lower bar, right side as shown in FIG. 17). A user interface such as that of FIG. 18 can appear after clicking Add New Field.

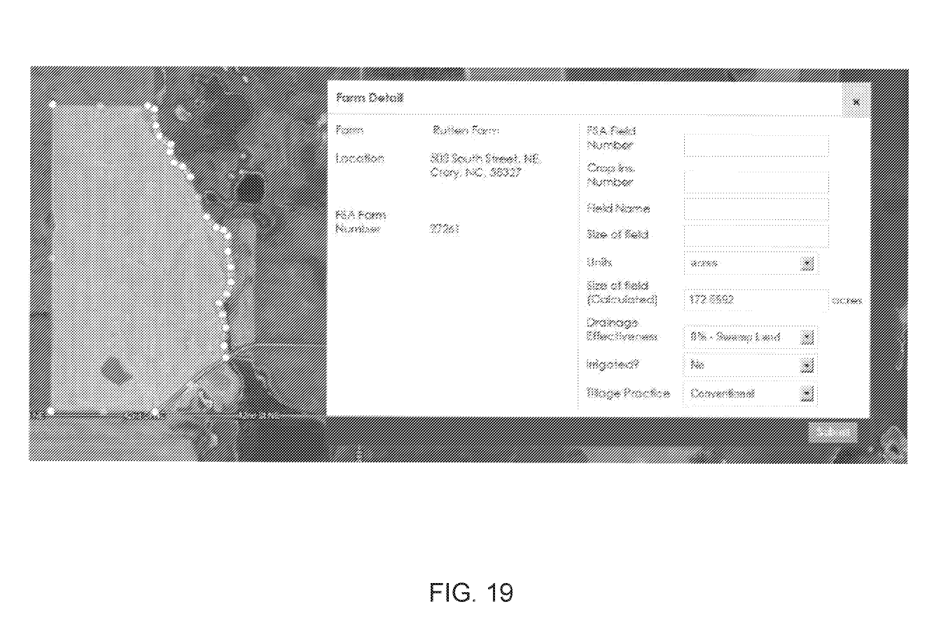

The dialogue box 1820 in FIG. 18 can be modified to indicate how to use the pan and polygon drawing tool 1810 to help new or inexperienced Users. A dialogue can appear explaining the how to create the Field boundary. Currently the User can navigate to draw a Field boundary and then complete the information about the Field in the dialogue box as shown in FIG. 19. There can be instructions or explanation about how to create/draw the Field boundary.

Internal Boundary Polygons: The user interface can support the ability to draw polygon boundaries for areas within the primary Field boundary. For example, the Farmer can draw a boundary around a large area of sitting water that is in the Field. The Farmer can do this as many times as desired. The internal boundaries can be drawn so as to not overlap. Responsive to determining that an internal boundary overlaps another internal boundary, an error condition can be generated or the user can be otherwise prevented from drawing such overlapping internal boundaries.

The acreage of such internal boundaries can be subtracted from the total calculated Field acres. This will help determine the number of acres actually available for crop production within a Field. In some cases, the outside boundary alone does not tell the whole story.

Instead of being named “Farm Detail” the Dialogue box of FIG. 19 can display can give the <Farm Name> (Hyperlinked to Farm Description Dialogue Box)—Add New Field: in title at top. For example, it could say Rutten Farm: Add New Field. This box is currently completed after Field boundary has been drawn. The User can be given the choice of completing data entry into the dialogue box first and then drawing a Field boundary or do it in the opposite order.

The new dialogue box of FIG. 19 can contain the following data entry Fields:

Field Name (Data Input), Size of Field (Can just show units in acres and drop unit type selection), Units (e.g. Acres), Size of Field (Calculated), FSA Field Number (Data Input), Crop Insurance Number (Data Input), Irrigated (Y/N), Tiled (Y/N), Drainage Effectiveness can be deleted.

In FIG. 19, the Farm information description (left side) can be removed from the Add New Field dialogue box as explained above. (The <Farm Name> Add New Field can be shown in title bar, as previously explained above). If the User wishes to view the Farm information, the User can click on the name of the Farm in the title at the top of the dialogue box and the dialogue box (as shown in FIG. 18) for the Farm selected opens. The Add New Field dialogue box can be kept open when this is done. After the User closes the Farm Information dialogue box, the Add New Field dialogue box can still be shown so that it can be completed or closed.

### Creating Field Boundaries (Manually Drawing):

When Users are given the option of completing the dialogue box before drawing the Field boundary, there can be a button on the dialogue box that says “Draw Field Boundaries” When that button is clicked, the current dialogue box in FIG. 19 can disappear and a smaller dialogue box explaining the process to draw a Field boundary can be shown. The pan and polygon icons at top of screen can be explained and how to use them can be described. Such a Help box can be closed by a User if desired. Once the User has completed drawing the Field boundary, the Field information dialogue box (modified version from FIG. 19) can reappear in a size that does not encroach upon the Field boundary just drawn. The Submit button can be activated after completing data entry process.

### Method 2: Creating Fields—Click on User Uploaded Map Image

In order to use Method 2 to create/add Field(s), the User can upload map data from their equipment monitor thumb drive or flash memory card into their System Account. The uploaded data can be a yield map, spraying map, as planted map, or the like.

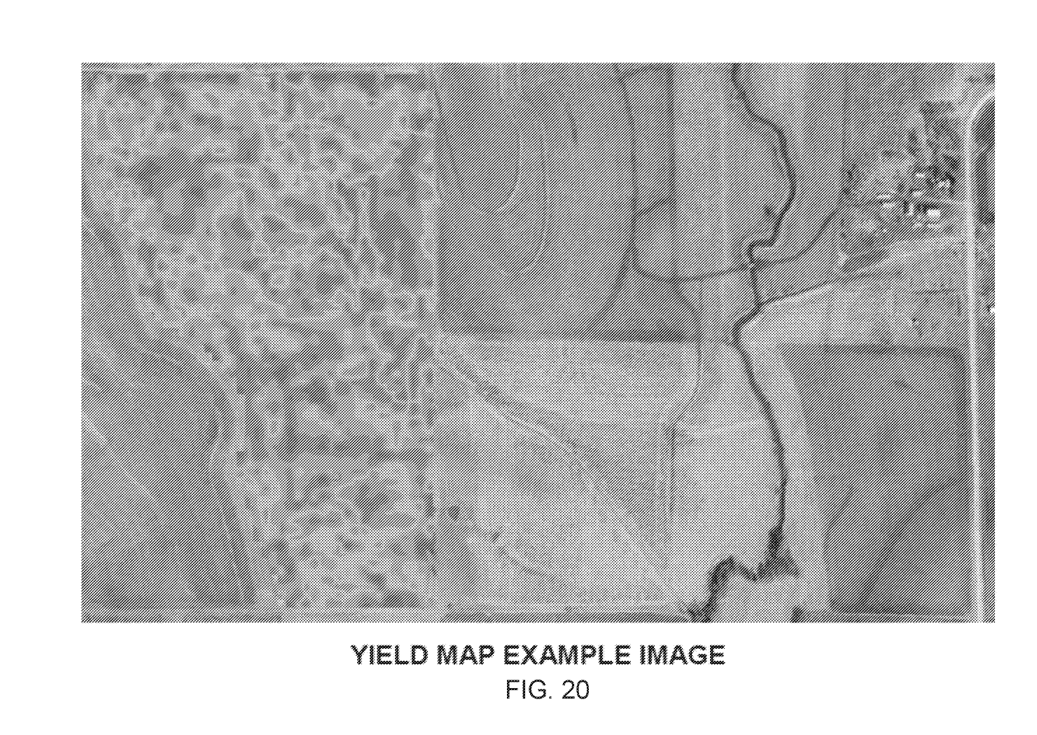

Once these maps are uploaded (e.g., Using a Data Upload process), they can be used to create Field boundaries and load important information about the Field. Uploaded maps will be viewable within the User's Account. FIG. 20 is an example of a Yield Map. Fields can be created separately.

In the example, using the mapping capabilities of the system, the User has located the yield map that was previously uploaded. To finish setting up this particular Field, the User can simply double click on or otherwise activate the image of the particular map image, regardless what type of image it is (e.g., yield, spraying, planting, etc.) and a dialogue box can open that is used to capture the essential information about the Field. The dialogue box can request the following information:

Farm Name (Pull down menu of existing Farm(s) sorted alphabetically; Field Name (Data Input); Size of Field (Can just show units in acres and drop unit type selection); Units (e.g. Acres); Size of Field (Calculated); FSA Field Number (Data Input); Crop Insurance Number (Data Input); Irrigated (YIN)

### Tiled (Y/N).

The User is asked to first enter the Farm Name. This can be done to associate the Field with the correct Farm. A drop down box which is used to assign the Field to a Farm can also be visible. The User opens the drop down and selects the Farm to which this particular Field is to be assigned.

Alternatively, the User can first select the correct Farm from the Farm Listing and then locate and click on the map image. If done this way, the Farm dialogue data Input box can already be prepopulated with the name of the Farm selected from the Farm Listing menu. Once the User has completed the dialogue box, the User can click Submit to load Field into system.

When using Method 2, a Field boundary (the perimeter) can be created for the Field map selected. Using this boundary, acres for this Field can be automatically calculated and Size of Field (Calculated) can also be prepopulated as well.

The system can support creating a Field in this manner from any screen in the User's Account where the uploaded map image is visible.

### Method 3: Creating Fields Using CLU Boundaries

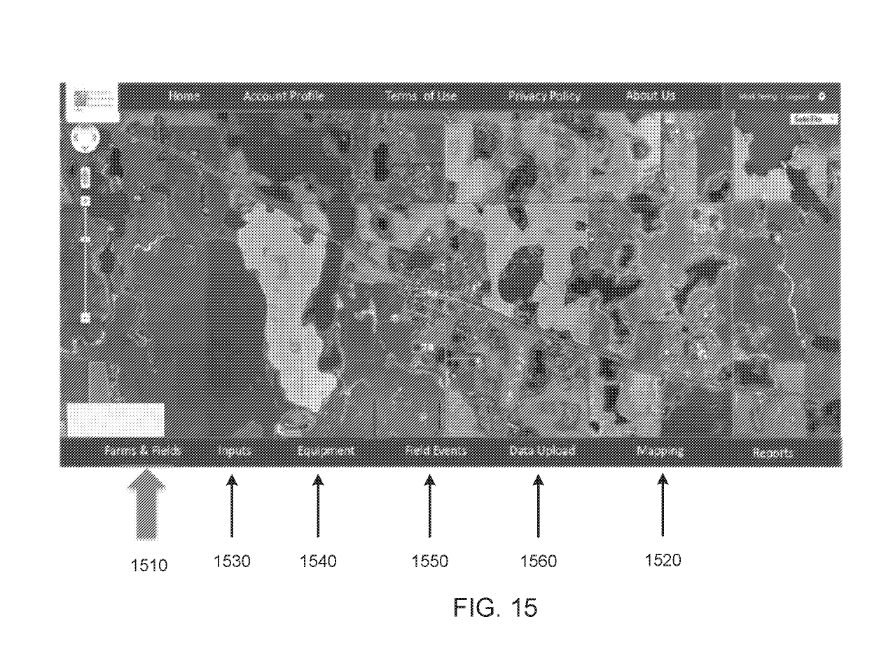

Common Land Unit (CLU) boundaries are created by the Farm Services Agency (FSA) of the USDA. Such information may be dated but can still be very useful. CLU's are a spatial data layer that shows governmentally mapped field boundaries. These can also be used to create Field boundaries when adding a new Field. This is another way for a User to create a Field boundary rather than manually drawing the boundary (Method 1) or clicking on a map image (Method 2). To create a Field using Method 3, the User can first click on Mapping 1520 (in the bottom bar of screen FIG. 15) on the home page.

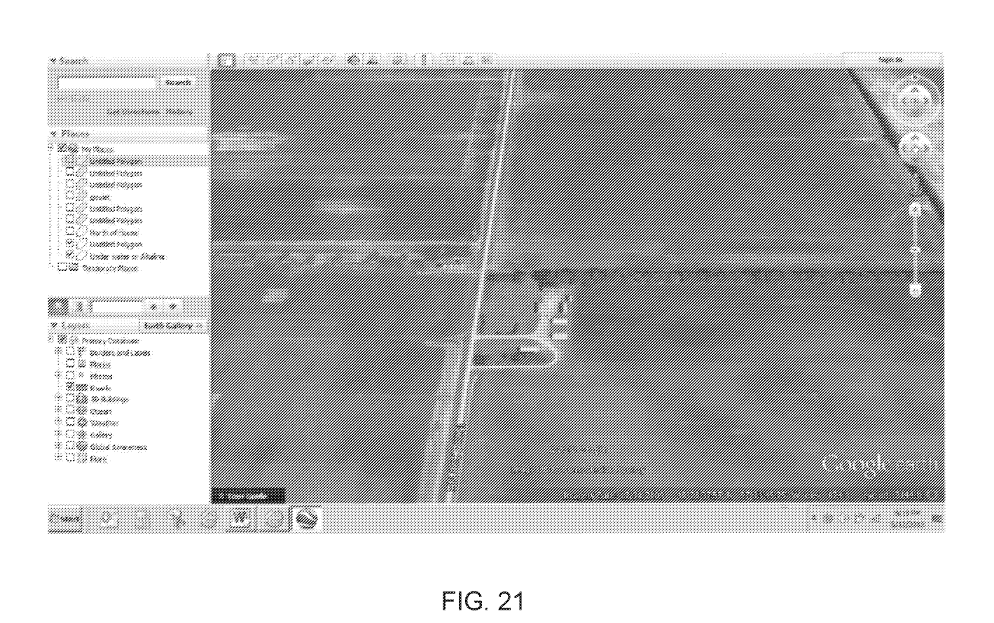

Clicking on Mapping can open up a Mapping view like that of FIG. 21. Although not shown in FIG. 21, under “Layers” on the left side of screen, there can be a layer named “CLU.” The User can check the box for CLU, and the CLU boundaries will appear. The User can move the map until the desired Field is shown on the screen. Once the User has identified the desired Field in the CLU layer, the process becomes very similar to Method 2. The User then simply clicks within the perimeter of the CLU boundary and a dialogue box like the one used for Method 2 will appear. The User can complete the dialogue box just as they would do under Method 2 and again click Submit.

When the User clicks within the correct CLU boundary, a Field boundary is created for that specific Field for the Farm selected in the dialogue box. Users may find that Method 3, like Method 2, is a much quicker and easier way to create Field boundaries than Method 1. To close out the Mapping View, the User can select the desired menu option from lower menu bar that has remained visible throughout the Three Methods.

Although some illustrations show features provided by particular mapping software such as Google Earth, any suitable mapping software can be used.

### Example 15

### Example Web Portal: Working with Fields

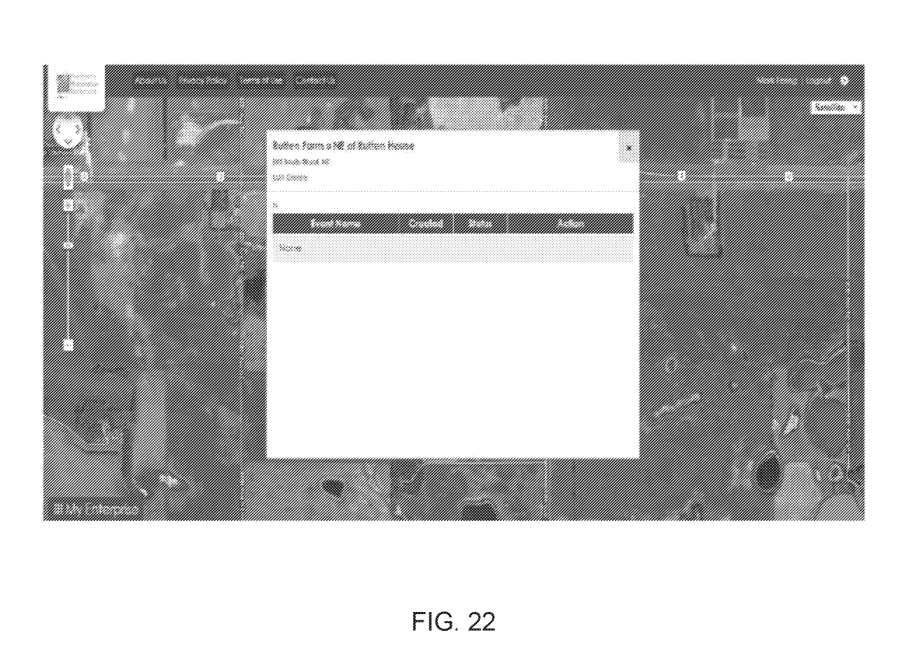

To access information for a specific Field, the User can click on the Farm name from the Farm Listing control and then click on the desired Field listed in the dialogue box (as in FIG. 17 below) or the User can simply click within the boundary of a created Field to open the Field information dialogue box (FIG. 22).

In Methods 2 and 3 to create Field(s) described above, Users clicked on map images or CLU boundaries to create the Field(s) in the FBN system. Once any Field has been created, something different happens when one clicks on any of the images or within the boundaries of a particular Field. Instead of creating the Field, the Field information dialogue box will open (like that shown in FIG. 19 or a modified version thereof).

Correcting errors is just one way Users can use this. If a User has made a mistake by creating a Field within the wrong Farm and wants to correct the mistake and reassign to the Field to the right Farm. The User can do so without having to delete the Field and having to start over and recreate under the correct Farm name. The User can simply click on or otherwise select the Field and open the Field information dialogue box, and click Edit under the Field name at top. The User can then simply correct the Farm name assignment in the Field information dialogue box (e.g., same one used when Field was created, like that shown in FIG. 19).

When a Field is selected (regardless of whether using the interface of FIG. 17 or directly clicking within boundary of a Field that has been created), the browser can then zoom to the selected Field, and the dialogue box shown in FIG. 9 will open. When you select and open a Field (using box above or double click within boundary) the browser can zoom to image of the Field boundary which can appear on screen and the dialogue box shown in FIG. 22 can open.

When a user selects and clicks a Field from the list of Fields (e.g., a Field is selected and opened), FIG. 22 can appear. If a User wants to open the Farm information dialogue box, the User can click on the Farm name at the top of the box. If the User wants to View, Edit, or Delete General Field information, the User can click on the name of the Field at the top of the box. In FIG. 22, Rutten Farm is the Farm name, and NE of Rutten House is the Field name.

The bottom half of the shown box can list the Events for that particular Field. There can be a control button that says Add New Event in the box. It can open the Events pop-up menu and enable a User to add an Event. When the Event has been entered, the dialogue box above can be opened showing the new, added Event in the list of Events.

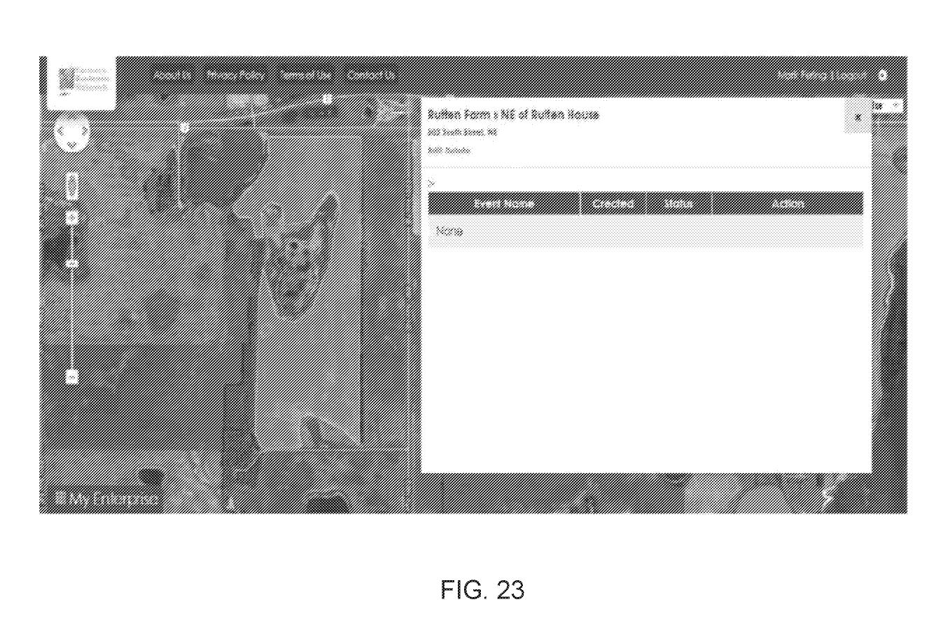

When a Field is selected, as shown in FIG. 23, the Field boundary created for the Field selected can be shown. The dialogue box as shown in FIG. 22 can be automatically moved to not cover up the Field boundaries view.

The Edit, Delete options can instead appear within the Farm or Field information dialogue box that was opened. The Farm address need not be shown in title bar of this dialogue box. That address can appear in the Farm information dialogue box (e.g., opened by clicking on the Farm name).

The dialogue box shown in FIGS. 22 and 23 can still open with the Events for that Field listed. However, it can be made apparent that one can click on an individual event to get the details for that event. Any Event listed can be linked to the information dialogue box for that Event.

The dialogue box shown in FIG. 23 can have a button to click if the User wants to Add New Event. The User can then select the event type from a drop down and go through the normal process of creating an event. An Event added this way can be for the Field that is open at the time. When done creating the new Event using this method (navigation path), the browser can return to view as shown in FIG. 23 above. As described herein, one can go to Events and create an Event for multiple Fields if desired.

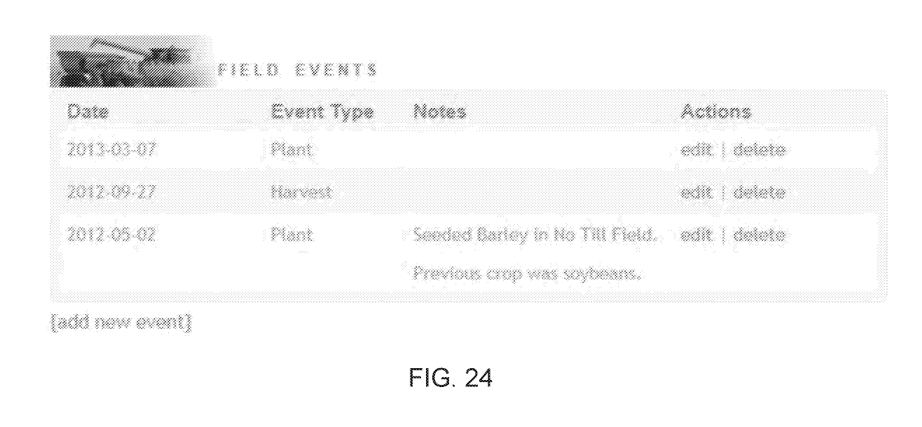

The Event list in the dialogue box can look like the user interface of FIG. 24.

The column headings can be as follows: Event Type; Date Created; Date Completed (if complete); Actions (Edit/Delete).

When the Farm/Field listing dialogue (as shown in FIG. 17) is closed, the browser can return to the User's Home Page.

### Example 16

### Example Web Portal: Inputs

Inputs can include the Seed, Fertilizer, Lime and Chemicals that are used (put into Field or on a crop) during the crop production cycle. When the User clicks on Inputs 1530 on the bottom bar (e.g., as shown in the FIG. 15), a pop-up menu can appear with the input choices mentioned above. There can be literally thousands of different types of Seed and Chemicals alone that are maintained in Master Lists.

User typically do not want to sort through so many choices. Therefore, using the tools in the Inputs section, Users can customize short lists of the products they are likely to use/apply.

After clicking on Inputs 1530, the User can then click on the type of Input the User wants to add to their short list. In this way, Users can create short lists for the different types of Input products they plan to use. Creating short lists is a good way for Users to save considerable time later when recording Field Events.

This again is the list of Inputs that can appear when the User clicks Inputs on the bottom bar, Inputs can be listed in the following order on the bar at bottom of a user interface:

Seed, Fertilizer, Lime, Chemicals

Regardless of the type of Input for which the User is adding product to their short lists, the navigation can be designed so as similar as practical. The navigation for selecting Inputs can be made as similar as possible, particularly for Seed and Chemicals.

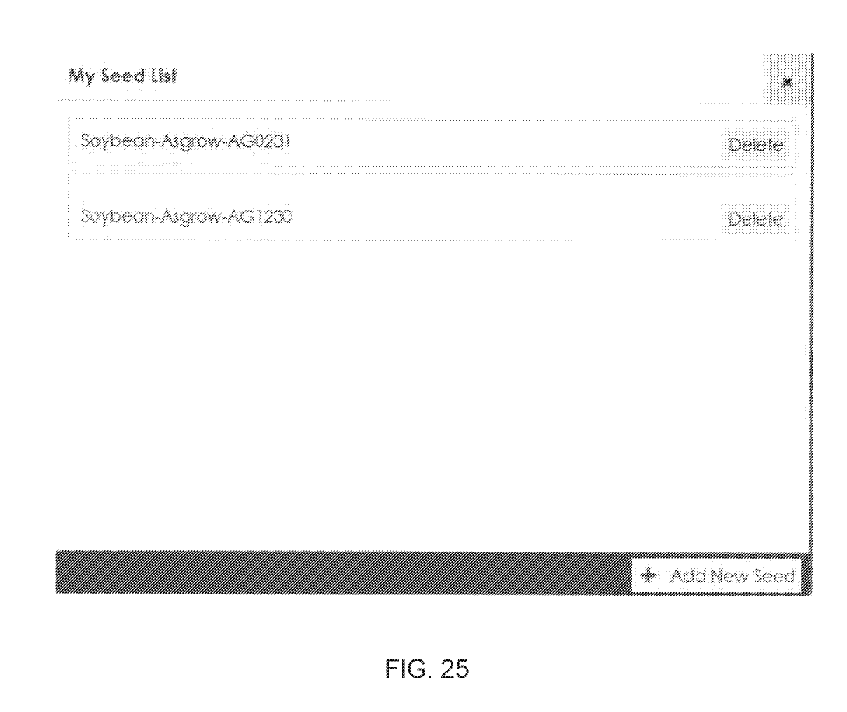

When Seed is selected from the Input pop-up menu, the User's current My Seed List (“short list”) for Seed can appear as shown in FIG. 25.

The dialogue box for the User's Seed short list shown in FIG. 25 can be automatically sized to show the current list of Seeds that User has selected. Users can delete a Seed type using this dialogue box, and can click on Add New Seed on the lower right corner of the box to add a seed type/variety to their short list which is called My Seed List.

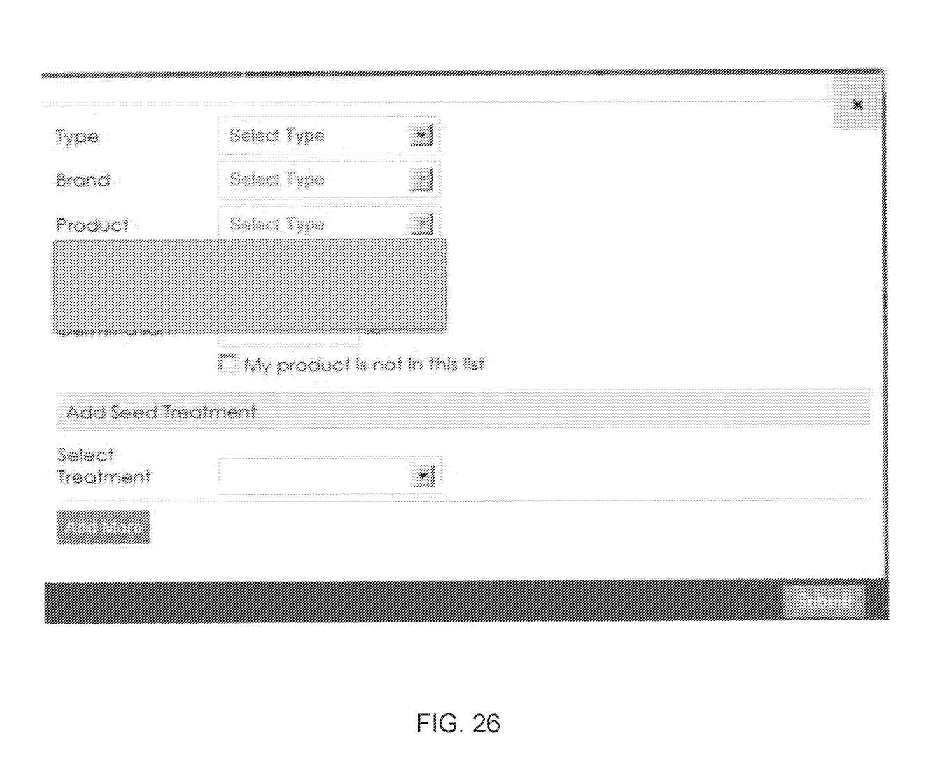

When a User clicks Add New Seed of FIG. 25 the user interface in FIG. 26 can be presented. The dialogue box can capture the following data:

Type (dropdown—Corn or Soybeans)

Brand (dropdown—Asgrow, Dekalb, Pioneer, etc.)

Product (dropdown, User selects the right product ID/number from list. For example AG0231, AG1230 as shown in FIG. 10 above).

Seed Size and Seed Germination % can be shown or omitted.

If the User checks “My product is not on this list”, the pull down menus can become data input boxes where the User can manually enter the product that is not on the Master List. Although a User is able to manually enter the appropriate data, the User-entered data need not be automatically added to the Master List for use for the drop down menus. Such information (e.g., Brands and Products) can be reviewed that are not on the Master lists that have been added by Users. A determination can be made whether or not they are to be added to the Master List.

Alternative Method to Add Brand/Product not on Master List:

When the box is checked indicating the Seed the User is looking for is not on the list, a new dialogue box can appear to enable User to enter the Brand/Product manually. Again, if this is done, the added Brand/Product can appear on the My Seed List but need not be automatically added to Master List (it can be reviewed by the administrator for possible inclusion in Master List as explained above).

Add Seed Treatment

A user interface for adding Seed Treatment can be presented comprising the following.

A drop down display list of seed treatments; Search seed treatments (Select from dropdown); Add, delete treatments to short list;

The user can add multiple seed treatments.

The user then activates “Submit.”

Page can then return to list of Seeds on “My Seed List.”

### Fertilizer

The setup of the “My Lists” (“short lists”) can make the navigation process as similar as possible while making it very intuitive.

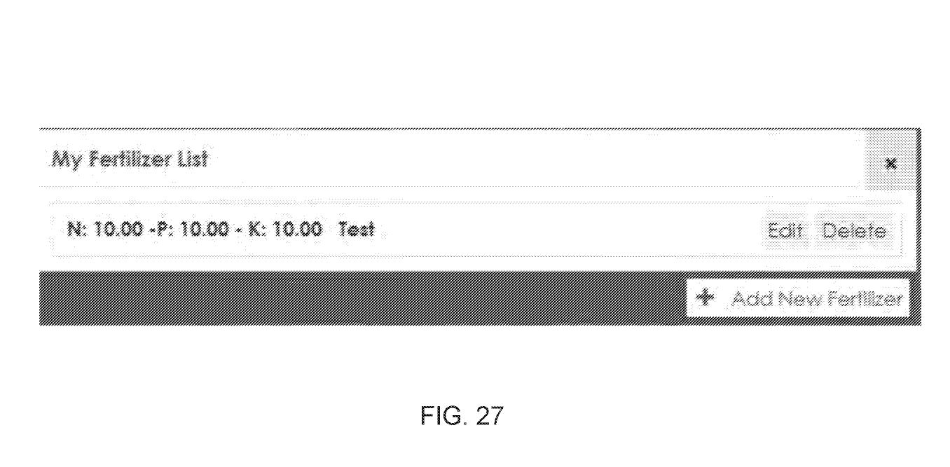

The My Fertilizer List can have the same look and feel as the Seeds list. It can look like the user interface shown in FIG. 27.

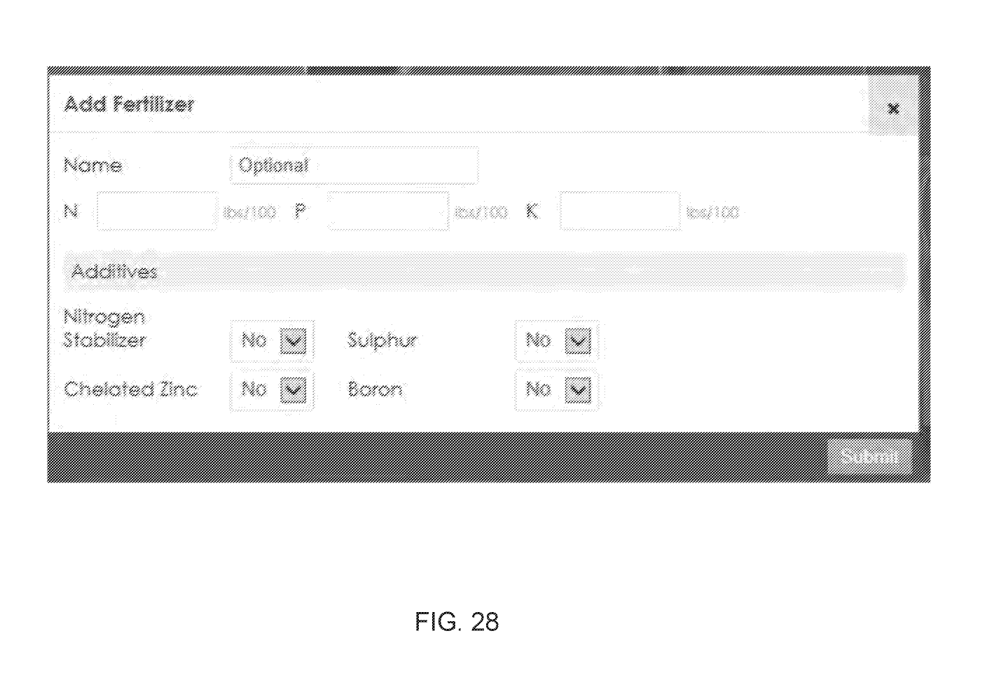

When Users want to Add New Fertilizer, they click “Add New Fertilizer” button. The style of the input for adding a new Fertilizer is somewhat different than seed. A user interface such as that shown in FIG. 28 can be used. Users can add, edit, or delete items from their My Fertilizer List. As with Seeds. Information collected can include: Name of Fertilizer (Is shown as the percent of N, P, K) Nitrogen (N) (data input); Phosphorous (P) (data input); Potassium (K) (data input); Add Additive Nitrogen Yes/No; Sulphur Yes/No; Chelated Zinc Yes/No; Boron Yes/No

When the User clicks Submit, the browser can return to My Fertilizer list. When My Fertilizer List is closed, the browser can return to User's Home Page.

### Chemicals

When a user clicks on Inputs/Chemicals, the user can be given choices to go from there:

My Chemical List; My Tank Mix; My Seed Treatment

My Seed Treatment can be alternatively shown with the Inputs/Seed menu.

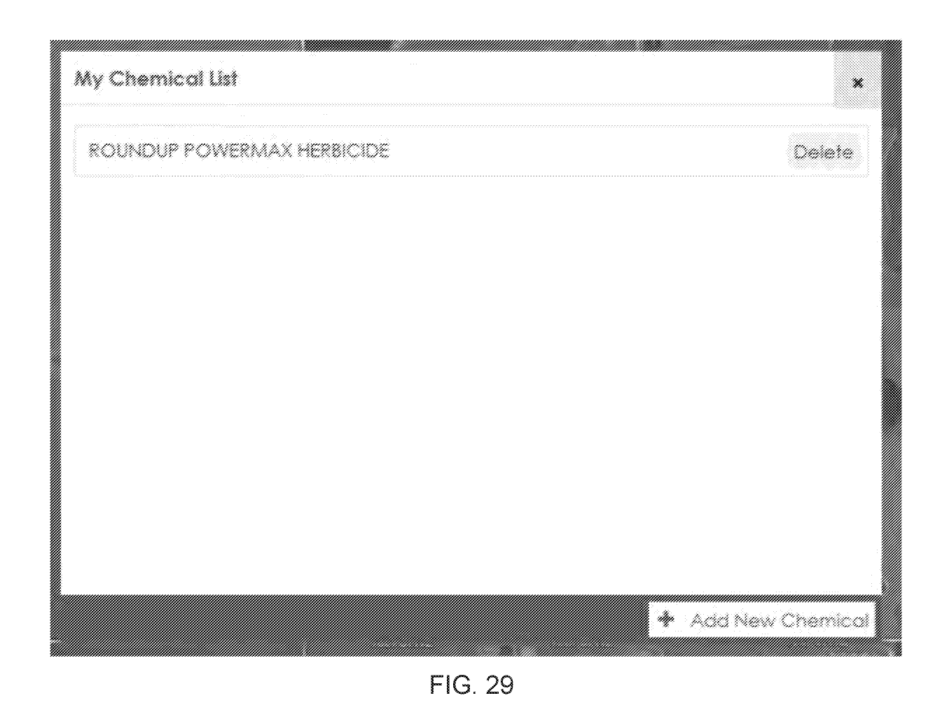

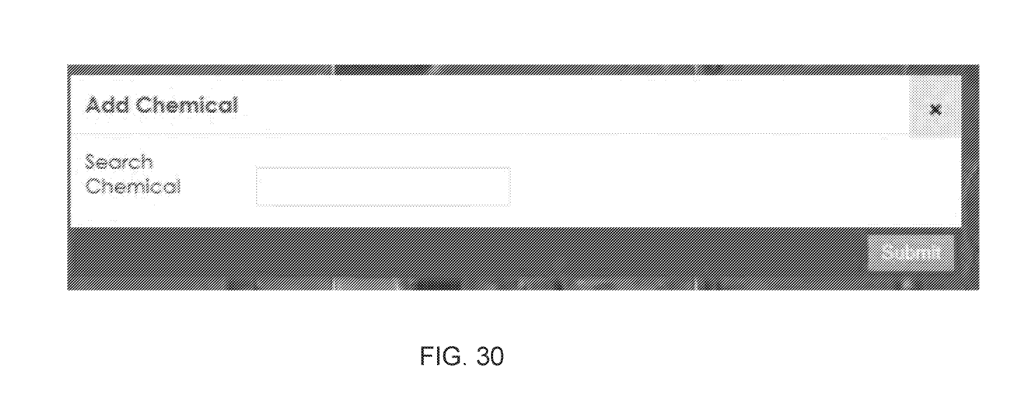

The My Chemicals List menu can be like the user interface shown in FIG. 29. It looks similar to the My Seeds List. When a User clicks “Add New Chemical,” a user interface as shown in FIG. 30 can be shown

Instead of having to start to key in the name of the Chemical to make a drop down selection list appear, the interface can use a pull-down menu(s) to find the Chemical the User wants to add to your My Chemicals short list.

It can work similarly to the Add New Seed dialogue box. A possible list of pull-down menus that could be used follows:

Type (Choices are Herbicide, Insecticide, and Fungicide, if possible); Brand (Name of company that manufacturers the product); Product Name (Pull down list appears based on two selections above).

Alternatively, if a User can't find product using the options above, the User can try finding/entering the FPA Number for the product, if known. (e.g., User selects from pull down menu or manually enters EPA Number to identify the desired chemical to add to the User's My Chemicals List).

When the desired product is located, the User can click on Submit to add the product to the User's My Chemicals List.

The User can add as many Chemical Products as desired to their My Chemicals List.

If the User can't find the product they are looking for, the User can check the box where it says “My product is not on this list.” The process and rules to add a product not on the Master Lists can be the same as for Seed.

If User checks “My product is not on this list,” the pull down menus can become data input boxes where a User can manually enter the product that is not on the Master List. The alternate option can be the same (e.g., a new dialogue box can appear to enable User to enter the Brand/Product manually). The added Brand/Product can then appear on the My Chemicals List (after User clicks Submit) but will not be automatically added to Master List (it will be reviewed by FBN for possible inclusion in Master List as explained above).

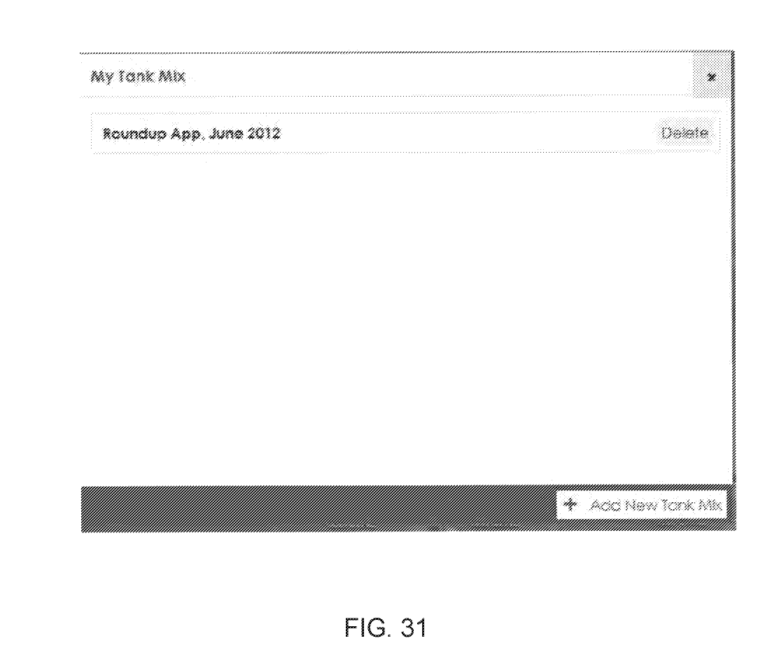

In crop production, a farmer can mix more than one Chemical in a tank for application on the Field or crop. In the described system, the mixes that a User intends to apply during the crop production season can be created in advance so that the User can simply select the Tank Mix the User wants when needed. The My Tank Mix dialogue box used for mixes can appear as shown in FIG. 31.

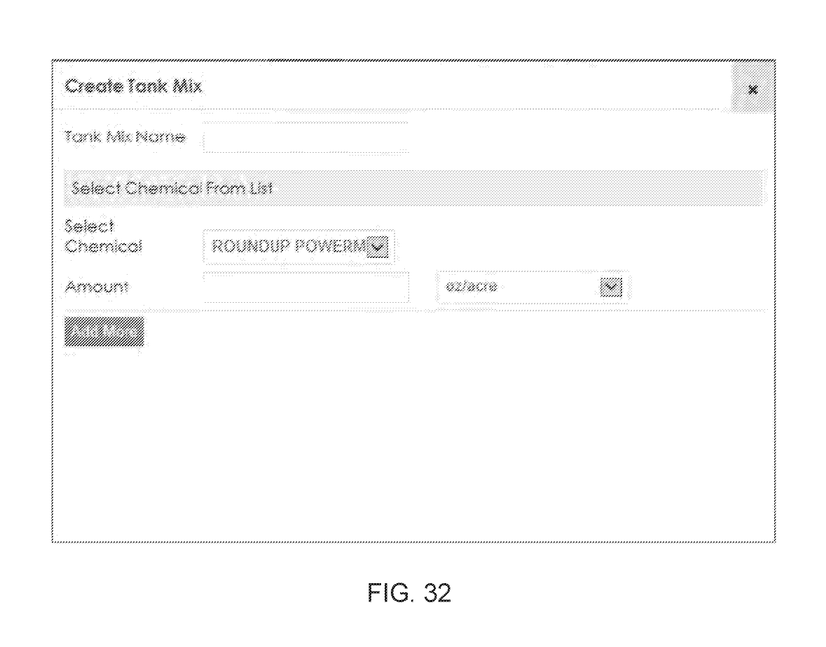

The title of the box can be “My Tank Mix(es)” to indicate a farm can create more than just one. To create a new tank mix, the User can click on the Add New Tank Mix button on the bottom bar of the screen shown. When that is done, a user interface such as that shown in FIG. 32 can be presented.

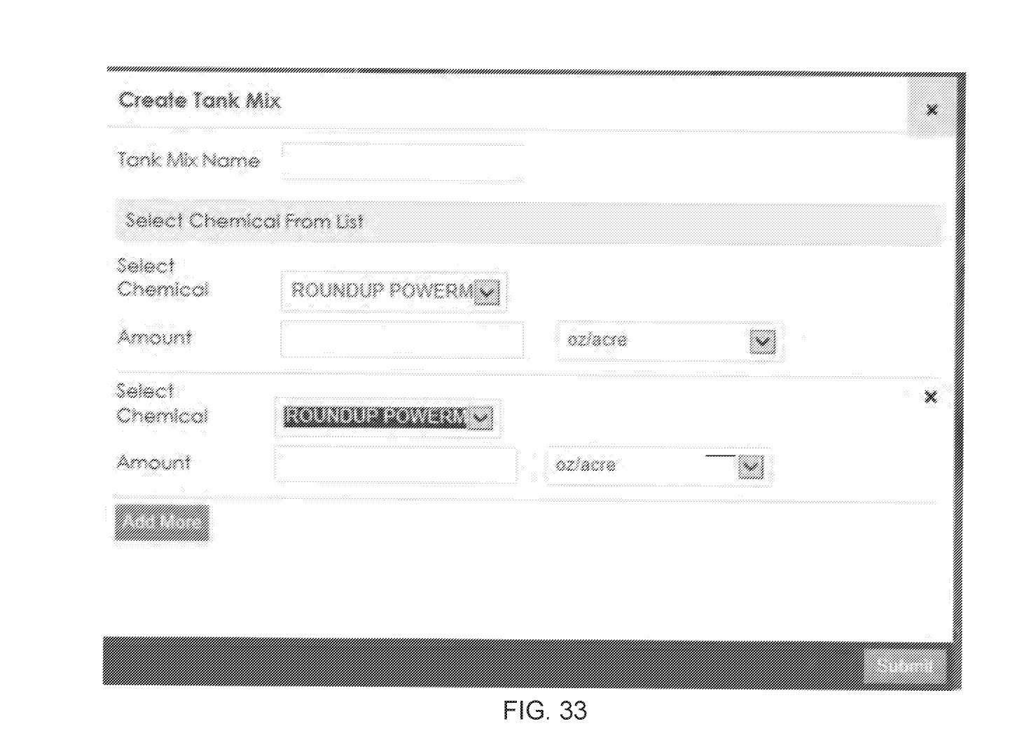

Using the user interface, the User can name the Tank Mix and then select the chemicals the User wants in the mix using the Select Chemical pull down menu. The pull down menu can include products that were added to the User's My Chemicals List. If more than one chemical is in the mix, the user can click Add More (or “Add another Chemical”). Room for another chemical is then provided as shown in FIG. 33.

Although two of the same chemicals are shown, in practice different chemicals will be used. The User can add as many Chemicals to the mix as are available (e.g., on the User's My Chemicals List). The User can also be asked to enter the amount applied for each Chemical in the mix. The User can also select the Units that amounts are measure in.

The options for units applied can include: oz./acre; pt./acre; qtrs./acre; gal/acre; lbs./acre

As always, when the User has completed adding the desired information to the Create Tank Mix dialogue box, they can click on Submit to enter it into their information in the system. When a new mix has been submitted, the screen can return to the My Tank Mixes dialogue box.

It is recommended, but not mandatory that Users create short lists (can be called “My Equipment”) of the Equipment they use in their Farm operations. The system website can make this a relatively simple and easy task to perform by enabling Users to select the Equipment they use from pre-populated pull down menus. To do this, a User can click on Equipment 1540 in the menu on the lower bar of the home screen shown in FIG. 15.

When the User clicks on Equipment from the main menu, the User can be given the choice of selecting the following: Master Equipment List; My Equipment List; or Equipment Combinations

My Equipment ‘Short List’:

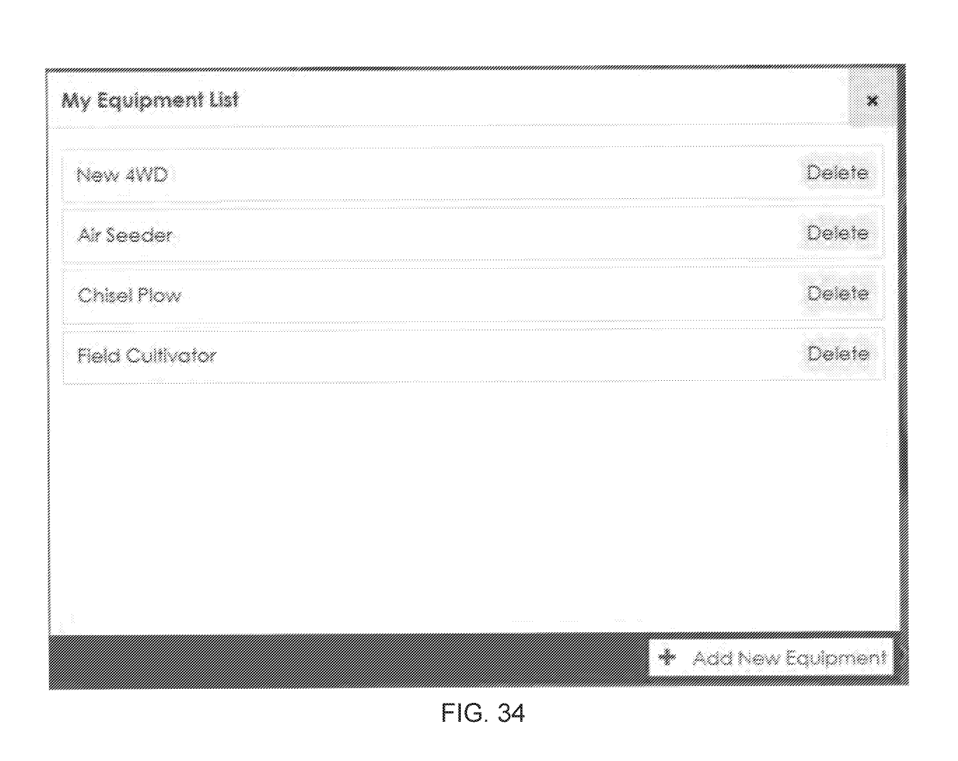

When a User clicks on My Equipment List, a user interface such as that shown in FIG. 34 can be shown. The box can be automatically sized to list the equipment.

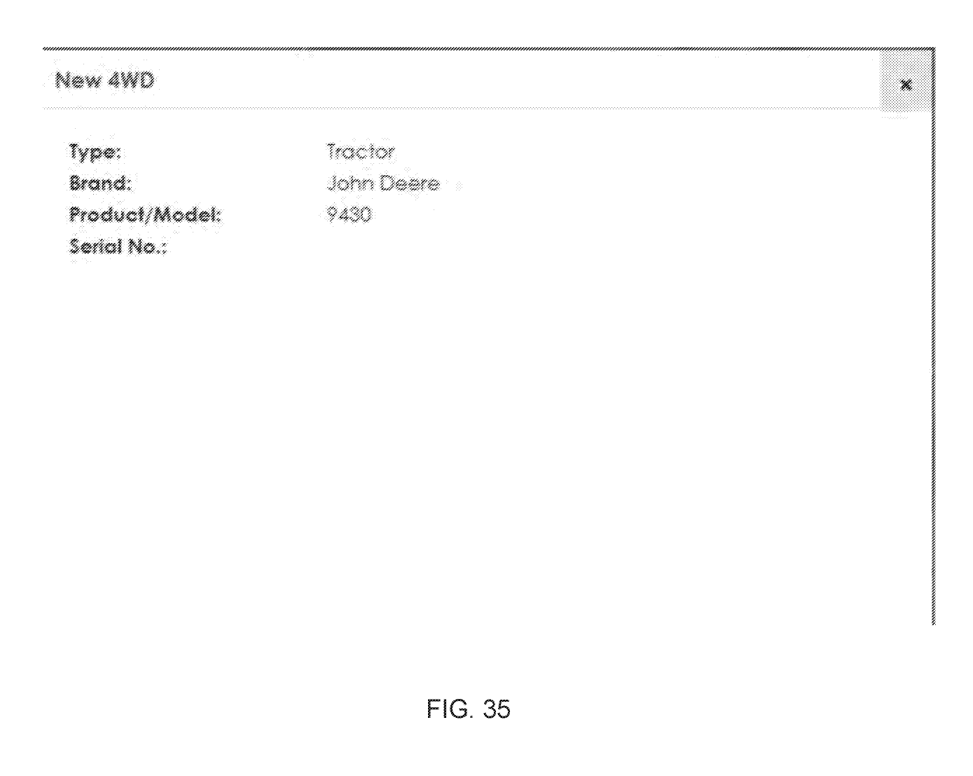

The Short list can be a list of equipment used in the operation's crop production activities. A User can activate one of the listed pieces of equipment to get a pop-up box that shows more detail, such as that shown in FIG. 35. It can be made apparent how the User can View or Edit the information for a piece of equipment.

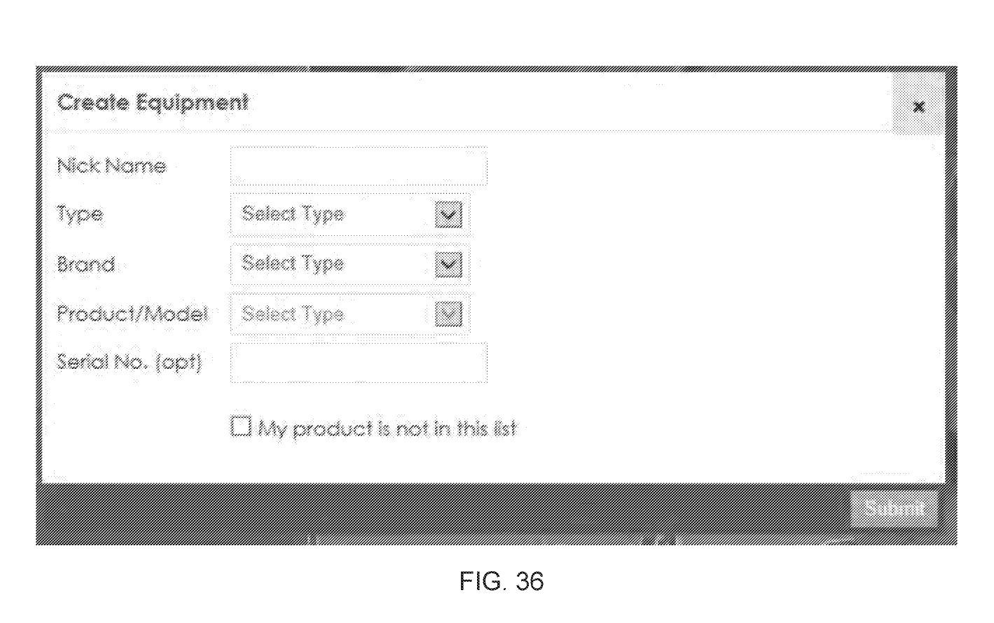

To add a new piece of Equipment to the My Equipment List, a dialogue box such as that shown in FIG. 36 can be displayed. Nick Name need not be a data input box.

The other selections can be made similarly to Seeds and Chemicals. The User can, but is not required to enter the Serial Number for the piece of equipment being added to My Equipment List. When finished, the User can click Submit to enter the piece of Equipment into the system.

If the User clicks on the “My product is not in this list” the same protocols described for Seeds and/or Chemicals can be applied in the same fashion to Equipment.

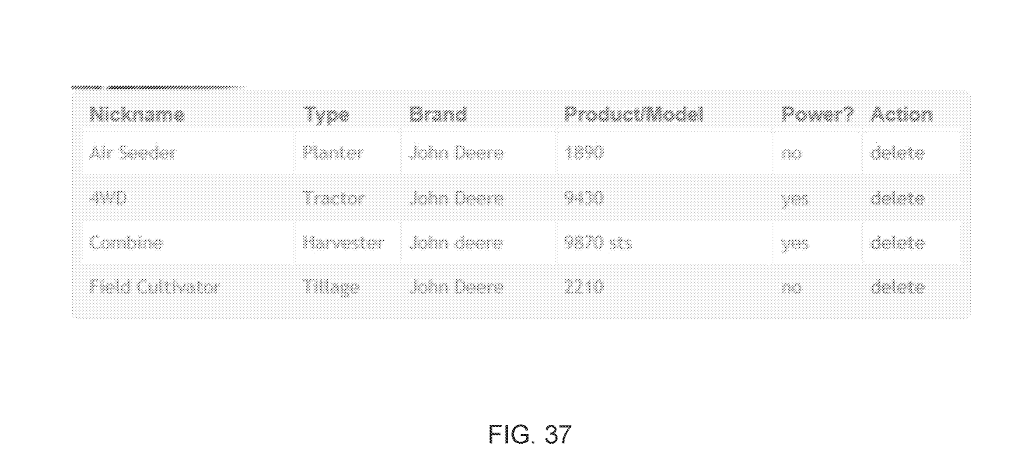

The individual pieces of equipment on the My Equipment List can contain more information to avoid the need to click on the piece for more information. For example, an alternative layout is shown in FIG. 37

Users are not be required to create Equipment lists in order to create Events.

### Equipment Combinations

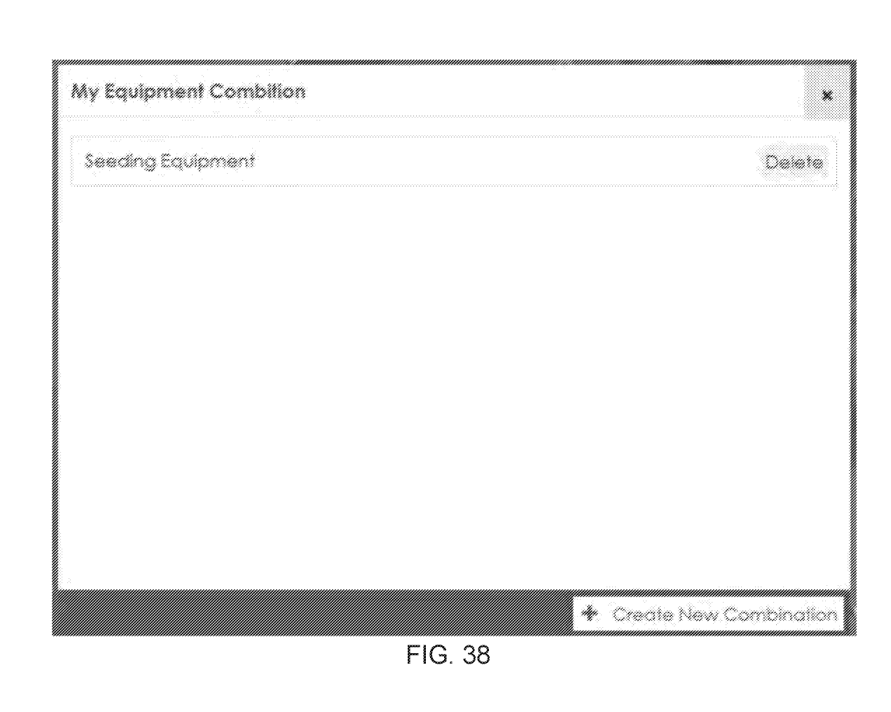

Equipment Combinations can be two or more pieces of Equipment from the User's My Equipment List that are treated as one piece of equipment. For example, a User may wish to create an Equipment Combination for a planter and the tractor that it is attached to. Thus, the User that assigns equipment to Field Events need not add the pieces individually to assign them to an Event. Creating Equipment Combinations is an optional capability that can save Users time in the long run. When the User clicks my Equipment Combination(s), a user interface such as that shown in FIG. 38 can be displayed. The interface can be automatically sized depending on the number of combinations shown.

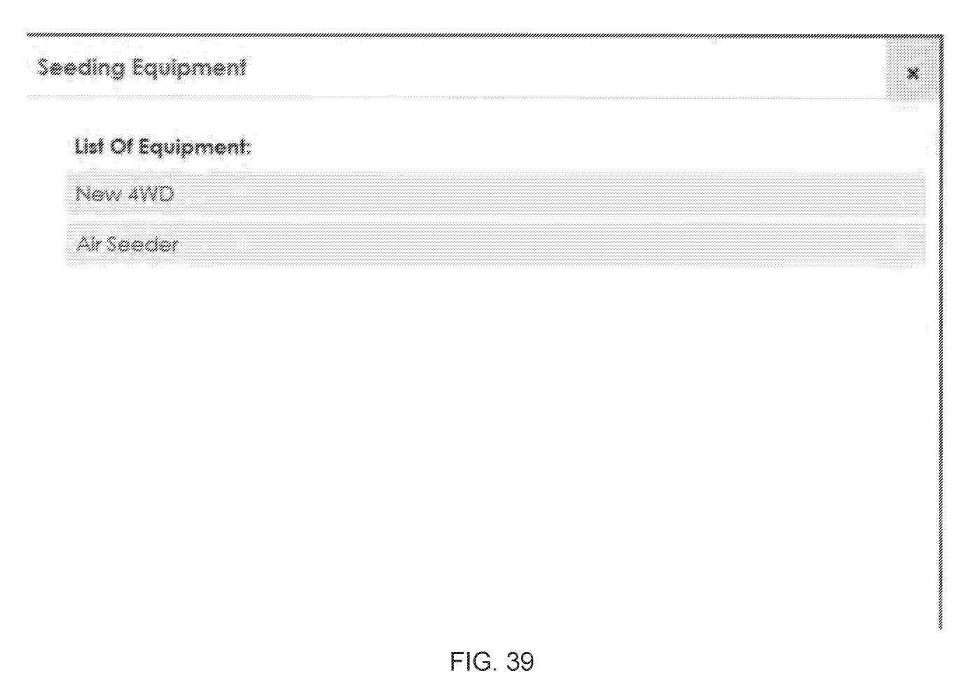

A User can View/Edit an Equipment Combination by clicking on the name of the individual Equipment Combination. This can be made apparent to Users. When a User does activate an Equipment Combination name in the illustrated interface, a box such as that shown in FIG. 39 can open. The interface can be automatically sized to show the pieces of equipment. More information about a displayed piece of equipment can be displayed, and view or edit functionality can be provided by activating the displayed piece of equipment.

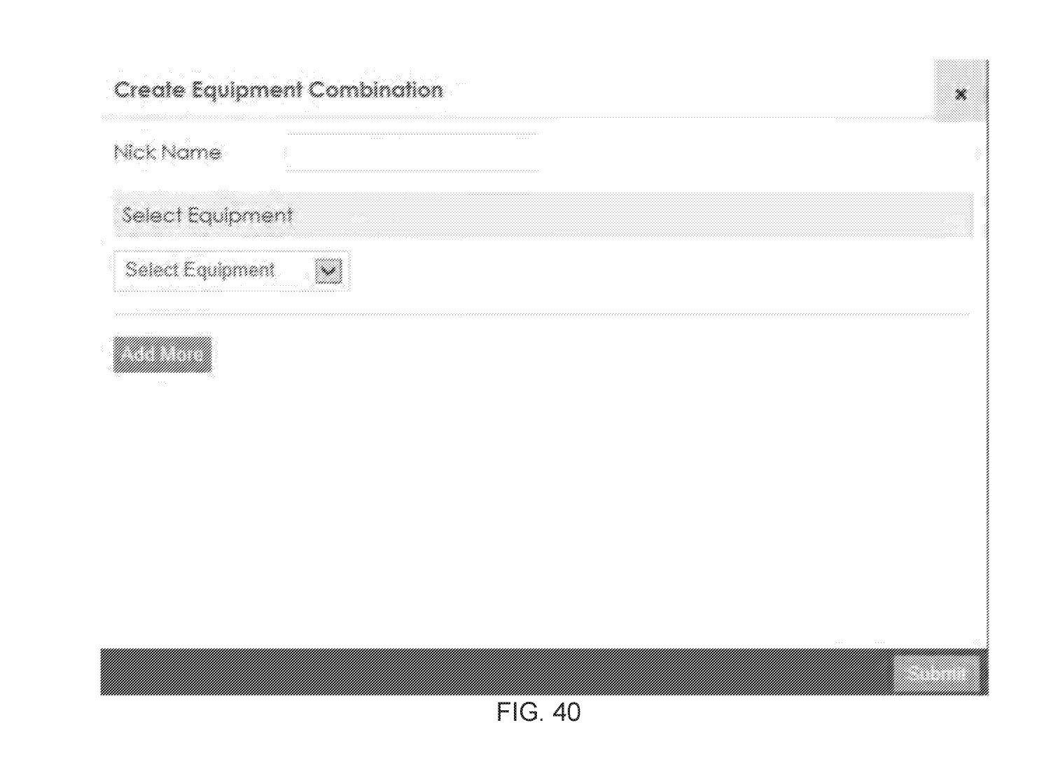

Equipment Combinations: When a User clicks Create a New Combination (lower right corner of the Equipment Combination(s) box) a user interface such as that shown in FIG. 40 can be presented.

The user need not remember a nick name for a piece of equipment, so it can be removed from the interface. Instead, a User's Equipment short list can be shown and equipment can be selected from it. The User can add as many pieces of equipment as available when building an Equipment Combination.

For My Equipment List and/or Equipment Combination(s), the User can Add/View/Edit/Delete any piece of equipment or a combination at any time desired.

Master List:

The Master Lists we have pre-loaded need only be available in the pull down menu for specific equipment. There need not be a separate option for Master List detail.

The system can support creating an event without creating an Equipment list. For example, some Users may prefer to record Harvesting or Planting events without assigning the equipment they used. This makes it easier and faster for some Users who do not want to bother setting up Equipment Lists.

### Example 17

### Example Web Portal: Events

Events can be any work or task the User performs during the growing season or it can be an Event like Weather where no work/task is performed by User.

Events can be recorded by date (MM/DD/YEAR) which will enable Users to view and compare their production activities/history by Production Year. Production Years can correspond to Calendar Years (e.g., for reporting purposes).

To create an Event, a User can activate “Field Events” 1550 of the user home page as shown in FIG. 15. The pop up menu can include the following in the list: Plant; Replant; Fertilizer; Lime Application; Chemical; Tillage; Weather.

### Plant Events

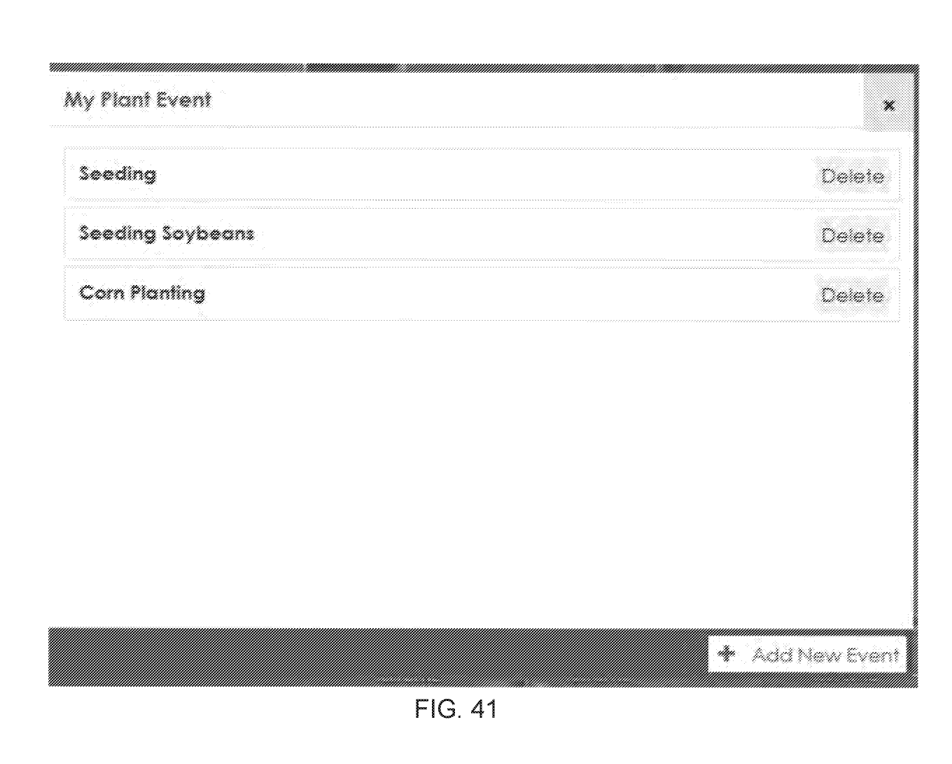

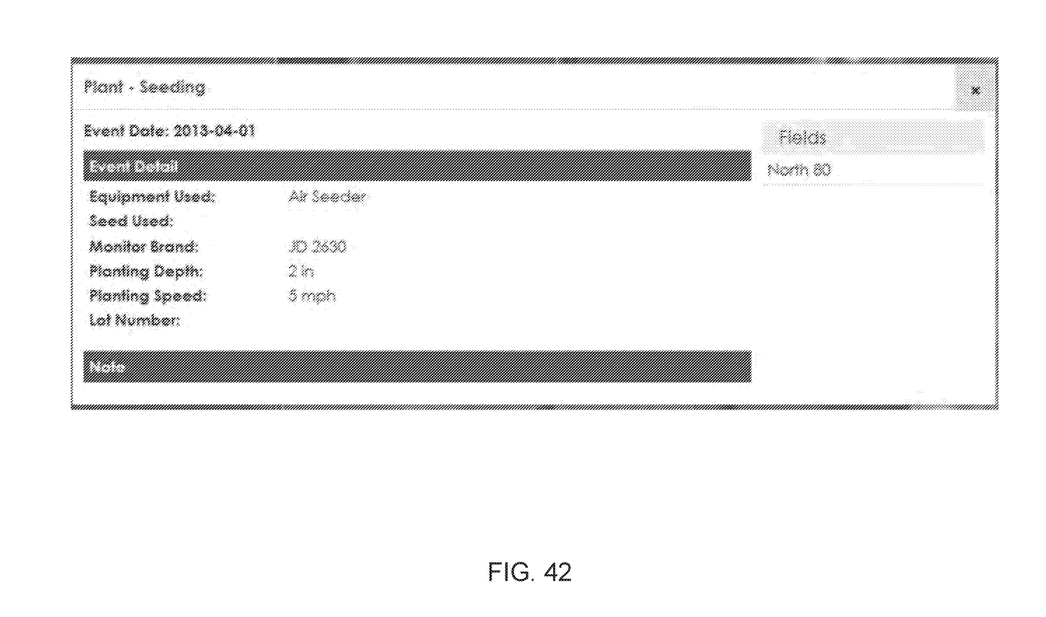

When the User clicks on Field Events and then selects Plant from the pop up menu, a user interface such as that shown in FIG. 41. This box in the figure shows some of the elements, but variations are possible. The dialogue box can be automatically sized, and it can be made more apparent that a User can click on the name of an Event to open the Event detail box. For example, if a User clicks on Seeding in the box above, a user interface such as that shown in FIG. 42 can be presented.

The following data elements can be included:

The Event name at top can be simply the type of Event selected. In this case, the Event Name can simply be “Plant”;

The dialogue box can have EDIT/DELETE options;

The Date can be the Date the Event was completed. It can be changed using Edit and a calendar date selection control;

Farm Name; Field or List of Fields if more than one; Seed Brand; Seed Product; Planting Depth; Planting Speed (Optional because it is captured by most of the monitor brands and stored in the memory device of the monitor); the Lot Number can be removed.

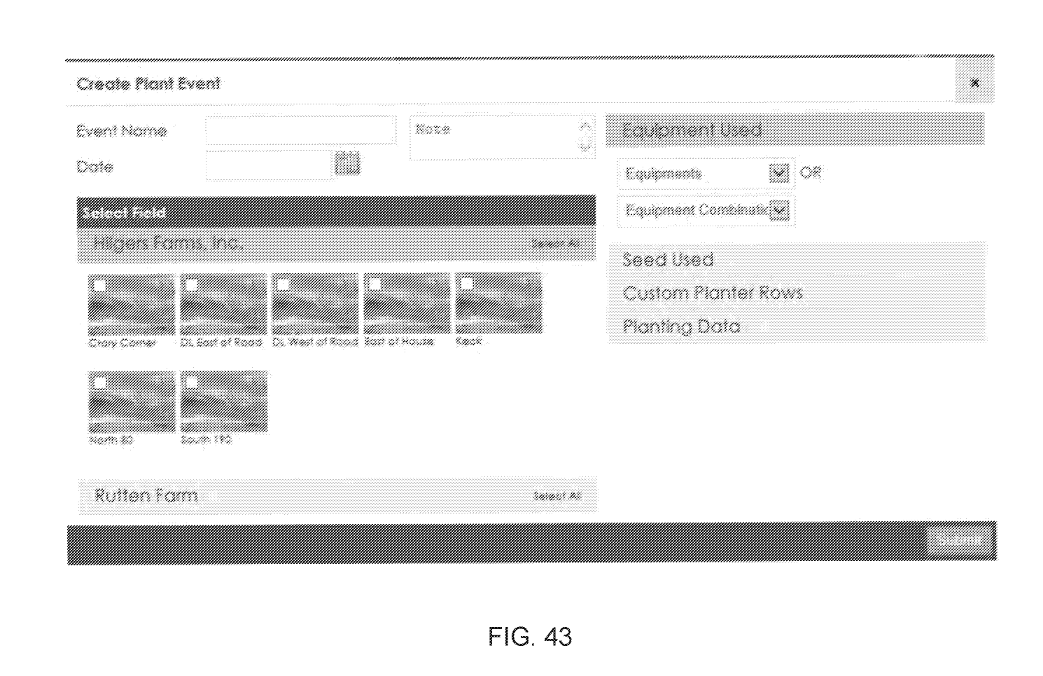

To create a New Plant Event, the User can click on Add New Event in the dialogue box above. When the User does so, a user interface such as that shown in FIG. 43 can be presented.

Because the event is a Plant Event, the title Create Plant Event can be shown. However, the Event Name can be removed and simply be “Plant.” The User can enter the date completed.

The Farms and Fields can be moved to the right side of the menu. Then the order of items below Date on the left side can be: Seed Used, Planting Data, and Equipment Used, which can be displayed a expanding/contracting panes as shown.

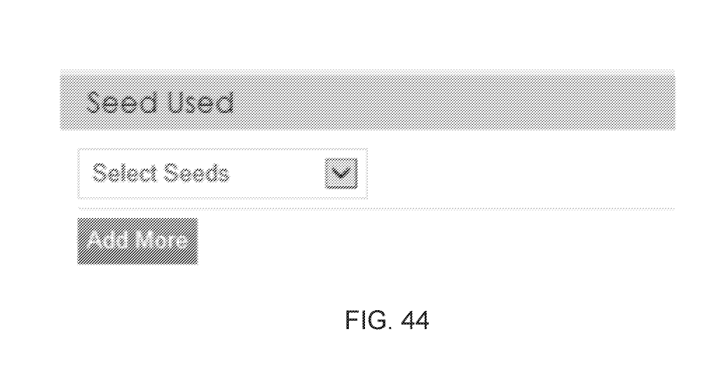

Seed Used: When opened a pane such as shown in FIG. 44 can be shown. Seed product can be selected from a drop down menu of My Seed List as shown above. The User is able to add more than one Seed product from their short list if they want to.

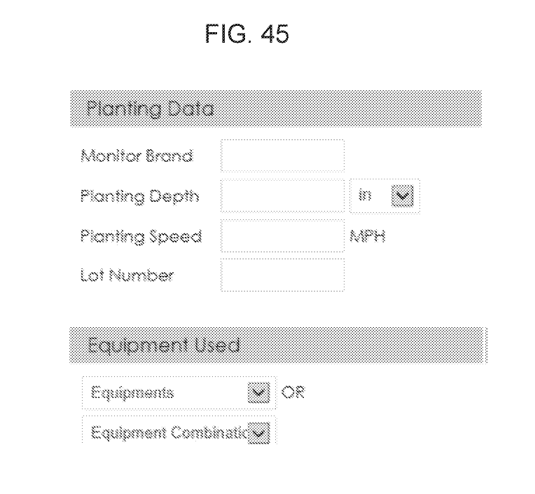

Planting Data can appear as shown in FIG. 45. The following can be included: Monitor Brand can be removed; Plant Population; Planting Depth (Enter depth and units in inches or centimeters); Planting Speed can be removed; Row Spacing (Data Input) in inches or cm from drop down; Lot Number can be removed.

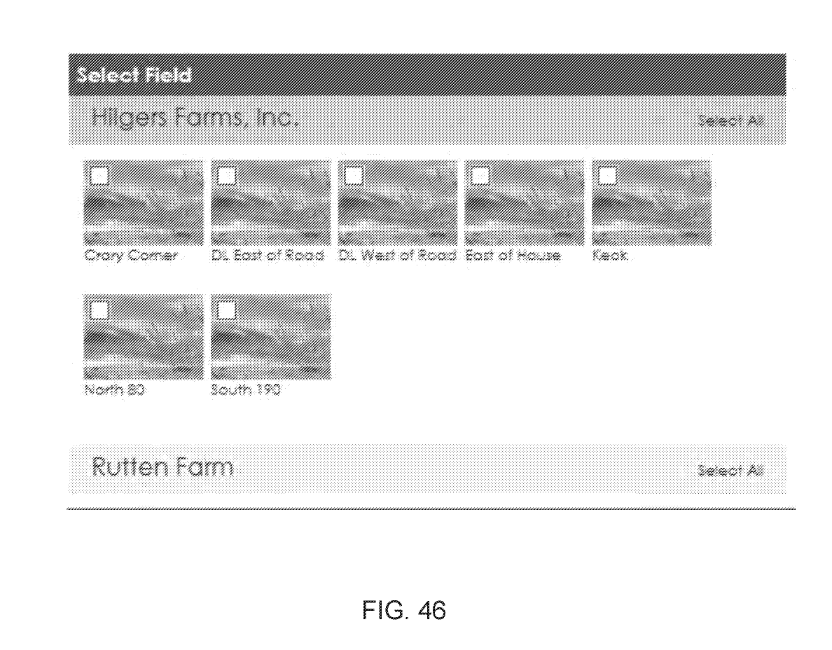

Equipment Used can appear as shown in FIG. 46. A User selects Equipment (User can select Equipment used one piece at a time from the My Equipment List items that appear in the drop down box.

User can also select an Equipment Combination that was created as already explained in the Equipment section

Thus, it is advantageous to create Equipment Combinations in advance. Doing so makes selecting Equipment Used a much easier and faster process here.

Customer Planter Rows can also be included.

On the right side of the menu, there can be a list of the Farms for the User's Account. A User can click on the name of any of those Farms to open up a list of the Field(s) in each Farm selected. An example is shown in FIG. 46.

In the example, the User clicked only on Hilgers Farms, Inc. to show list of Fields. The User could have also clicked on the Rutten Farm to open the list of Fields for that Farm. In the example shown, only one Farm (Hilgers Farms, Inc.) was selected and now the User can click on the Fields that this Planting Event is to be assigned to. A User can pick just one or select any number of them.

After the information has been entered, the User can click Submit and the screen can return to the My Plant Events box. A User can then add another Event or close the My Plant Events box and return to User Home Page.

### Replant Events

The functionality can be similar to Plant as explained above.

### Fertilizer Events

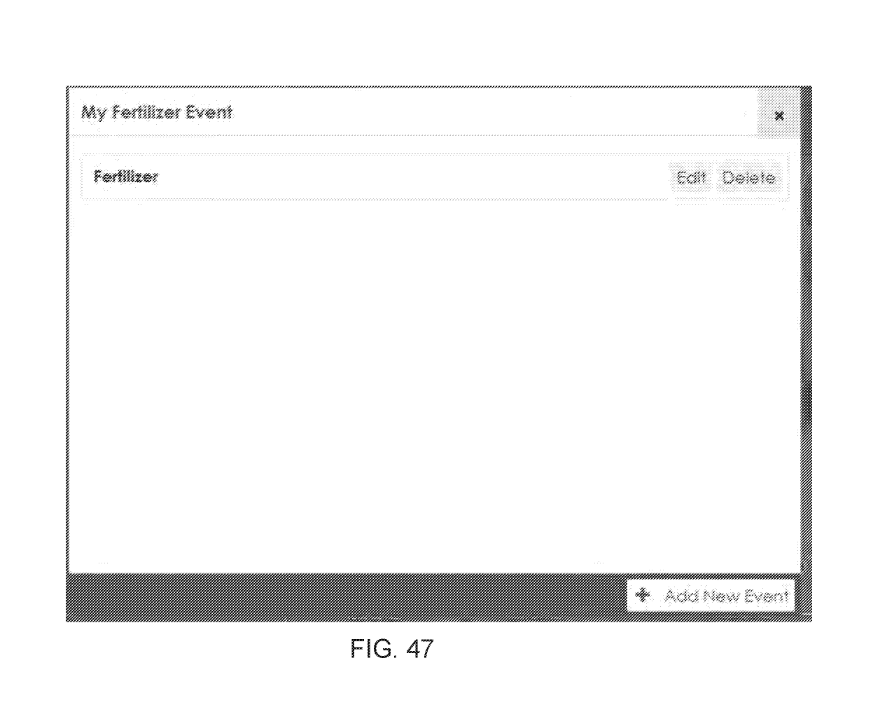

When the User clicks on Field Events and then selects Fertilizer from the pop up menu, a user interface such as that shown in FIG. 47 can be presented. The box can be automatically resized. Instructions can be included to indicate that a User can click on Fertilizer and view the Event Details. There can be columns across the top of the Event as follows: Name; Date; Farms & Fields.

To indicate how to view Event Details, the buttons after each Event can be View/Edit/Delete.

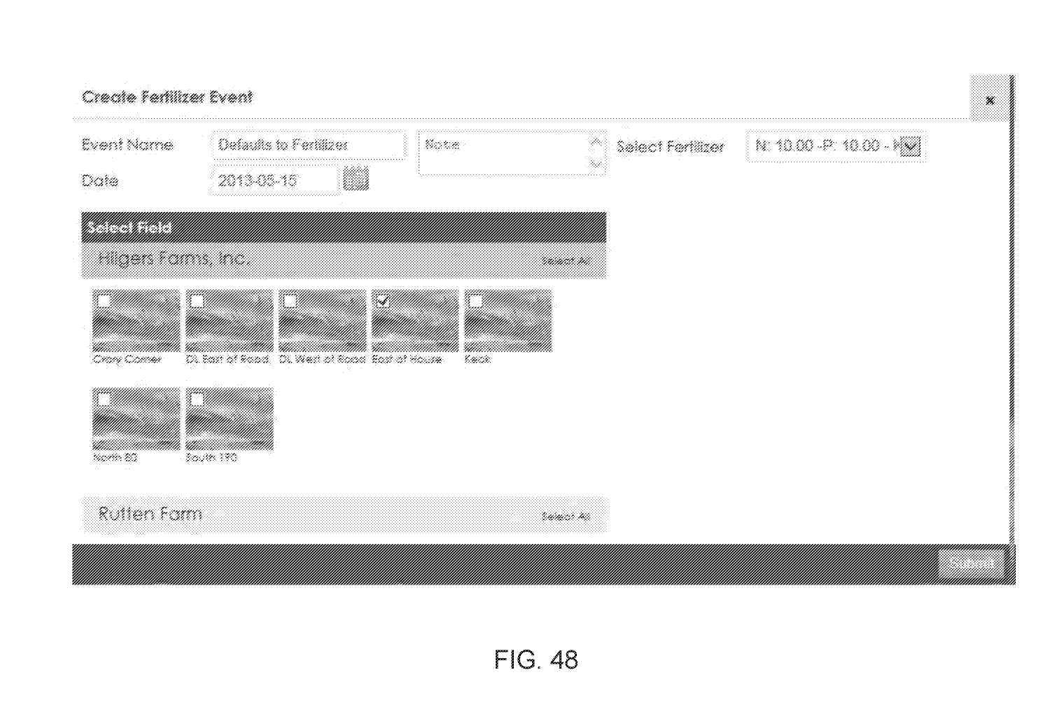

When a User clicks on Add New Event in the My Fertilizer Events box above, a user interface such as that shown in FIG. 48 can be presented.

The Name can simply be “Fertilizer” for a Fertilizer Event. The Select Fertilizer dropdown draws its options from the My Fertilizer List set up previously. The date can be entered using a calendar control object. The User can select the Farm and/or Fields to which this Event applies as in Planting Event above. The User can select only one Field if desired.

When complete, a User can click Submit, and the screen returns to My Fertilizer Event List. When the User closes the My Fertilizer Event List, the screen can return to the User Home Page.

### Lime Application Events

A lime application event can be supported by the following functionality and information:

A. Create/edit event/delete event

B. Create:
Event Name
Date
Write a note space
Field list
Option to select ONLY ONE Field

C. Equipment used
Option to select from dropdown of My equipment list or equipment combinations

D. Monitor brand (data Input)

E. Variable rate (Yes/no)

F. Lime (data Input)

G. Pella Lime (data Input)

H. Liquid Lime (data Input)

A submit button can be provided, and the page can return to the list of Lime Application events after creation of the event.

### Chemical Events

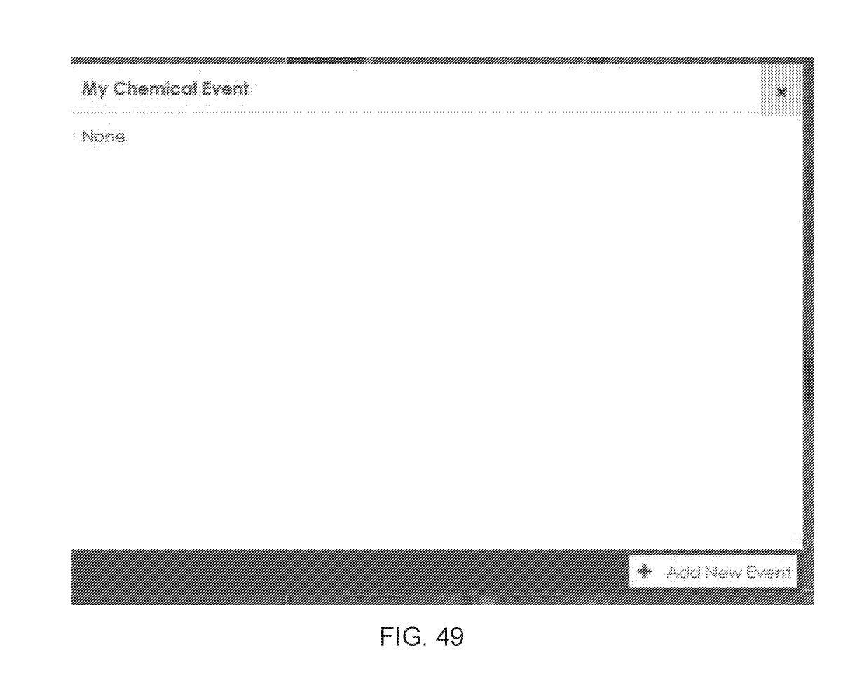

A chemical event can also be named a “Spraying Event.” When User clicks on EVENTS/CHEMICAL, a user interface such as that shown in FIG. 49 can be presented. It can incorporate the style of the other event interface described herein.

A User can click on Fertilizer and view the Event Details. There can be columns across the top of the Event as follows:

Name; Date; Farms & Fields

To indicate how to view Event Details, the buttons after each Event can be View/Edit/Delete.

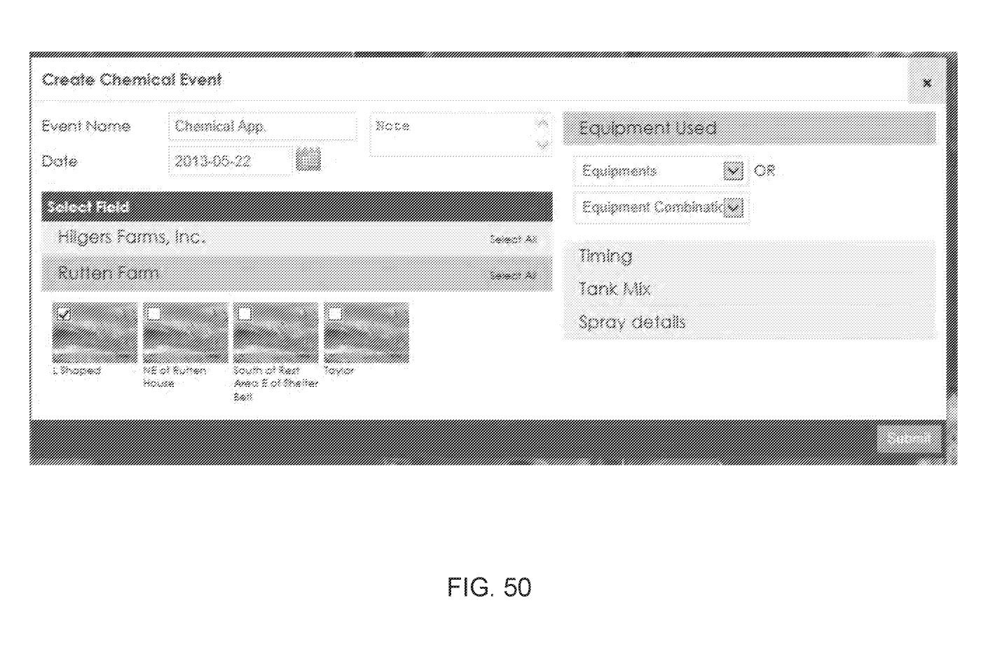

When the User clicks on Add New Event, a user interface such as that shown in FIG. 50 can be shown. Alternatively, the Event Name, Notes, Date and Farms/Fields can be on the left side of menu for any type of Event.

The Event Name can simply be “Chemical Event” and other features on left side can work the same as they did for other Events. A User can select individual or multiple fields to which to assign the Event.

The fight side of the menu above can include Tank Mix, Timing Spray details, Equipment Used, which can be displayed as expanding/contracting panes as shown.

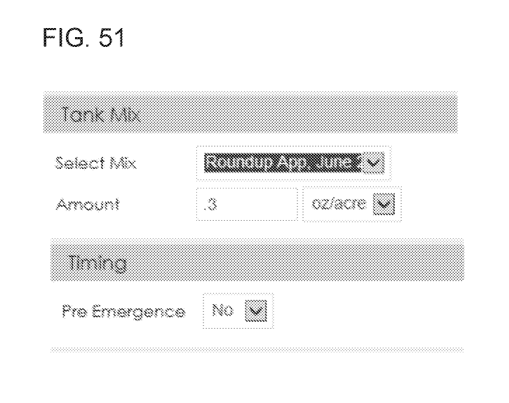

Tank Mix: When the User clicks on Tank Mix a user interface such as that shown in FIG. 51 can be presented. The dialogue box selects a Tank Mix from the list of Tank Mixes that were created when doing Inputs/Chemicals.

Timing: When User clicks Timing in the Create Chemical Event box, a user interface such as that shown in FIG. 51 can be shown. The box represents the functionality for Chemical Event Timing quite well.

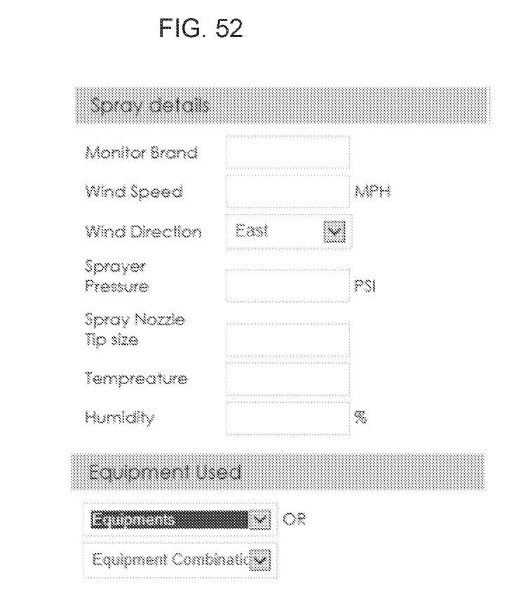

Spray Details: Clicking on Spray Details a user interface such as that shown in FIG. 52 can be presented. Monitor Brand can be removed.

The Chemical (or Spraying) Event can be submitted without the information entered.

Equipment Used: This menu item can appear last on the right side. When a User clicks on Equipment Used, a user interface such as that shown in FIG. 52 can be presented.

Spraying equipment can be added using the “My product does not appear on this list” approach. When the User is finished and clicks Submit, the screen can return to My Chemical Events List.

### Harvest Events

When a User clicks on Events/Harvest, a user interface incorporating the features of the other Event Lists above can also be incorporated. A user can be restricted to selecting only one Field for Harvest due to yield variance.

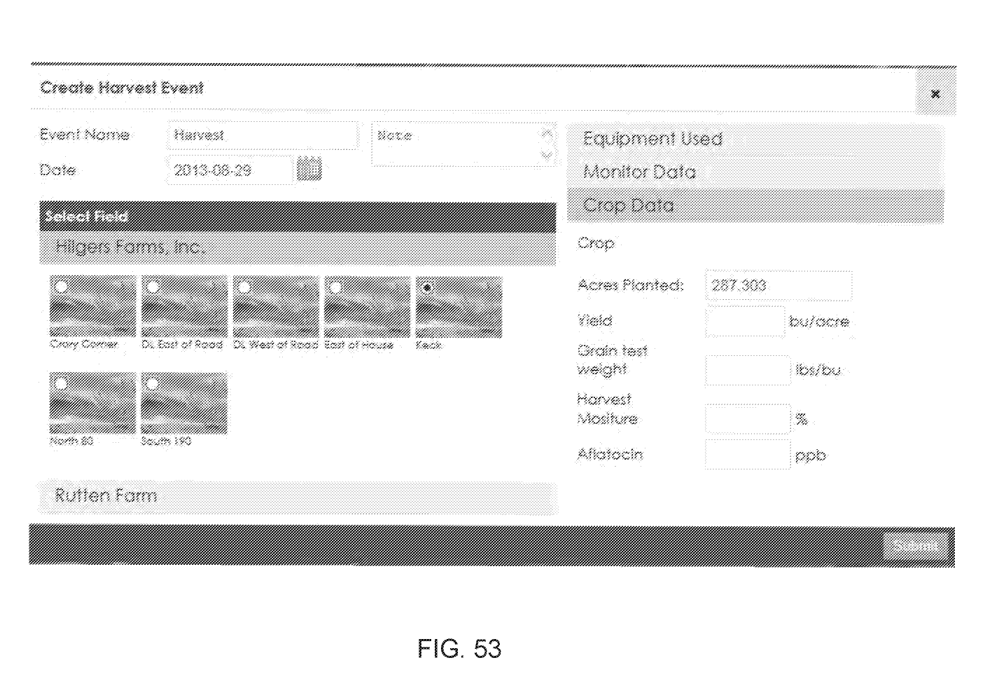

When the User clicks on Add New Event, a user interface such as that shown in FIG. 53 can be presented. The Event Name can default to “Harvest.” Other left side functionality requirements remain the same as those above.

On the right side of the box, the menu options Crop Data, Monitor Data, and Equipment Used can be presented as expanding/contracting panes as shown.

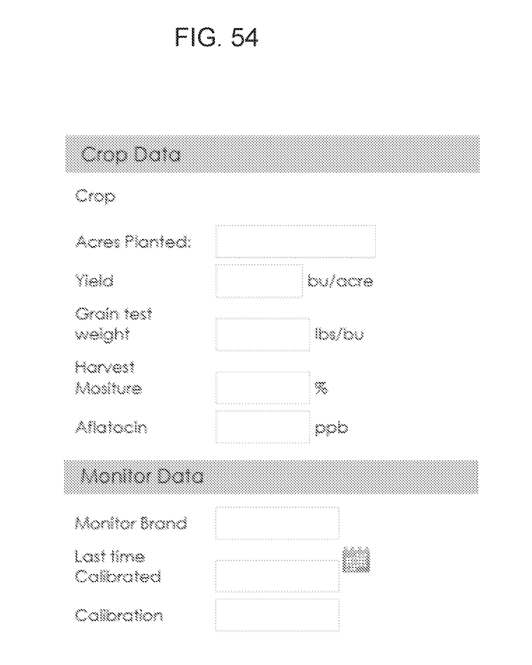

CROP DATA: When the Crop Data control is clicked, a user interface such as that shown in FIG. 54 can be presented. Crop: Can be prepopulated because they system already knows what field is involved, and the as planted data in the system. If the data element is not available, it can be a pull down box with Corn and Soybeans as options.

Acres Planted (or “Harvested”): This information can be available when the User uploads their Yield Map data.

Yield: Can be prepopulated if the User has uploaded the yield map for the Field, but User can manually enter if desired.

Harvest Moisture %: Already pre-populated from data uploaded by User or User manually enters this value.

Aflatocin: Can be removed.

MONITOR DATA: When a User clicks this menu option, a user interface such as that shown in FIG. 54 can be presented.

Monitor Brand: Can be a pull down menu using a Master List that has been prepopulated. A User can manually enter as well if their monitor is not on the Master List.

Last Time Calibrated: Use calendar control object to select correct date.

Calibration: Can be removed from list.

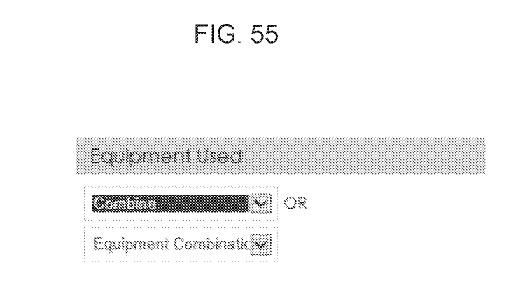

EQUIPMENT USED: When the Crop Data control is clicked, a user interface such as that shown in FIG. 55 can be presented. A user can be able to choose more than one item if selecting individual pieces of equipment for which Equipment Combination has not been created. This can be done by putting and Add button under first selection.

Equipment can be viewed by type, brand, and model number. The same is true for Equipment Combinations.

### Tillage Events

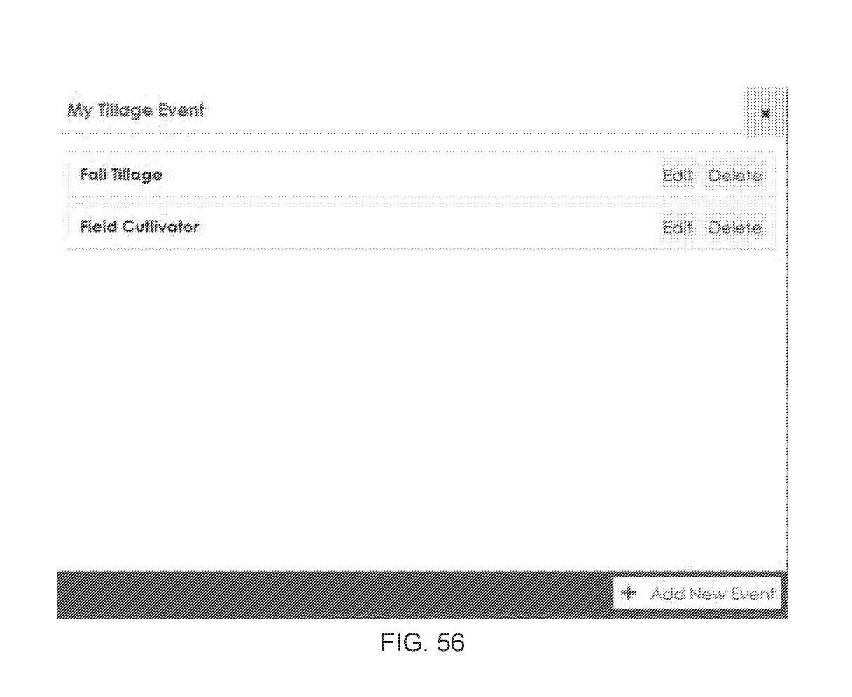

A tillage event list can be presented such as shown in FIG. 56. The features for other Event Lists can be applied here.

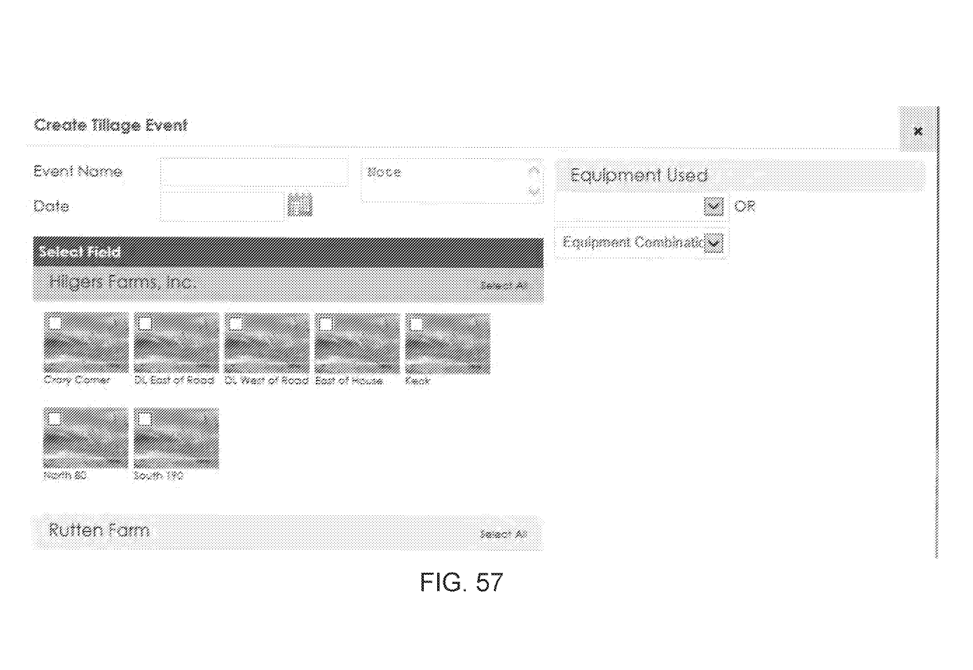

When the User clicks Add New Event, a user interface such as that shown in FIG. 57 can be presented.

The Event Name can be “Tillage Event.” A User can select more than one Field and assign Date. The Equipment Used is straightforward. The system can have Master Lists of types of tillage equipment. When User clicks Submit (not shown, but same as other similar type boxes) the screen can return to My Tillage Events and when that is closed, the screen can return to User Home Page.

### Weather Events

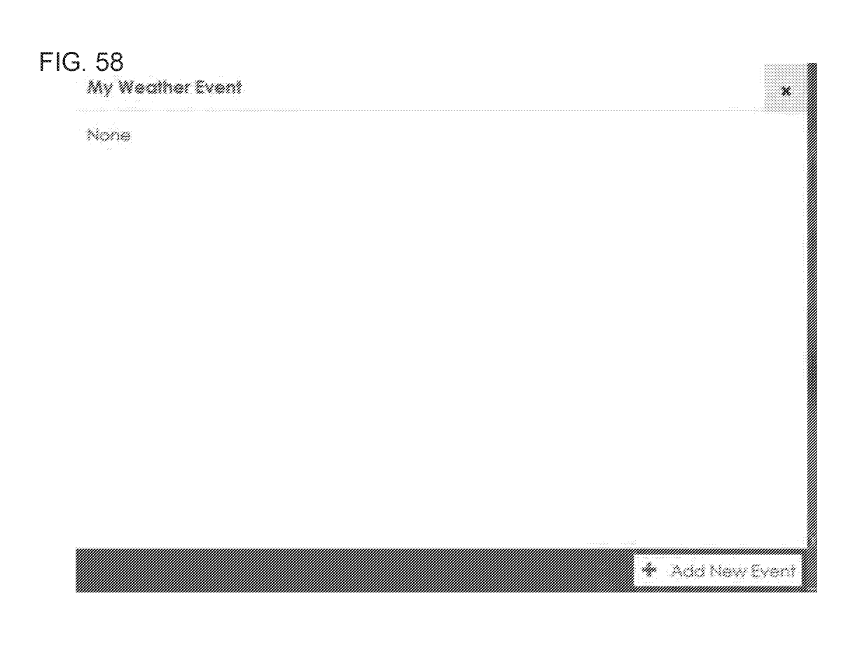

An example user interface presenting weather events is shown in FIG. 58. Weather events can use the features of the other event types. However, some appropriate column headings to include more general information can be added for a Weather Event. To get details there can be View/Edit/Delete buttons on right side of each listed Event.

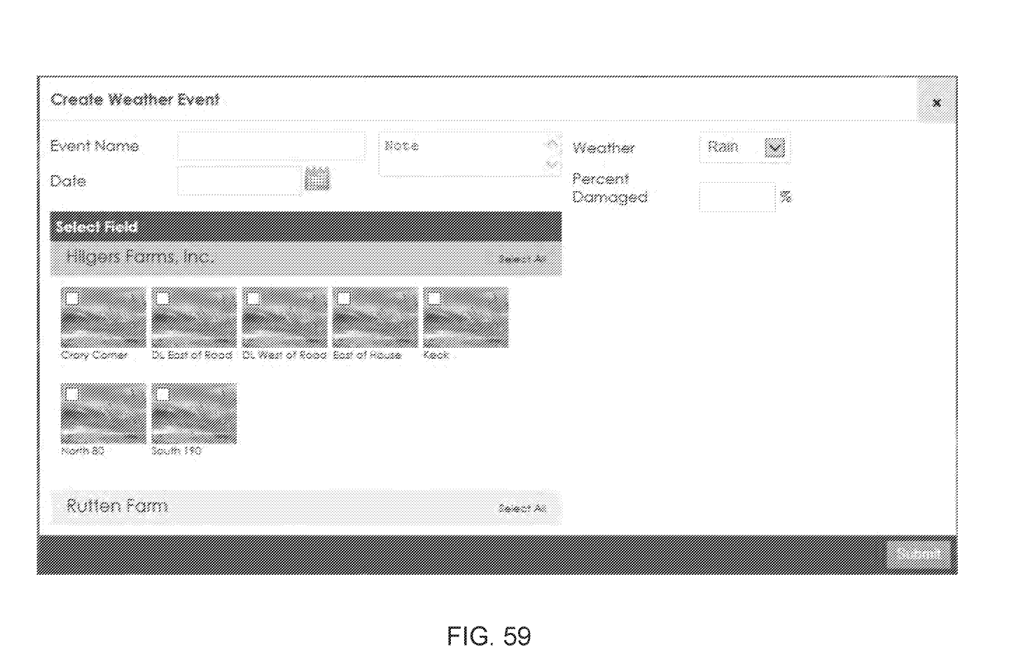

When User clicks Add New Event, a user interface such as that shown in FIG. 59 can be presented.

The Event Name can be the type of Event selected from the pull down box where it shows <Rain> above. Other items on left can incorporate features for the other event types. With weather, Users can select more than one farm or even all Field and all Farms.

The pull down menu at the top of the right side of box lists Rain, Temperature Hail, Winds, Tornado, and Flood. Temperature Daily High can be added. If Rain is selected, the amount of precipitation can be added. Precipitation in inches to the hundreds accuracy, (e.g., 52 hundredths) can be first box followed by the Temperature box (Degrees of Heat, Fahrenheit) and lastly, the Percent Damaged box.

When User clicks Submit, the screen can return to the Weather Events page, and when the Weather Events List page is closed, the User can be returned to User Home Page.

### Example 18

### Example Web Portal: Data Upload

Users with network connections will be able to directly upload USB sticks, Flash Memory cards, or the like for planting, harvesting, etc. data directly into their system Account.

For those that are able to read and transfer their card data directly to their Account, the procedures can be quite straightforward:

Users remove memory device (USB stick, Flash Memory Card, etc.) and inserts the device into the appropriate slot on their computer.

The User clicks on Data Upload (e.g., 1560 of FIG. 15). Users can be directed to browse their computer to locate the files on the memory device from the equipment monitor.

When the device is located, any files on device can be selected.

The User can click an Upload control button.

When the Upload button is clicked, a dialogue box opens up and asks the User to reconfirm their User Name and Password. Once they have entered this, they click Submit and the data transfer begins.

Data can be transferred to their Account file we have created for them. Once the data are successfully loaded into their Account file, we can begin processing the data an automatically populate their Account with the information that was on the memory device.

While the data transfer is happening, an indicator display can be shown that assures the User that the transfer is working and informs the User that the data transfer can take a relatively long time to complete.

When the transfer is successfully completed, a dialogue box can appear to inform the User that the data transfer was successfully completed. Or it was not, such an indication can be provided.

Then the User can clicks close on the information box and be returned to their Home Page.

### Example 19

### Example Web Portal: Mapping

Users can utilize the mapping capabilities of the system by clicking on <Mapping> (e.g., 1520 of FIG. 15 located in the bottom bar of the Users' Account).

Using the Mapping function, Users can view their Farms and Fields. They can also view any layers associated with those Fields. Some of the standard layers that can be included are:

Satellite/Aerial Imagery (background)

CLU Field Boundaries (Users can select their own Fields and create their own Field boundaries from this layer.)

Soil Types

Map View (Roads & Highways)

User Accounts can contain as many User created “layers” as desired. User created map layers can also be viewed by production year. The default will be the current production year. These can include:

Yield Maps

As Planted Maps

Spraying Maps

Soil Test Maps

Variable Rate Maps

Many of the functions related to mapping that were explained above can also be done directly using the functionality found in <Mapping>. As a User uses the Website, there can be more than one way to do the same thing. Enabling Users to do the same things from more than one area of the site can make the site easier and more intuitive to use. It will be harder to ‘get lost’ in the website, because a User can do things in the way that is most convenient and preferred by the User. For example, viewing a map for a completed Event (for which the map file has been uploaded) can be done by going to Events and finding the specific event being sought or alternatively, going directly to the Mapping functionality and selecting the Field and map type the User wants to see (e.g.—Yield Map, Rutten Farm, L Shaped Field, 2012 production year.)

Mapping can take User to a screen that contains features of mapping software tools with regard to imagery and navigation. Users can select a Farm (Browser zooms to Farm view extent)

The menu on the top part of the menu to the left of the screen can be where the User can select Places like Farms and Fields. The lower part just below that can be where the User can select the layer for the Place selected above. There can also be a way to select the production year so that maps are viewed for the year the User desires. This can be a pull down menu with the years listed for the User to select from. For example (2013, 2012, 2011 etc.)

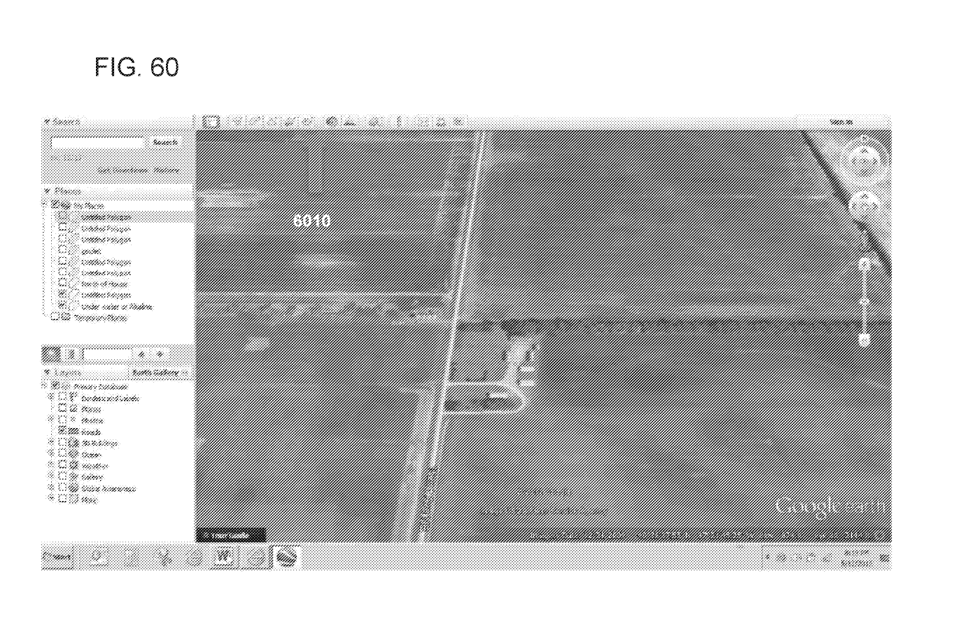

The bar 6010 across the top of the map screen shown in FIG. 60 can have controls that a User can use to draw Field boundaries, draw interior polygons on a map layer, etc. When the User hovers the cursor over the control button, the name of the control can be displayed and a “how to use the control” dialogue box can open if the cursor hovers over the control button more than a certain number of seconds. The Help dialogue box can remain open until the User closes it. There can be fewer control buttons. Examples of the control buttons are the Pan and Draw Boundary controls.

### Example 20

### Example Web Portal: Reports

The site can allow the Seed and other Master Lists to be viewed without going to the pull down menus (e.g., of the My Seed List). A control box with the Master List on one side (e.g., in alphabetical order) and a My Seed List on the other side can be presented. A user can click “Add” and/or “Remove” buttons to move items (e.g., seeds) to and from the My Seed List. The Master Seed List can be displayed as staying the same during the process.

One side can be the Master List for a specific type of product and the other the User's short list for that product. This can be a helpful way to build short lists. Items can be moved back and forth very easily as desired to reflect what the User wants included in the User's short lists.

### Example 21

### Example Computing Systems

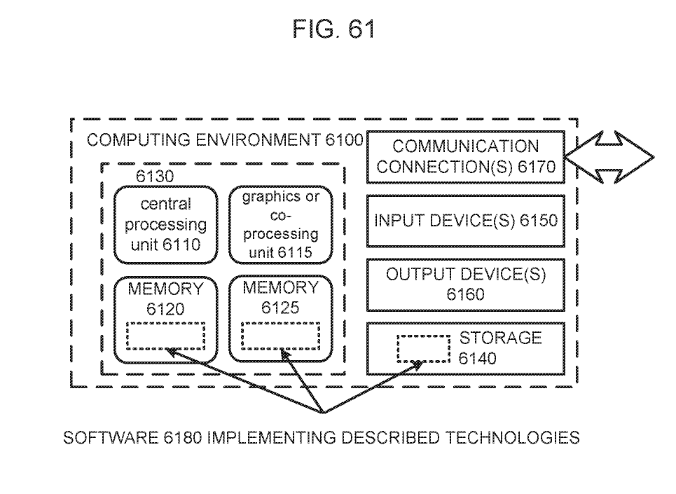

FIG. 61 illustrates a generalized example of a suitable computing system or environment 6100 in which several of the described innovations may be implemented. The computing system 6100 is not intended to suggest any limitation as to scope of use or functionality, as the innovations may be implemented in diverse general-purpose or special-purpose computing systems. A communication device as described herein can take the form of the described computing system 6100.

With reference to FIG. 61, the computing system 6100 includes one or more processing units 6110, 6115 and memory 6120, 6125. In FIG. 61, this basic configuration 6130 is included within a dashed line. The processing units 6110, 6115 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 61 shows a central processing unit 6110 as well as a graphics processing unit or co-processing unit 6115. The tangible memory 6120, 6125 may be volatile memory (e.g., registers, cache, RAM), non-volatile memory (e.g., ROM, EEPROM, flash memory, etc.), or some combination of the two, accessible by the processing unit(s). The memory 6120, 6125 stores software 6180 implementing one or more innovations described herein, in the form of computer-executable instructions suitable for execution by the processing unit(s).

A computing system may have additional features. For example, the computing system 6100 includes storage 6140, one or more input devices 6150, one or more output devices 6160, and one or more communication connections 6170. An interconnection mechanism (not shown) such as a bus, controller, or network interconnects the components of the computing system 6100. Typically, operating system software (not shown) provides an operating environment for other software executing in the computing system 6100, and coordinates activities of the components of the computing system 6100.

The tangible storage 6140 may be removable or non-removable, and includes magnetic disks, magnetic tapes or cassettes, CD-ROMs, DVDs, or any other medium which can be used to store information in a non-transitory way and which can be accessed within the computing system 6100. The storage 6140 stores instructions for the software 6180 implementing one or more innovations described herein.

The input device(s) 6150 may be a touch input device such as a keyboard, mouse, pen, or trackball, a voice input device, a scanning device, or another device that provides input to the computing system 6100. For video encoding, the input device(s) 6150 may be a camera, video card, TV tuner card, or similar device that accepts video input in analog or digital form, or a CD-ROM or CD-RW that reads video samples into the computing system 6100. The output device(s) 6160 may be a display, printer, speaker, CD-writer, or another device that provides output from the computing system 6100.

The communication connection(s) 6170 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-readable media. Computer-readable media are any available tangible media that can be accessed within a computing environment. By way of example, and not limitation, with the computing system 6100, computer-readable media include memory 6120, 6125, storage 6140, and combinations of any of the above.

The innovations can be described in the general context of computer-executable instructions, such as those included in program modules, being executed in a computing system on a target real or virtual processor (e.g., which is ultimately executed in hardware). Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Example 22

### Example Mobile Device

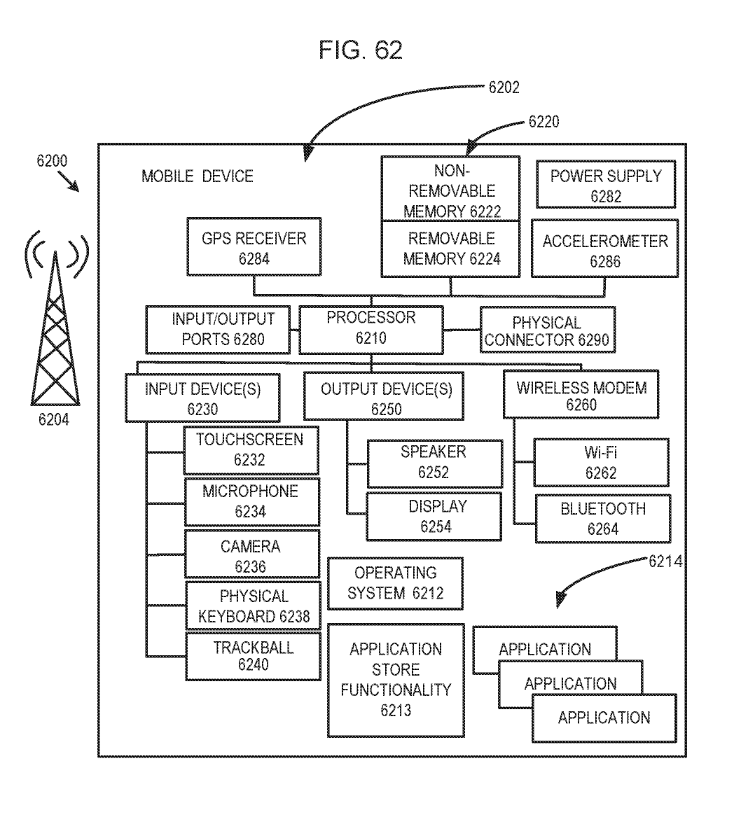

In any of the examples herein, a communication device can take the form of a mobile device. FIG. 62 is a system diagram depicting an example mobile device 6200 including a variety of optional hardware and software components, shown generally at 6202. Any components 6202 in the mobile device can communicate with any other component, although not all connections are shown, for ease of illustration. The mobile device can be any of a variety of computing devices (e.g., cell phone, smartphone, handheld computer, Personal Digital Assistant (PDA), etc.) and can allow wireless two-way communications with one or more mobile communications networks 6204, such as a cellular, satellite, or other network. Voice over IP scenarios (e.g., over Wi-Fi or other network) can also be supported. The communication devices described herein can take the form of the described mobile device 6200.

The illustrated mobile device 6200 can include a controller or processor 6210 (e.g., signal processor, microprocessor, ASIC, or other control and processing logic circuitry) for performing such tasks as signal coding, data processing, input/output processing, power control, and/or other functions. An operating system 6212 can control the allocation and usage of the components 6202 and support for one or more application programs 6214. The application programs 6214 can include common mobile computing applications (e.g., email applications, calendars, contact managers, web browsers, messaging applications), or any other computing application. Functionality 6213 for accessing an application store can also be used for acquiring and updating applications 6214.

The illustrated mobile device 6200 can include memory 6220. Memory 6220 can include non-removable memory 6222 and/or removable memory 6224. The non-removable memory 6222 can include RAM, ROM, flash memory, a hard disk, or other well-known memory storage technologies. The removable memory 6224 can include flash memory or a Subscriber Identity Module (SIM) card, which is well known in GSM communication systems, or other well-known memory storage technologies, such as “smart cards.” The memory 6220 can be used for storing data and/or code for running the operating system 6212 and the applications 6214. Example data can include web pages, text, images, sound files, video data, or other data sets to be sent to and/or received from one or more network servers or other devices via one or more wired or wireless networks. The memory 6220 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device 6200 can support one or more input devices 6230, such as a touch screen 6232, microphone 6234, camera 6236, physical keyboard 6238 and/or trackball 6240 and one or more output devices 6250, such as a speaker 6252 and a display 6254. Other possible output devices (not shown) can include piezoelectric or other haptic output devices. Some devices can serve more than one input/output function. For example, touchscreen 6232 and display 6254 can be combined in a single input/output device.

A wireless modem 6260 can be coupled to an antenna (not shown) and can support two-way communications between the processor 6210 and external devices, as is well understood in the art. The modem 6260 is shown generically and can include a cellular modem for communicating with the mobile communication network 6204 and/or other radio-based modems (e.g., Bluetooth 6264 or Wi-Fi 6262). The wireless modem 6260 is typically configured for communication with one or more cellular networks, such as a GSM or CDMA network for data and voice communications within a single cellular network, between cellular networks, or between the mobile device and a public switched telephone network (PSTN).

The mobile device 6200 can further include at least one input/output port 6280, a power supply 6282, a satellite navigation system receiver 6284, such as a Global Positioning System (GPS) receiver, an accelerometer 6286, and/or a physical connector 6290, which can be a USB port, WEE 1394 (FireWire) port, and/or RS-232 port. The illustrated components 6202 are not required or all-inclusive, as any components can be deleted and other components can be added.

### Example 23

### Example Cloud-Supported Environment

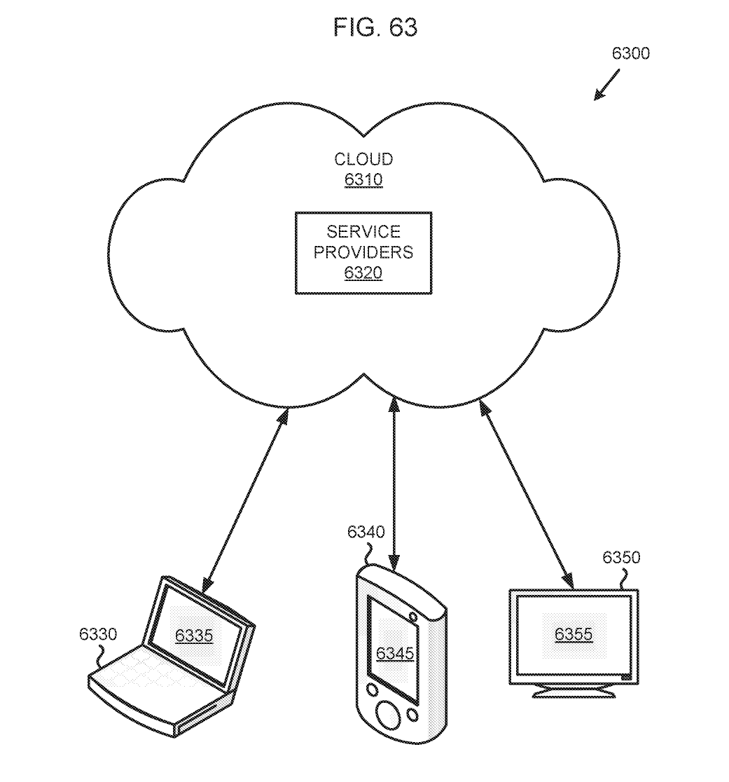

In example environment 6300 of FIG. 63, the cloud 6310 provides services for connected devices 6330, 6340, 6350 with a variety of screen capabilities. Connected device 6330 represents a device with a computer screen 6335 (e.g., a mid-size screen). For example, connected device 6330 could be a personal computer such as desktop computer, laptop, notebook, netbook, or the like. Connected device 6340 represents a device with a mobile device screen 6345 (e.g., a small size screen). For example, connected device 6340 could be a mobile phone, smart phone, personal digital assistant, tablet computer, and the like. Connected device 6350 represents a device with a large screen 6355. For example, connected device 6350 could be a television screen (e.g., a smart television) or another device connected to a television (e.g., a set-top box or gaming console) or the like. One or more of the connected devices 6330, 6340, 6350 can include touch screen capabilities. Touchscreens can accept input in different ways. For example, capacitive touchscreens detect touch input when an object (e.g., a fingertip or stylus) distorts or interrupts an electrical current running across the surface. As another example, touchscreens can use optical sensors to detect touch input when beams from the optical sensors are interrupted. Physical contact with the surface of the screen is not necessary for input to be detected by some touchscreens. Devices without screen capabilities also can be used in example environment 6300. For example, the cloud 6310 can provide services for one or more computers (e.g., server computers) without displays.

Services can be provided by the cloud 6310 through service providers 6320, or through other providers of online services (not depicted). For example, cloud services can be customized to the screen size, display capability, and/or touch screen capability of a particular connected device (e.g., connected devices 6330, 6340, 6350).

In example environment 6300, the cloud 6310 provides the technologies and solutions described herein to the various connected devices 6330, 6340, 6350 using, at least in part, the service providers 6320. For example, the service providers 6320 can provide a centralized solution for various cloud-based services. The service providers 6320 can manage service subscriptions for users and/or devices (e.g., for the connected devices 6330, 6340, 6350 and/or their respective users).

### Example 24

### Example Implementations

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions stored on one or more computer-readable storage media (e.g., non-transitory computer-readable media, such as one or more optical media discs, volatile memory components (such as DRAM or SRAM), or nonvolatile memory components (such as hard drives)) and executed on a computer (e.g., any commercially available computer, including smart phones or other mobile devices that include computing hardware). Any of the computer-executable instructions for implementing the disclosed techniques as well as any data created and used during implementation of the disclosed embodiments can be stored on one or more computer-readable media (e.g., non-transitory computer-readable media). The computer-executable instructions can be part of for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub-combinations with one another. The disclosed methods, apparatus, and systems are not limited to any specific aspect or feature or combination thereof nor do the disclosed embodiments require that any one or more specific advantages be present or problems be solved.

### Non-Transitory Computer-Readable Media

Any of the computer-readable media herein can be non-transitory (e.g., memory, magnetic storage, optical storage, or the like).

### Storing in Computer-Readable Media

Any of the storing actions described herein can be implemented by storing in one or more computer-readable media (e.g., computer-readable storage media or other tangible media).

Any of the things described as stored can be stored in one or more computer-readable media (e.g., computer-readable storage media or other tangible media).

### Methods in Computer-Readable Media

Any of the methods described herein can be implemented by computer-executable instructions in (e.g., encoded on) one or more computer-readable media (e.g., computer-readable storage media or other tangible media). Such instructions can cause a computing system to perform the method. The technologies described herein can be implemented in a variety of programming languages.

### Methods in Computer-Readable Storage Devices

Any of the methods described herein can be implemented by computer-executable instructions stored in one or more computer-readable storage devices (e.g., memory, magnetic storage, optical storage, or the like). Such instructions can cause a computer to perform the method.

### Further Implementations: Clauses

1. A method of predicting crop yields comprising:
   Sensing information that affects the yields of a particular crop;
   Converting the sensed information that affects the yields of said particular crop to data;
   Collecting and arranging the data;
   Evaluating the data of said particular crop; and
   Predicting the future performance of said particular crop based on the evaluation of the data.
2. The method of predicting crop yields according to Clause 1 wherein information includes at least one of the following:

Geographical information, GPS coordinates, crop type, seed type, seed population planted, date of planting, seed genetics, weather conditions, soil conditions, soil terrain, soil fertility, selection of equipment used for soil preparation, selection of equipment used for planting, selection of equipment used for harvesting; date of harvesting; type of fertilizer used, amount of fertilizer used; date of application of fertilizer, method of application of fertilizer, weather conditions prior to planting, weather conditions during planting, weather conditions during growing, weather conditions during harvest, weather conditions during fallow periods, weather history or combinations thereof.
3. The method of predicting crop yields according to any of Clauses 1-2 wherein information is provided by and includes any sensor connectable to a machine useful in delivering seed or soil amendments to soil; conditioning soil, or harvesting said crop.
4. The method of predicting crop yields according to Clause 1, 2, or 3 wherein data is transferred to a server wherein an evaluator/predictor program resides for prediction calculations.
5. The method of predicting crop yields according to Clause 1, 2, 3 or 4 wherein said evaluator/predictor program produces a prediction of a crop's yield which is transmittable.
6. The method of predicting crop yields according to Clause 1, 2, 3, 4 or 5 wherein said evaluator/predictor program produces a transmittable report containing an assessment of a crop's yields and a prediction of a crop's yields based on a user's input and the initial prediction to provide an assessment of the impact the user's input has upon the predicted crop yields.
7. The method of predicting crop yields according to Clause 1, 2, 3, 4, 5 or 6 wherein said user's input includes at least one of the following:

Geographical information, GPS coordinates, crop type, seed type, seed population planted, date of planting, seed genetics, weather conditions, soil conditions, soil terrain, soil fertility, selection of equipment used for soil preparation, selection of equipment used for planting, selection of equipment used for harvesting; date of harvesting; type of fertilizer used, amount of fertilizer used; date of application of fertilizer, method of application of fertilizer, weather conditions prior to planting, weather conditions during planting, weather conditions during growing, weather conditions during harvest, weather conditions during fallow periods, weather history or combinations thereof.
8. The method of predicting crop yields according to Clause 1, 2, 3, 4, 5, 6 or 7 wherein said user's input includes hypothetical information which may include least one of the following:

Geographical information, GPS coordinates, crop type, seed type, seed population planted, date of planting, seed genetics, weather conditions, soil conditions, soil terrain, soil fertility, selection of equipment used for soil preparation, selection of equipment used for planting, selection of equipment used for harvesting; date of harvesting; type of fertilizer used, amount of fertilizer used; date of application of fertilizer, method of application of fertilizer, weather conditions prior to planting, weather conditions during planting, weather conditions during growing, weather conditions during harvest, weather conditions during fallow periods, weather history or combinations thereof.
9. The method of predicting crop yields according to Clause 7 wherein user's input is provided by and includes any sensor connectable to a machine useful in delivering seed or soil amendments to soil; conditioning soil, or harvesting said crop.
10. The method of predicting crop yields according to any of Clauses 1-9 wherein said user's input may also include financial information related to input costs, application costs, land costs, rent costs and crop and/or output values.
11. The method of predicting crop yields according to any of Clauses 1-10 wherein information collected is monitored.
12. An apparatus substantially as shown and described.
13. A method substantially as shown and described.
21. One or more computer-readable storage media storing computer-executable instructions that, when executed, perform a method for analyzing farming data, the method comprising:
   receiving identification marker data, the identification marker data associated with at least one of applied seed, applied pesticide, or applied fertilizer;
   based at least in part on the identification marker data, identifying at least one of a seed type of the applied seed, a pesticide type of the applied pesticide, or a fertilizer type of the applied fertilizer; and
   based at least in part on the identification marker data, determining at least one of a planting rate of the applied seed, an application rate of the applied pesticide, or an application rate of the applied fertilizer.
22. The computer-readable storage media of Clause 21, wherein the identification marker data indicates a detection of a tracking substance.
23. The computer-implemented method of Clause 22, wherein the tracking substance is a substance that is present in seeds, pesticide, fertilizer, or other applied material in a concentration or a combination not naturally found in an area where the tracking substance is detected.
24. The computer-readable storage media of Clause 22, wherein the tracking substance is an inert substance.
25. The computer-readable storage media of Clause 24, wherein the tracking substance is at least one of a fluorescent dye or a rare earth element.
26. The computer-readable storage media of Clause 21, wherein the method further comprises determining an expected yield based at least in part on at least one of the seed type, the planting rate, the pesticide type, the application rate of the applied pesticide, the fertilizer type, or the application rate of the applied fertilizer.
30. A method of managing agronomic data comprising:
presenting a plurality of forms;
collecting agronomic data via the forms; and
integrating the agronomic data into an agronomic database.

### ALTERNATIVES

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the following claims. We therefore claim as our invention all that comes within the scope and spirit of the claims.

What is claimed is:

1. A computer-implemented method for forecasting crop yield, the method comprising:
determining an expected yield at a first time;
determining a growth function representing how the expected crop yield changes over time; and
based at least in part on an intrinsic yield function and the growth function, determining an expected yield at a second time, wherein the second time is later than the first time.

2. The computer-implemented method of claim 1, wherein the growth function is determined based on a plurality of parameters, the respective parameters each representing one or more environmental factors or one or more cultural farming practices.

3. The computer-implemented method of claim 2, wherein the one or more environmental factors comprises at least one of weather conditions, soil conditions, or terrain, and wherein the one or more cultural farming practices are actions taken with respect to a field growing a crop for which the expected yield at the second time is determined, the cultural farming practices comprising at least one of soil disturbance, soil amendment, fertilizer application, fertilizer characteristics, pesticide application, pesticide characteristics, crop rotation, planting depth, planting density of a the crop, planting density of an alternate crop rotated with the crop, crop characteristics, crop residue management, weed management, tillage, canopy management, protective seed treatment, seed characteristics, characteristics of equipment used to manage the first crop, and a path or a speed of equipment traveling over the field growing the crop.

4. The computer-implemented method of claim 1, wherein the intrinsic yield function corresponds to a crop yield under assumed conditions.

5. The computer-implemented method of claim 1, wherein the intrinsic yield function is a probability distribution function.

6. The computer-implemented method of claim 5, wherein the intrinsic yield function represents a maximum yield determined at least in part from data reflecting a variety of environmental factors and cultural farming practices for a crop variety for which the expected yield at the second time is determined.

7. The computer-implemented method of claim 1, wherein the growth function is a probability distribution function.

8. The computer-implemented method of claim 7, wherein determining the growth function comprises performing a simulation to generate a value for each of a plurality of field locations at each of a plurality of times.

9. The computer-implemented method of claim 8, wherein the value of the growth function at a particular field location and time is correlated to the value of the growth function at another field location or time.

10. The computer-implemented method of claim 1, further comprising receiving identification marker data, the identification marker data associated with at least one of applied seed, applied pesticide, or applied fertilizer, and wherein the growth function is based at least in part on the received identification marker data.

11. The computer-implemented method of claim 10, wherein the identification marker data indicates a detection of a tracking substance.

12. The computer-implemented method of claim 11, wherein the tracking substance is a substance that is present in seeds, pesticide, fertilizer, or other applied material in a concentration or a combination not naturally found in an area where the tracking substance is detected.

13. The computer-implemented method of claim 11, wherein tracking substance is an inert sub stance.

14. One or more computer-readable storage media storing computer-executable instructions that, when executed, perform a method for forecasting crop yield, the method comprising:
receiving at least one of environmental data or cultural farming practice data for one or more fields growing a crop of a crop type; and
constructing a location-specific growth function that estimates a change in an expected crop yield over time for the one or more fields growing the crop of the crop type, the growth function based on the at least one of environmental data or cultural farming practice data.

15. The computer-readable storage media of claim 14, wherein constructing the location-specific growth function comprises:
fitting yield data to a yield distribution function, wherein the yield data is a function of time and geospatial location and represents empirical data for the one or more fields growing the crop of the crop type;
based at least in part on the yield distribution function, calculating an average yield and a full-width half maximum (FWHM) of the yield distribution function with respect to each of a plurality of environmental factors or cultural farming practices corresponding to the environmental data or cultural farming practices data; and
determining a plurality of calibration constants for the yield distribution function based at least in part on the calculating.

16. The computer-readable storage media of claim 14, wherein constructing the location-specific growth function further comprises, based at least in part on the plurality of calibration constants, constructing a hypersurface.

17. The computer-readable storage media of claim 14, wherein the method further comprises determining an expected yield at a time later than a current time based at least in part on an intrinsic yield function representing crop yield for the crop type and the location-specific growth function.

18. The computer-readable storage media of claim 17, wherein the method further comprises:
analyzing, for the crop type, crop yield data for a plurality of fields; and
based at least in part on the analyzing, determining the statistical intrinsic yield function.

19. One or more computer-readable storage media storing computer-executable instructions that, when executed, perform a method for forecasting crop yield, the method comprising:
generating a yield trajectory for each of a plurality of locations in a field or group of fields, the respective yield trajectories representing an expected yield as a function of time for a set of environmental factors and cultural farming practices, the respective yield trajectories generated by:
determining an intrinsic yield function for the location, the intrinsic yield function representing a yield determined from a set of empirical observations;
determining a growth function having values for the location at each of a plurality of time steps, the growth function based at least in part on a plurality of parameters reflecting at least some of the environmental factors and cultural farming practices; and
for each of the plurality of time steps after an initial time step, calculating an expected yield based at least in part on an expected yield of the previous time step, the intrinsic yield function, and the growth function; and
combining the yield trajectories for the plurality of locations in the field or group of field to determine an expected yield for a growing season.

20. The computer-readable storage media of claim 19, wherein for the respective yield trajectories, a maximum yield is determined by performing a simulation.
